(19) United States
(12) Patent Application Publication
(10) Pub. No.: US 2025/0327471 A1
(43) Pub. Date: Oct. 23, 2025

(54) TOOLING ASSEMBLY, TOOLING SYSTEM, AND METHOD FOR USING THE SAME

(71) Applicant: The Boeing Company, Arlington, VA (US)

(72) Inventors: Brent A. Beach, St. Louis, MO (US); Blake C. Kohlmeyer, Ballwin, MO (US); Chester J. Hill, Grafton, IL (US); Jesse Tihen, St. Charles, MO (US)

(73) Assignee: The Boeing Company, Arlington, VA (US)

(21) Appl. No.: 18/641,049

(22) Filed: Apr. 19, 2024

(51) Int. Cl. F16B 7/04

(52) U.S. Cl. CPC F16B 7/04

(57) ABSTRACT

There is provided a tooling assembly for full size determinant assembly of a structure. The tooling assembly has a clamshell assembly that locates the structure in an assembly jig in one or more of, an x-axis direction, a y-axis direction, and a z-axis direction. The clamshell assembly includes a hinged clamshell structure, and a latch assembly, a clamp assembly, and a base plate all attached to the hinged clamshell structure. The tooling assembly further has a pin assembly with a pin having a head end clamped between the clamp assembly and the clamshell assembly, an indexing portion substantially positioned within the hinged clamshell structure, a rotation control portion, and a tail end. The pin assembly includes one or more nut elements and an interfacing surface. The clamshell assembly allows the pin to releasably engage within the assembly jig and allows the pin and the structure to float.

### FIELD

The disclosure relates generally to assemblies, systems, and methods for full size determinant assembly, and more particularly, to tooling assemblies, tooling systems, and methods for using the same, to enable full size determinant assembly of structures, such as aircraft structures for aircraft.

### BACKGROUND

Full size determinant assembly is a precision assembly or manufacturing method or process that uses alignment features, such as holes, to index component parts and assemblies relative to each other, and that eliminates or minimizes the use of hard tooling by replacing it with self-locating detail parts that determine the configuration of the assembly by their own dimensions and certain coordinating features incorporated into the design of the parts. Full size determinant assembly uses automated machines to drill clean, precise, full-size holes in advance of assembling the structure, and such holes then line up easily for insertion of fasteners without the need to take it apart. Full size determinant assembly is increasingly used to assemble and manufacture aircraft structures, such as fuselage and wings.

Known methods and systems used to enable full size determinant assembly of aircraft structures, such as fuselage and wings, or other production parts, use assembly jigs, fixtures, and pins to position and support frame sections of such aircraft structures or other production parts, including inserting pins through holes or slots in the frame sections held by the assembly jig and/or fixtures. When the pins are rotated in the holes or slots, there is a possibility that the pins may get locked in the assembly jig or fixture or that the pins may bind and become immovable. Such known methods and systems do not allow the pins to be releasably engaged so that the pins can be moved out of the assembly jig with the aircraft structure. Moreover, such known methods and systems do not allow the pins to float or adjust to allow for full size determinant assembly and do not allow the pins and the aircraft structure to float together. This may result in removal of the assembly jig or fixture and possible damage to the holes of the frame section. Thus, full size determinant assembly may not be achieved due to over-constraining, build-up, and possible pin binding.

It would be desirable to solve the problem of assembly jig lock and pin binding to accurately position and support structures, such as aircraft structures, for example, frame sections of fuselage and wings, to enable full size determinant assembly. Accordingly, there is a need in the art for an improved tooling assembly, tooling system, and method for supporting a structure, such as an aircraft structure, for full size determinant assembly that allow pins to be releasably engaged so that the pins can be moved out of the assembly jig with the structure, such as the aircraft structure, that allow for the pin and the structure, such as the aircraft structure, to float to allow for full size determinant assembly, and that provide other advantages over known systems and methods.

### SUMMARY

Example implementations of the present disclosure provide a tooling assembly, a tooling system, and a method for using the same to support a structure, such as an aircraft structure, for full size determinant assembly. As discussed in the below detailed description, versions of the tooling assembly, tooling system, and method may provide significant advantages over known systems and methods.

In a version of the disclosure, there is provided a tooling assembly for full size determinant assembly of a structure. The tooling assembly comprises a clamshell assembly that locates the structure in an assembly jig in one or more of, an x-axis direction, a y-axis direction, and a z-axis direction.

The clamshell assembly comprises a hinged clamshell structure having a hinged end with a hinge pin and a non-hinged end. The clamshell assembly further comprises a latch assembly attached to the non-hinged end of the hinged clamshell structure, to latch the hinged clamshell structure in a closed position. The clamshell assembly further comprises a clamp assembly attached to the hinged clamshell structure. The clamshell assembly further comprises a base plate attached to a bottom of the hinged clamshell structure.

The tooling assembly further comprises a pin assembly. The pin assembly comprises a pin. The pin comprises a head end clamped between the clamp assembly and the hinged clamshell structure. The pin further comprises an indexing portion extending from the head end and substantially positioned within the hinged clamshell structure. The pin further comprises a rotation control portion coupled to the indexing portion. The pin further comprises a tail end.

The pin assembly further comprises one or more nut elements coupled to the pin. The pin assembly further comprises an interfacing surface on one of, the pin, or the one or more nut elements. The interfacing surface is configured to interface with a portion of the structure.

The clamshell assembly of the tooling assembly allows the pin to releasably engage within the assembly jig, and allows the pin and the structure to float, while preventing over-constraint of the full size determinant assembly.

In another version of the disclosure, there is provided a tooling system for full size determinant assembly of an aircraft structure. The tooling system comprises an assembly jig. The tooling system further comprises a frame section of the aircraft structure for the full size determinant assembly. The frame section is positioned on, and supported by, the assembly jig.

The tooling system further comprises two or more tooling assemblies. Each tooling assembly comprises a clamshell assembly that locates the aircraft structure in the assembly jig in one or more of, an x-axis direction, a y-axis direction, and a z-axis direction.

The clamshell assembly comprises a hinged clamshell structure having a hinged end with a hinge pin and a non-hinged end. The clamshell assembly further comprises a latch assembly attached to the non-hinged end of the hinged clamshell structure, to latch the hinged clamshell structure in a closed position. The clamshell assembly further comprises a clamp assembly attached to the hinged clamshell structure. The clamshell assembly further comprises a base plate attached to a bottom of the hinged clamshell structure.

The tooling assembly further comprises a pin assembly. The pin assembly comprises a pin. The pin comprises a head end clamped between the clamp assembly and the hinged clamshell structure. The pin further comprises an indexing portion extending from the head end and substantially positioned within the hinged clamshell structure. The pin further comprises a rotation control portion coupled to the indexing portion. The pin further comprises a tail end.

The pin assembly further comprises one or more nut elements coupled to the pin. The pin assembly further comprises an interfacing surface on one of, the pin, or the one or more nut elements. The interfacing surface is configured to interface with a portion of the aircraft structure.

The clamshell assembly of each of the tooling assemblies allows the pin to releasably engage within the assembly jig, and allows the pin and the aircraft structure to float, while preventing over-constraint of the full size determinant assembly.

In another version of the disclosure, there is provided a method of supporting an structure for full size determinant assembly. The method comprises the step of attaching two or more tooling assemblies to the structure.

Each tooling assembly comprises a clamshell assembly that locates the structure in an assembly jig in one or more of, an x-axis direction, a y-axis direction, and a z-axis direction. The clamshell assembly comprises a hinged clamshell structure having a hinged end with a hinge pin and a non-hinged end. The hinged clamshell structure further comprises a latch assembly attached to the non-hinged end of the hinged clamshell structure, to latch the hinged clamshell structure in a closed position. The hinged clamshell structure further comprises a clamp assembly attached to the hinged clamshell structure. The hinged clamshell structure further comprises a base plate attached to a bottom of the hinged clamshell structure.

The clamshell assembly further comprises a pin assembly. The pin assembly comprises a pin. The pin comprises a head end clamped between the clamp assembly and the hinged clamshell structure. The pin further comprises an indexing portion extending from the head end and substantially positioned within the hinged clamshell structure. The pin further comprises a rotation control portion coupled to the indexing portion. The pin further comprises a tail end.

The pin assembly further comprises one or more nut elements coupled to the pin. The pin assembly further comprises an interfacing surface on one of, the pin, or the one or more nut elements, the interfacing surface configured to interface with a portion of the structure.

The method further comprises the step of positioning and locating the structure on the assembly jig using the two or more tooling assemblies. The method further comprises the step of using the clamshell assembly of each of the two or more tooling assemblies to releasably engage the pin of each of the two or more tooling assemblies within the assembly jig, and to allow the pin of each of the two or more tooling assemblies and the structure to float, while preventing over-constraint of the full size determinant assembly.

The features, functions, and advantages that have been discussed can be achieved independently in various versions of the disclosure or may be combined in yet other versions, further details of which can be seen with reference to the following description and drawings.

### BRIEF DESCRIPTION OF THE DRAWINGS

The disclosure can be better understood with reference to the following detailed description taken in conjunction with the accompanying drawings, which illustrate preferred and exemplary versions, but which are not necessarily drawn to scale. The drawings are examples and not meant as limitations on the description or claims.

FIG. 1 is an illustration of a block diagram of an exemplary version of a tooling assembly of the disclosure that is part of an exemplary tooling system of the disclosure for full size determinant assembly;

FIG. 2A is an illustration of a front perspective view of an exemplary version of a primary clamshell assembly of a tooling assembly of the disclosure in an assembled configuration and having a stop tab;

FIG. 2B is an illustration of a left side view of the primary clamshell assembly of FIG. 2A;

FIG. 2C is an illustration of a back right side perspective view of the primary clamshell assembly of FIG. 2A;

FIG. 2D is an illustration of a front cross-sectional view of the primary clamshell assembly of FIG. 2A;

FIG. 2E is an illustration of a right side perspective view of the primary clamshell assembly of FIG. 2A in an unassembled configuration;

FIG. 2F is an illustration of back right side perspective view of the primary clamshell assembly of FIG. 2C with no stop tab;

FIG. 2G is an illustration of a left side perspective view of the primary clamshell assembly of FIG. 2F;

FIG. 2H is an illustration of a back right side perspective view of the primary clamshell assembly of FIG. 2F in an unassembled configuration;

FIG. 2I is an illustration of a back perspective enlarged view of an exemplary version of a hinge plate with a stop tab of the primary clamshell assembly of FIG. 2C;

FIG. 2J is an illustration of a back perspective enlarged view of another exemplary version of a hinge plate with no stop tab of the primary clamshell assembly of FIG. 2F;

FIG. 2K is an illustration of a back right side perspective enlarged view of a V-block of the primary clamshell assembly of FIG. 2E;

FIG. 2L is an illustration of a bottom perspective enlarged view of the V-block of FIG. 2K;

FIG. 3A is an illustration of a front perspective view of an exemplary version of a secondary clamshell assembly of the disclosure in an assembled configuration and having a stop tab;

FIG. 3B is an illustration of a left side view of the secondary clamshell assembly of FIG. 3A;

FIG. 3C is an illustration of a back right side view of the secondary clamshell assembly of FIG. 3A;

FIG. 3D is an illustration of a front cross-sectional view of the secondary clamshell assembly of FIG. 3A;

FIG. 3E is an illustration of a right side perspective view of the secondary clamshell assembly of FIG. 3A in an unassembled configuration;

FIG. 3F is an illustration of back right side perspective view of the secondary clamshell assembly of FIG. 3C with no stop tab;

FIG. 3G is an illustration of a left side perspective view of the secondary clamshell assembly of FIG. 3F;

FIG. 3H is an illustration of a back perspective view of the secondary clamshell assembly of FIG. 3F in an unassembled configuration;

FIG. 3I is an illustration of a back right side perspective enlarged view of an exemplary version of a lower clamshell portion of the secondary clamshell assembly of FIG. 3E having an integral hinge plate with a stop tab;

FIG. 3J is an illustration of a bottom right side perspective enlarged view of an exemplary version of a lower clamshell portion of the secondary clamshell assembly of FIG. 3H having an integral hinge plate with no stop tab;

FIG. 4A is an illustration of a front perspective view of an exemplary version of a tertiary clamshell assembly of the disclosure in an assembled configuration and having no stop tab;

FIG. 4B is an illustration of a left side perspective view of the tertiary clamshell assembly of FIG. 4A;

FIG. 4C is an illustration of a right side perspective view of the tertiary clamshell assembly of FIG. 4A and having a stop tab added;

FIG. 4D is an illustration of a front cross-sectional view of the tertiary clamshell assembly of FIG. 4A;

FIG. 5A is an illustration of a side perspective view of an exemplary version of a datum side pin assembly of the disclosure in an unassembled configuration;

FIG. 5B is an illustration of a side perspective view of the datum side pin assembly of FIG. 5A in an assembled configuration;

FIG. 5C is an illustration of a side cross-sectional view of the datum side pin assembly of FIG. 5A in an assembled configuration;

FIG. 6A is an illustration of a side perspective view of an exemplary version of a non-datum side pin assembly of the disclosure in an unassembled configuration;

FIG. 6B is an illustration of a side perspective view of the non-datum side pin assembly of FIG. 6A in an assembled configuration;

FIG. 6C is an illustration of a side cross-sectional view of the non-datum side pin assembly of FIG. 6A in an assembled configuration;

FIG. 7A is an illustration of a front view of an exemplary version of a tooling assembly of the disclosure showing a primary clamshell assembly and a datum side pin assembly;

FIG. 7B is an illustration of a back perspective view of the tooling assembly of FIG. 7A;

FIG. 7C is an illustration of a back right side perspective view of the primary clamshell assembly of FIG. 7A with a stop tab and with a non-datum side pin assembly;

FIG. 7D is an illustration of a front perspective view of the tooling assembly of FIG. 7C;

FIG. 7E is an illustration of a front cross-sectional view of the tooling assembly of FIG. 7D;

FIG. 8A is an illustration of a back right side perspective view of another exemplary version of a tooling assembly of the disclosure showing a secondary clamshell assembly and a datum side pin assembly;

FIG. 8B is an illustration of a front view of the tooling assembly of FIG. 8A;

FIG. 8C is an illustration of a front perspective view of the secondary clamshell assembly of FIG. 8A with a non-datum side pin assembly;

FIG. 8D is an illustration of a front cross-sectional view of the tooling assembly of FIG. 8C;

FIG. 9A is an illustration of a front perspective view of another exemplary version of a tooling assembly of the disclosure showing a tertiary clamshell assembly and a non-datum side pin assembly;

FIG. 9B is an illustration of a front cross-sectional view of the tooling assembly of FIG. 9A with no stop tab and with a datum side pin assembly;

FIG. 10A is an illustration of a front perspective view of an exemplary version of a tooling system of the disclosure, showing exemplary versions of tooling assemblies coupled to an assembly jig and coupled to aircraft structures;

FIG. 10B is an illustration of a back perspective view of the tooling system of FIG. 10A;

FIG. 11A is an illustration of a front perspective view of an exemplary version of another tooling system of the disclosure, showing exemplary versions of tooling assemblies coupled to an assembly jig and coupled to aircraft structures;

FIG. 11B is an illustration of a back perspective view of the tooling system of FIG. 11A;

FIG. 12A is an illustration of a front view of an exemplary version of yet another tooling system of the disclosure, showing exemplary versions of tooling assemblies coupled to an assembly jig and coupled to structures;

FIG. 12B is an illustration of a back perspective view of the tooling system of FIG. 12A;

FIG. 13 is an illustration of a flow diagram of an exemplary method of the disclosure;

FIG. 14 is an illustration of a perspective view of an exemplary aircraft having wings and a fuselage that may be manufactured using an exemplary version of a tooling system with one or more tooling assemblies of the disclosure for full size determinant assembly;

FIG. 15 is an illustration of a flow diagram of an exemplary aircraft manufacturing and service method; and

FIG. 16 is an illustration of an exemplary block diagram of an aircraft.

The figures shown in this disclosure represent various aspects of the versions presented, and only differences will be discussed in detail.

### DETAILED DESCRIPTION

Disclosed versions will now be described more fully hereinafter with reference to the accompanying drawings, in which some, but not all of the disclosed versions are shown. Indeed, several different versions may be provided and should not be construed as limited to the versions set forth herein. Rather, these versions are provided so that this disclosure will be thorough and fully convey the scope of the disclosure to those skilled in the art.

This specification includes references to “one version” or “a version”. The instances of the phrases “one version” or “a version” do not necessarily refer to the same version. Particular features, structures, or characteristics may be combined in any suitable manner consistent with this disclosure. All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

As used herein, “comprising” is an open-ended term, and as used in the claims, this term does not foreclose additional structures or steps.

As used herein, “configured to” means various parts or components may be described or claimed as “configured to” perform a task or tasks. In such contexts, “configured to” is used to connote structure by indicating that the parts or components include structure that performs those task or tasks during operation. As such, the parts or components can be said to be configured to perform the task even when the specified part or component is not currently operational (e.g., is not on).

As used herein, the terms “first”, “second”, etc., are used as labels for nouns that they precede, and do not imply any type of ordering (e.g., spatial, temporal, logical, etc.).

As used herein, an element or step recited in the singular and preceded by the word “a” or “an” should be understood as not necessarily excluding the plural of the elements or steps. As used herein, the term “and/or” includes any and all combinations of one or more of the associated listed items. As also used herein, the term “combinations thereof” includes combinations having at least one of the associated listed items, wherein the combination can further include additional, like non-listed items.

As used herein, the phrase “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category

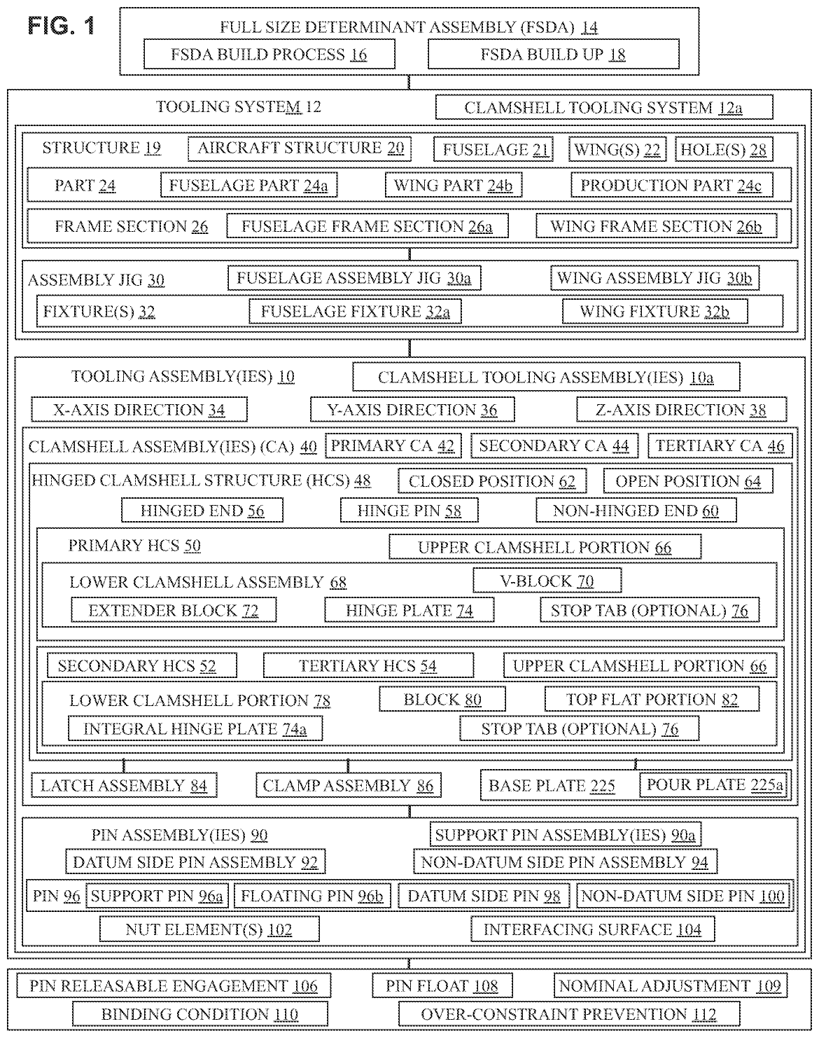

Now referring to FIG. 1, FIG. 1 is an illustration of a block diagram of exemplary versions of a tooling assembly 10, such as a clamshell tooling assembly 10a, of the disclosure that are part of an exemplary tooling system 12, such as a clamshell tooling system 12a, of the disclosure for full size determinant assembly (FSDA) 14, including a full size determinant assembly (FSDA) build process 16 and a full size determinant assembly (FSDA) build up 18, of a structure 19. In one version, as shown in FIG. 1, the structure 19 comprises an aircraft structure 20, such as a fuselage 21, a wing 22, or another suitable aircraft structure. In other versions, the structure 19 may comprise another aerospace structure such as a spacecraft structure, a rotorcraft structure, a drone, or other suitable aerospace structures, that can be assembled with full size determinant assembly (FSDA) 14, or the structure 19 may comprise a watercraft structure, an automobile structure, a truck structure, or other suitable vehicle structures, that can be assembled with FSDA 14. In yet other versions, the structure 19 may comprise an architectural structure, such as a building structure, a bridge structure, or other suitable architectural structures, that can be assembled with FSDA 14. The structure 19 may also comprise another suitable structure that can be assembled with FSDA 14.

As used herein, “full size determinant assembly” means a precision assembly or manufacturing method or process that uses alignment features, such as holes produced to their final size at a detail part level as opposed to match drilling holes during an assembly operation, to index component parts and assemblies relative to each other, and that uses self-locating detail parts that determine the configuration of the assembly by their own dimensions and certain coordinating features incorporated into the design of the parts. As used herein, “clamshell” means an object with two parts that are hinged or joined together at one end, and that opens and closes by pivoting the hinged end in a manner resembling a clamshell.

The blocks in FIG. 1 represent elements, and lines connecting the various blocks do not imply any particular dependency of the elements. Furthermore, the connecting lines shown in the various figures contained herein are intended to represent example functional relationships and/or physical couplings between the various elements, but it is noted that other alternative or additional functional relationships or physical connections may be present in versions disclosed herein. One or more of these blocks may be combined, divided, or combined and divided into different blocks when implemented in an illustrative example. Further, the illustrations of the tooling assembly 10, such as the clamshell tooling assembly 10a, and the tooling system 12, such as the clamshell tooling system 12a, in FIG. 1 are not meant to imply physical or architectural limitations to the manner in which an illustrative example may be implemented. Other components in addition to, or in place of, the ones illustrated may be used. Some components may be unnecessary.

Each tooling assembly 10, such as each clamshell tooling assembly 10a, and preferably, two or more of the tooling assemblies 10, such as two or more of the clamshell tooling assemblies 10a, is/are designed to pin in place and support a part 24 (see FIG. 1) in space, while preventing over-constraint or over-constraining of the full size determinant assembly (FSDA) 14. As shown in FIG. 1, the part 24 may comprise a fuselage part 24a, a wing part 24b, or another type of production part 24c, of the aircraft structure 20 or structure 19, or another type of part 24 of a structure 19, while having the ability to be nominally adjusted for the full size determinant assembly build process 16. As shown in FIG. 1, in one version, the part 24, such as the production part 24c, of the structure 19, such as the aircraft structure 20, comprises a frame section 26 of the structure 19, such as the aircraft structure 20. The part 24, such as the production part 24c, has one or more holes 28 through the part 24 configured for coupling with one or more of the tooling assemblies 10. The frame section 26 may comprise a fuselage frame section 26a (see FIG. 1), for example, a bulkhead frame section, a keel frame section, or another suitable fuselage frame section. The frame section 26 may further comprise a wing frame section 26b (see FIG. 1), for example, a rib frame section, a spar frame section, or another suitable wing frame section. In other versions, the part 24, such as the production part 24c, comprises other suitable aircraft parts for aircraft structures 20, or other suitable parts for structures 19, and the frame section 26 comprises other suitable frame sections for structures 19.

As shown in FIG. 1, the tooling system 12 further comprises an assembly jig 30, such as a fuselage assembly jig 30a, a wing assembly jig 30b, or another suitable assembly jig. The fuselage assembly jig 30a may comprise a forward fuselage assembly jig, an aft fuselage assembly jig, or another suitable fuselage assembly jig. The wing assembly jig 30b may comprise an inner wing assembly jig, an outer wing assembly jig, or another suitable wing assembly jig. In other versions, the assembly jig 30 comprises other suitable types of aircraft structure assembly jigs or other suitable types of structure assembly jigs. As used herein, “assembly jig” means an assembly that determines both a location of the assembly and a position of assembly features, such as holes, in a manufacturing process, such as full size determinant assembly.

As shown in FIG. 1, the tooling system 12, such as the clamshell tooling system 12a, may further comprise one or more fixtures 32, or fixture assemblies. The assembly jig 30 may comprise the one or more fixtures 32, or fixture assemblies, that make up the full assembly jig 30. The fixture 32 may comprise a fuselage fixture 32a (see FIG. 1), for example, a forward fuselage fixture, an aft fuselage fixture, or another suitable fuselage fixture or fixture assembly. The fixture 32 may further comprise a wing fixture 32b (see FIG. 1), for example, an inner wing fixture, an outer wing fixture, or another suitable wing fixture. In other versions, the fixture 32 comprises other suitable types of aircraft structure fixture devices or assemblies or other suitable types of structure fixture devices or assemblies. The part 24, such as the production part 24c, of the aircraft structure 20 or the structure 19 for the full size determinant assembly 14 is positioned on, and supported by, the one or more fixtures 32 or fixture assemblies that make up the assembly jig 30. As used herein, a “fixture” or a “fixture assembly” means a support structure or apparatus that is part of an assembly jig, to hold, support, and locate an assembly in a manufacturing process, such as full size determinant assembly, but the fixture does not determine a position of assembly features, such as holes.

As shown in FIG. 1, the tooling system 12, such as the clamshell tooling system 12a, further comprises two or more tooling assemblies 10, such as two or more clamshell tooling assemblies 10a. As further shown in FIG. 1, each tooling assembly 10, such as each clamshell tooling assembly 10a, is configured to locate, and locates, the aircraft structure 20, or other type of structure 19, in the assembly jig 30 in one or more of, an x-axis direction 34, a y-axis direction 36, and a z-axis direction 38. In particular, each tooling assembly 10, such as each clamshell tooling assembly 10a, comprises a clamshell assembly 40 that locates the aircraft structure 20, or other type of structure 19, in the assembly jig 30 in one or more of, the x-axis direction 34, the y-axis direction 36, and the z-axis direction 38.

As shown in FIG. 1, the clamshell assembly (CA) 40 may comprise a primary clamshell assembly (CA) 42, a secondary clamshell assembly (CA) 44, or a tertiary clamshell assembly (CA) 46, discussed in further detail below. As shown in FIG. 1, the clamshell assembly 40 comprises a hinged clamshell structure (HCS) 48. As further shown in FIG. 1, the hinged clamshell structure 48 may comprise a primary hinged clamshell structure (HCS) 50, a secondary hinged clamshell structure (HCS) 52, or a tertiary hinged clamshell structure (HCS) 54.

The hinged clamshell structure 48 has a hinged end 56 (see FIG. 1) with a hinge pin 58 (see FIG. 1) inserted through the hinged end 56. The hinged clamshell structure 48 further has a non-hinged end 60 (see FIG. 1). The hinged clamshell structure 48 is configured to move or pivot, and moves or pivots, back and forth between a closed position 62 (see FIG. 1) and an open position 64 (see FIG. 1).

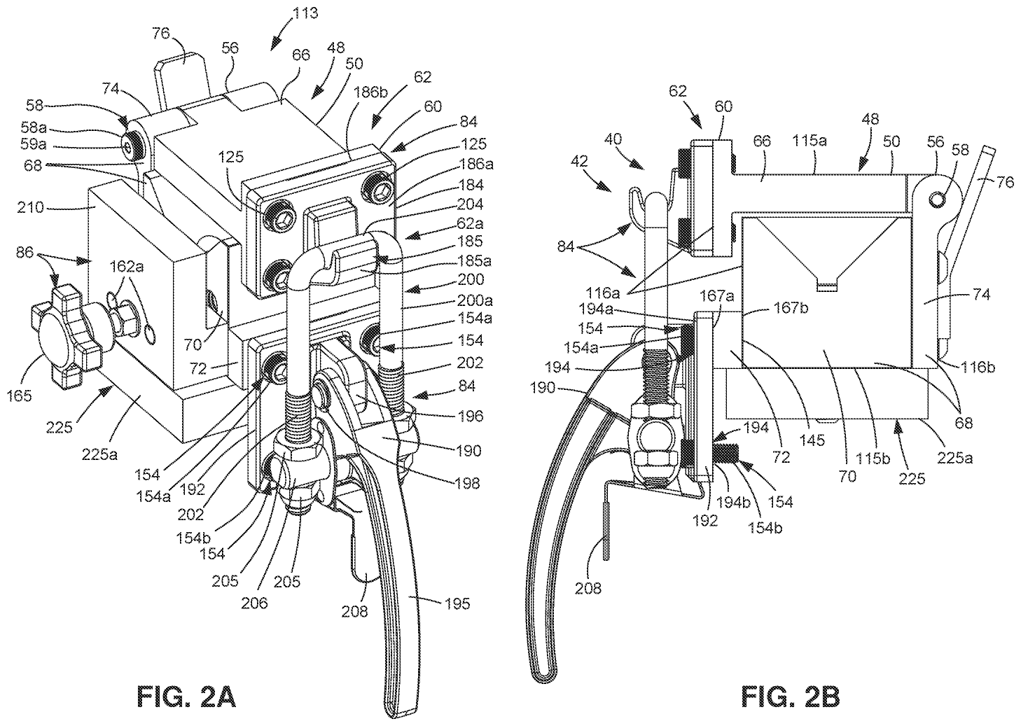

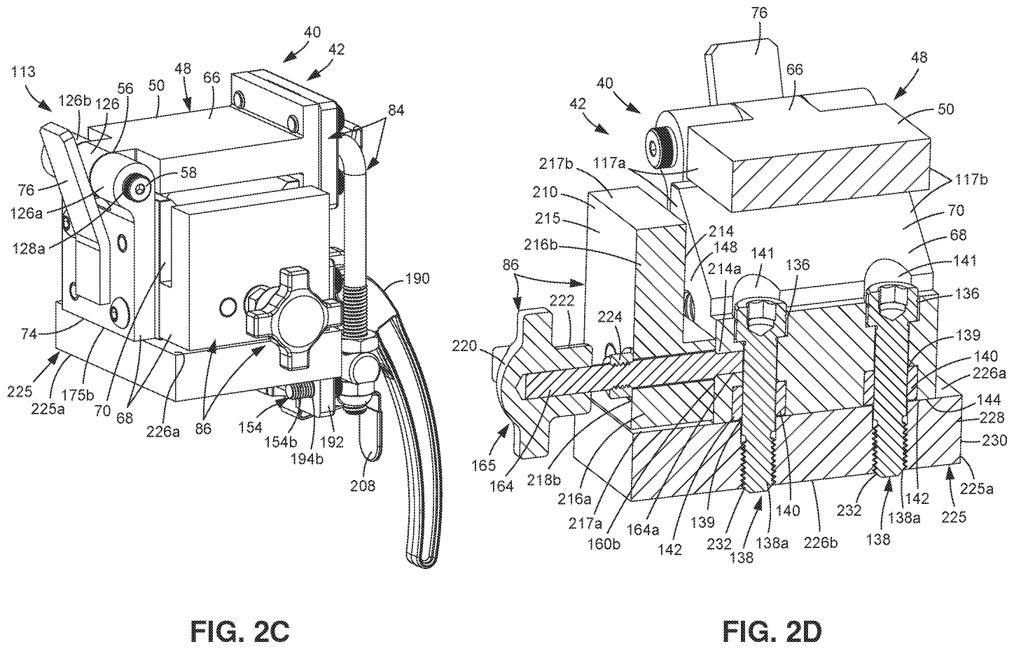

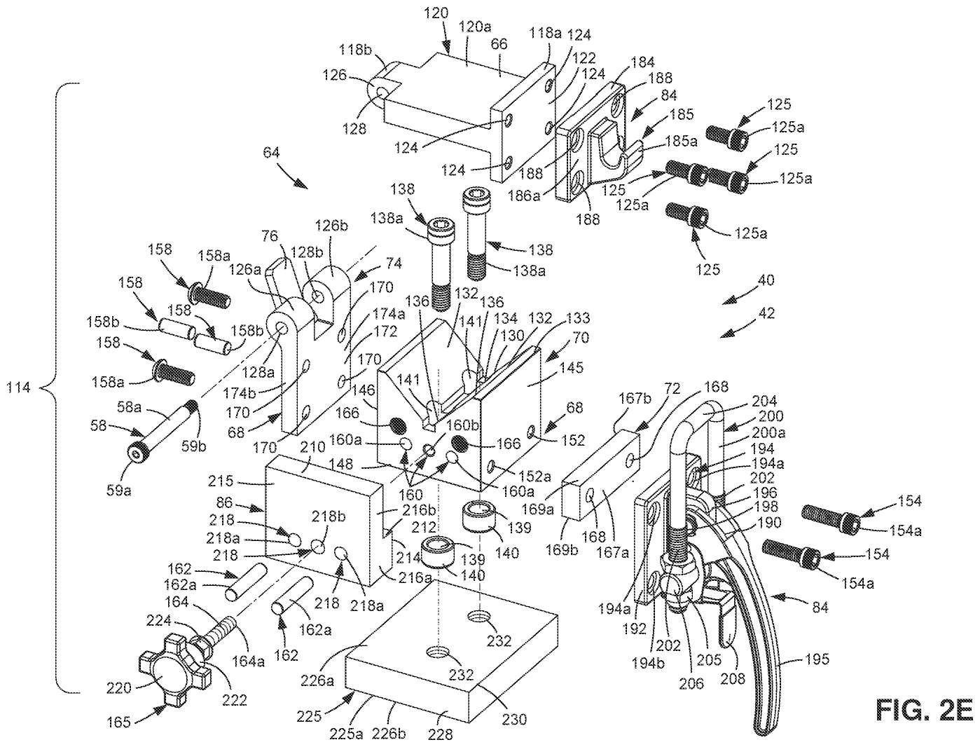

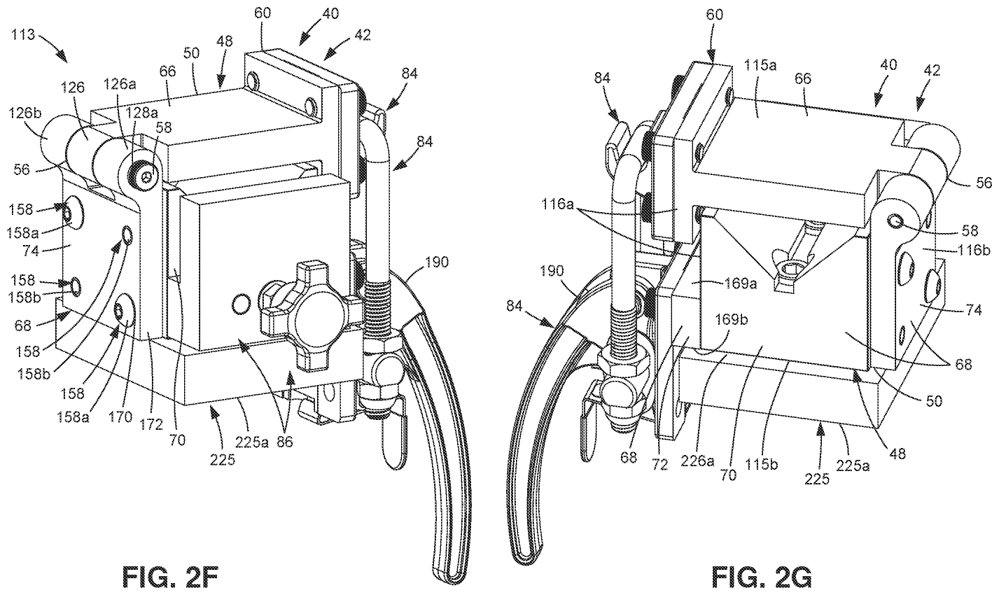

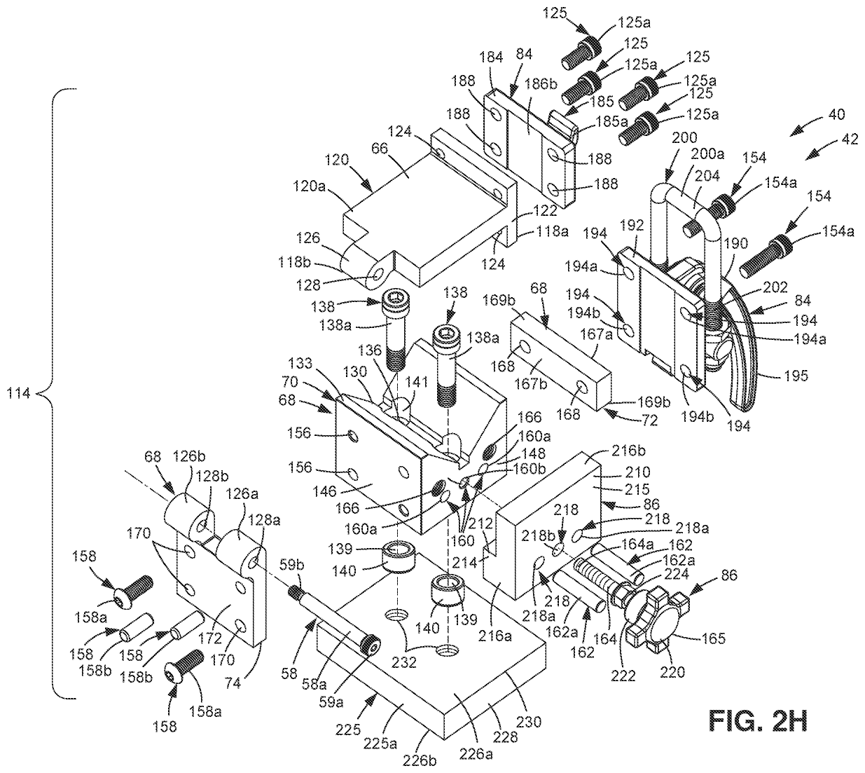

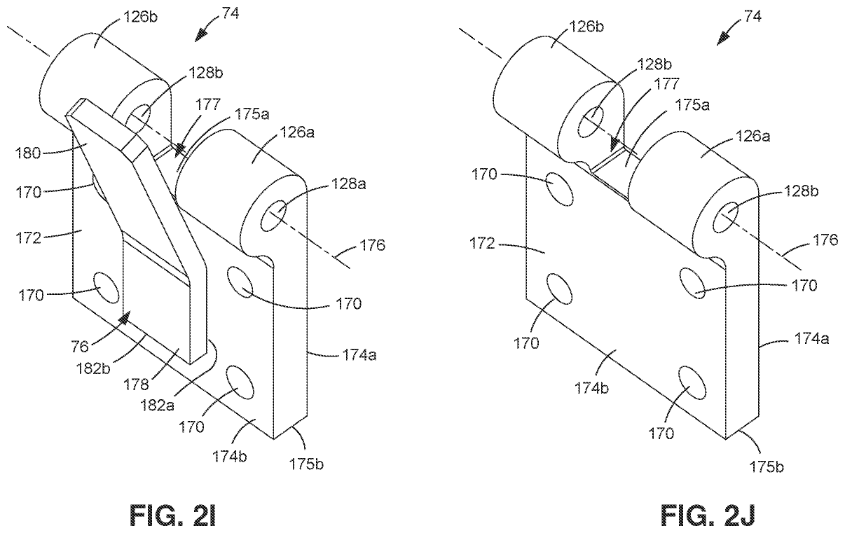

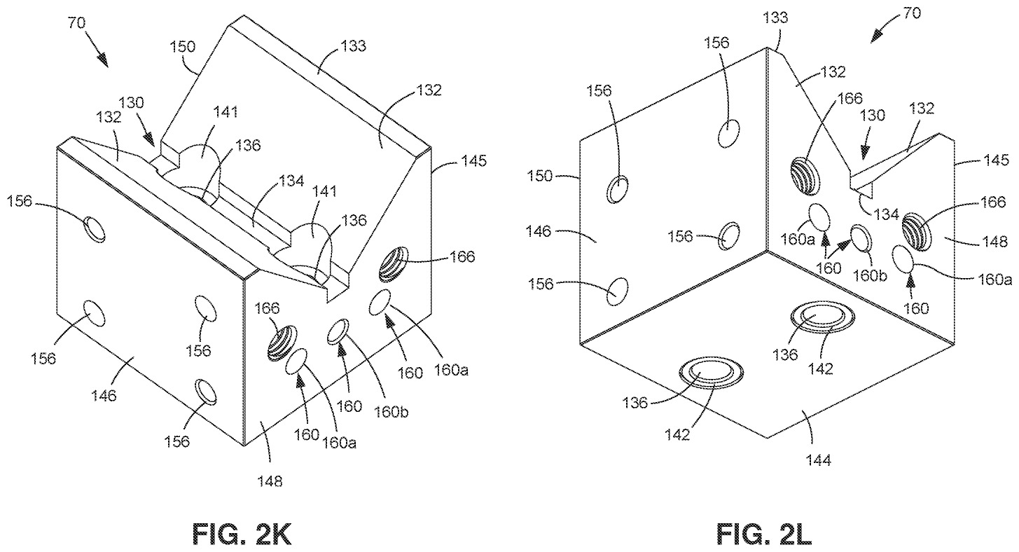

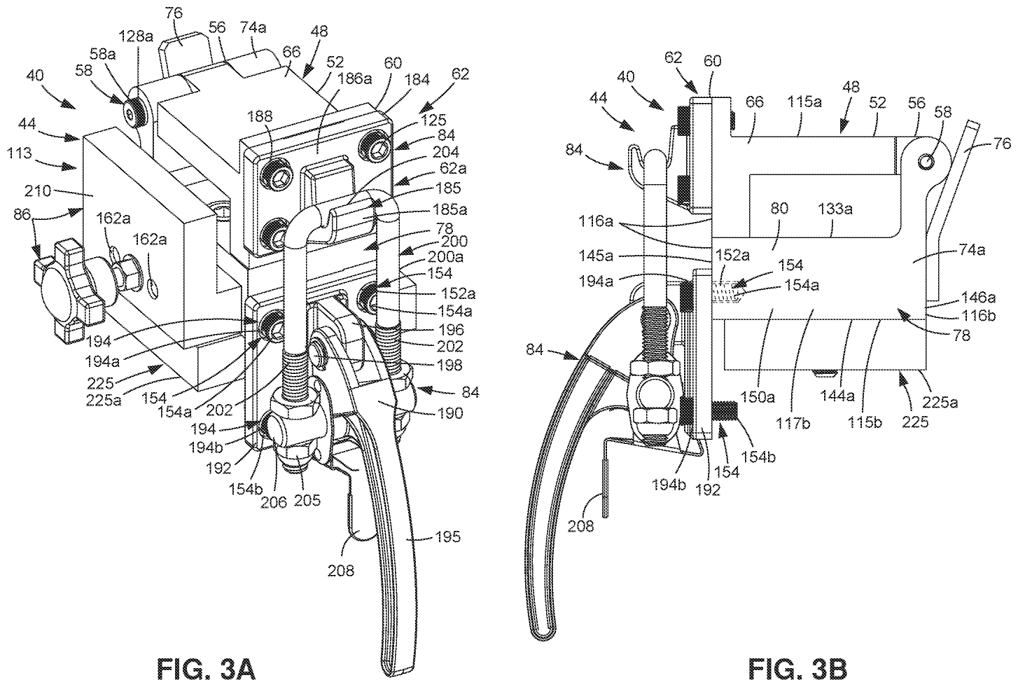

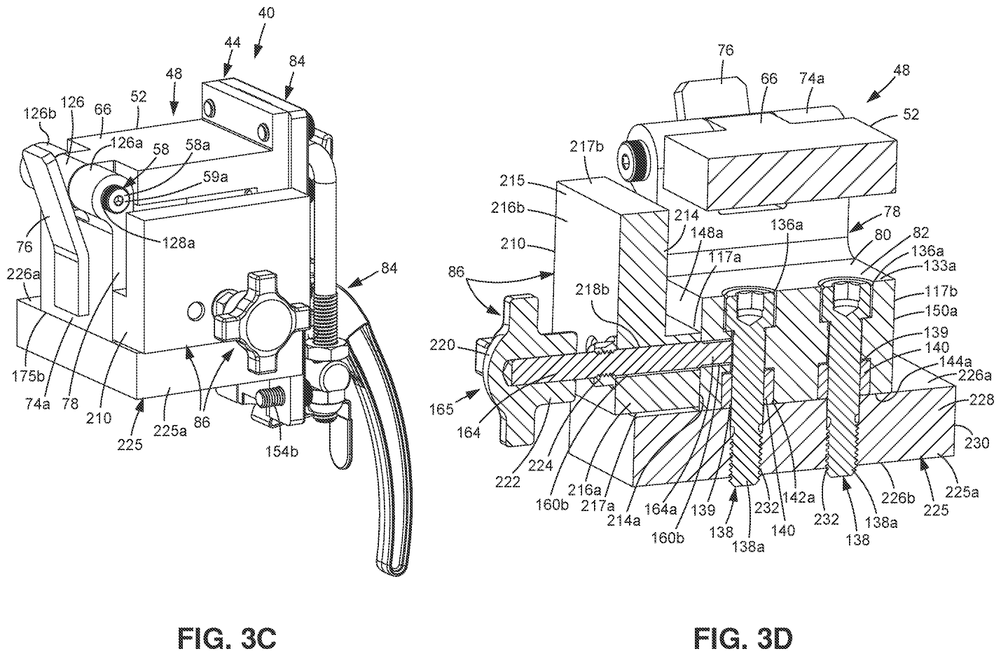

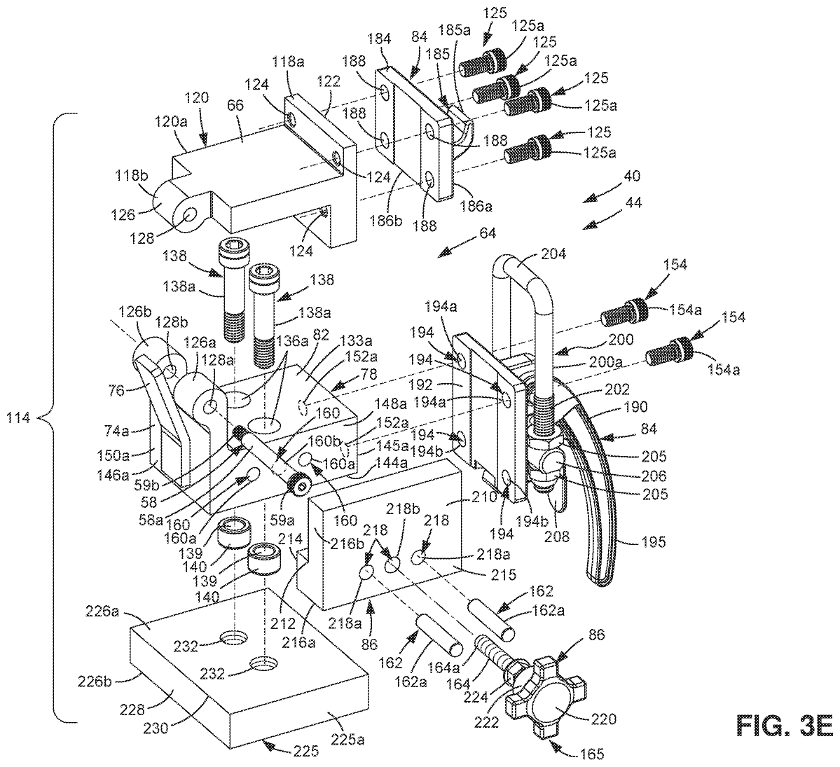

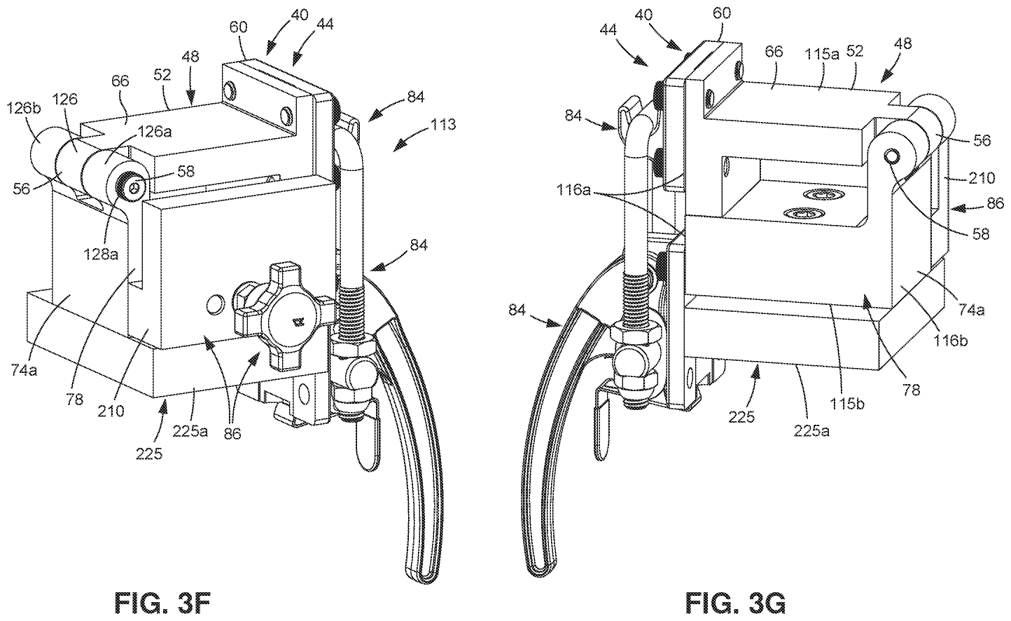

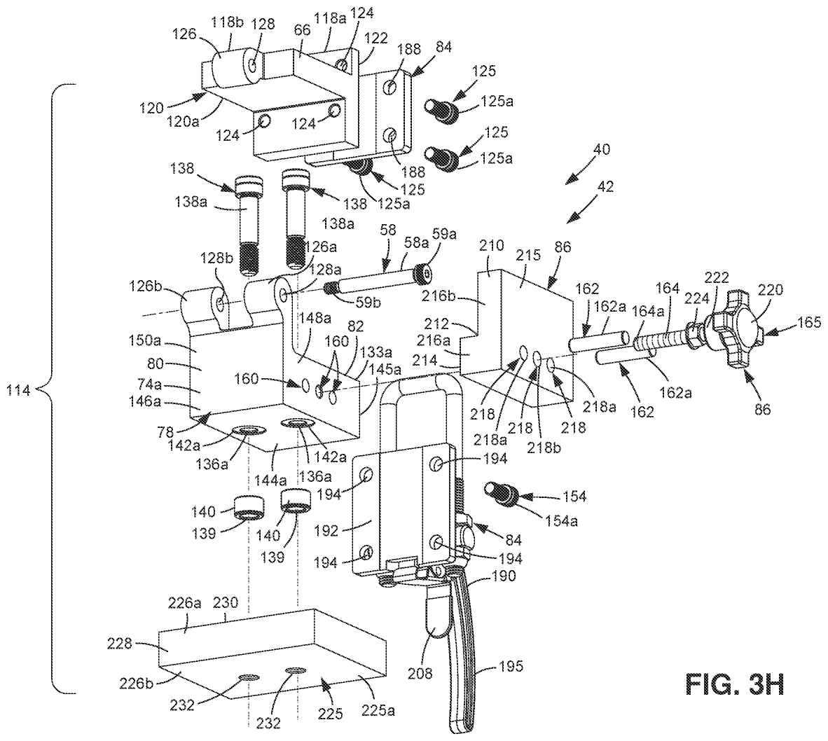

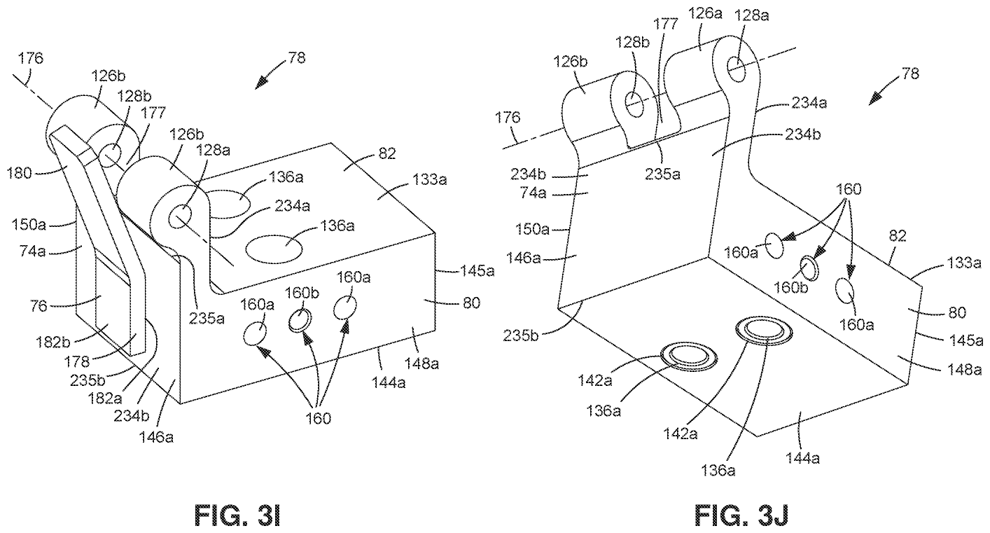

In one version, the clamshell assembly 40 comprises the primary clamshell assembly 42 that locates the aircraft structure 20, or other type of structure 19, in the x-axis direction 34, in the y-axis direction 36, and in the z-axis direction 38. When the clamshell assembly 40 comprises the primary clamshell assembly 42, the hinged clamshell structure 48 comprises the primary hinged clamshell structure 50 comprising an upper clamshell portion 66 (see FIG. 1) hingedly or pivotally connected, via the hinge pin 58, to a lower clamshell assembly 68 (see FIG. 1). As shown in FIGS. 2A, 2E, 2H, 3A, 3E, 3H, in one version, the hinge pin 58 comprises a shoulder bolt 58a. In other versions, the hinge pin 58 comprises a dowel pin or another suitable type of hinge pin. As shown in FIGS. 2E, 2H, 3E, 3H, the hinge pin 58, such as the shoulder bolt 58a, has a head end 59a and a tail end 59b.

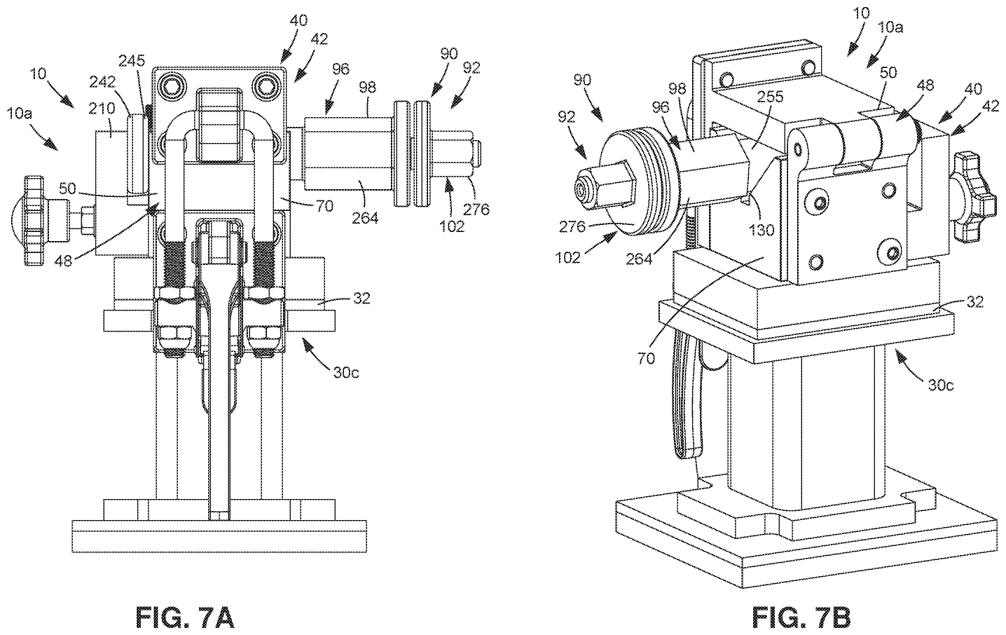

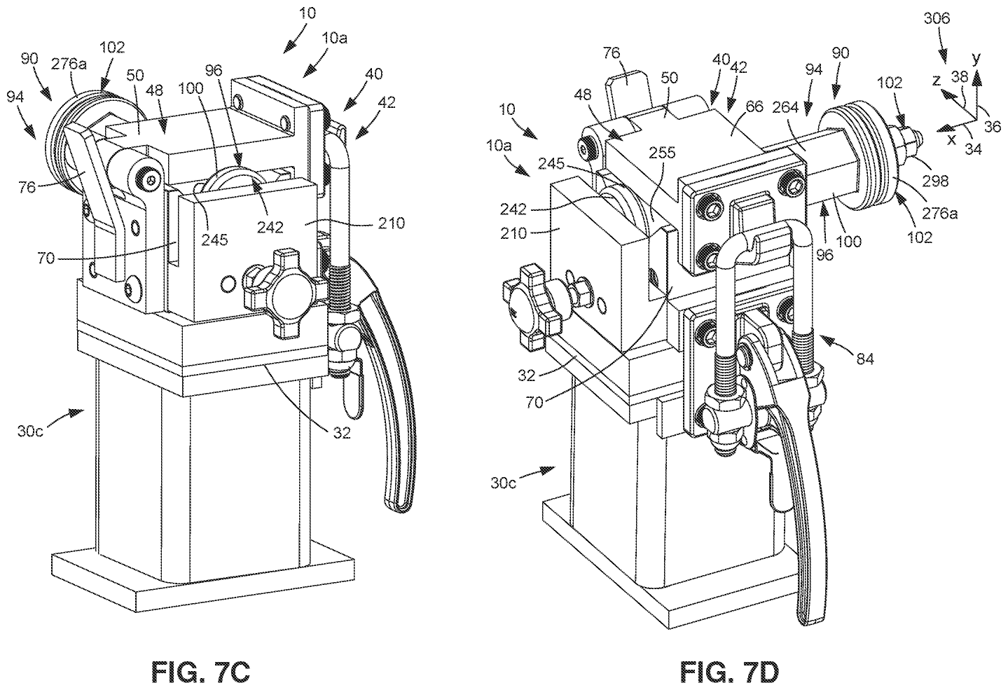

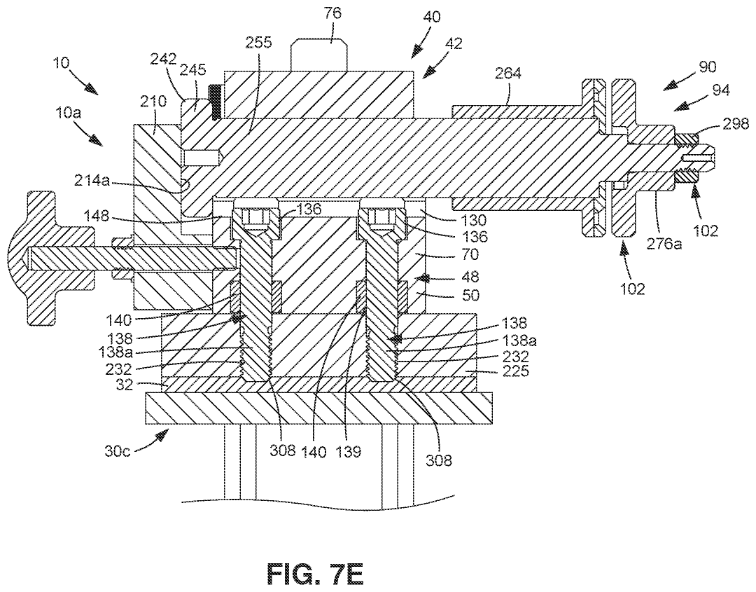

As shown in FIG. 1, the lower clamshell assembly 68 comprises a V-block 70, an extender block 72 attached to the V-block 70, and a hinge plate 74 attached to the V-block 70. In one version, as shown in FIG. 2I, the hinge plate 74 optionally has a stop tab 76 attached to the hinge plate 74. The stop tab 76 is designed to stop the upper clamshell portion 66 from over-pivoting, when the upper clamshell portion 66 is pivoted upward from the closed position 62 of the hinged clamshell structure 48 to the open position 64 of the hinged clamshell structure 48. In another version, as shown in FIG. 2J, the hinge plate 74 does not have the stop tab 76. The primary clamshell assembly 42 and the primary hinged clamshell structure 50 are discussed in further detail below with respect to FIGS. 2A-2L, 7A-7E.

In another version, the clamshell assembly 40 comprises the secondary clamshell assembly 44. With the secondary clamshell assembly 44, two directions of movement are constrained and one direction is free to float. In one example, the clamshell assembly 40 comprises the secondary clamshell assembly 44 that locates the aircraft structure 20, or other type of structure 19, in the y-axis direction 36 and in the z-axis direction 38, and allows floating of a pin 96 (see FIG. 1) in the x-axis direction 34. When the clamshell assembly 40 comprises the secondary clamshell assembly 44, the hinged clamshell structure 48 comprises the secondary hinged clamshell structure 52.

In yet another version, the clamshell assembly 40 comprises the tertiary clamshell assembly 46. With the tertiary clamshell assembly 46, only one direction of movement is constrained and two directions are free to float. In one example, the clamshell assembly 40 comprises the tertiary clamshell assembly 46 that locates the aircraft structure 20, or other type of structure 19, in the z-axis direction 38, and allows floating of the pin 96 in the x-axis direction 34 and in the y-axis direction 36. When the clamshell assembly 40 comprises the tertiary clamshell assembly 46, the hinged clamshell structure 48 comprises the tertiary hinged clamshell structure 54.

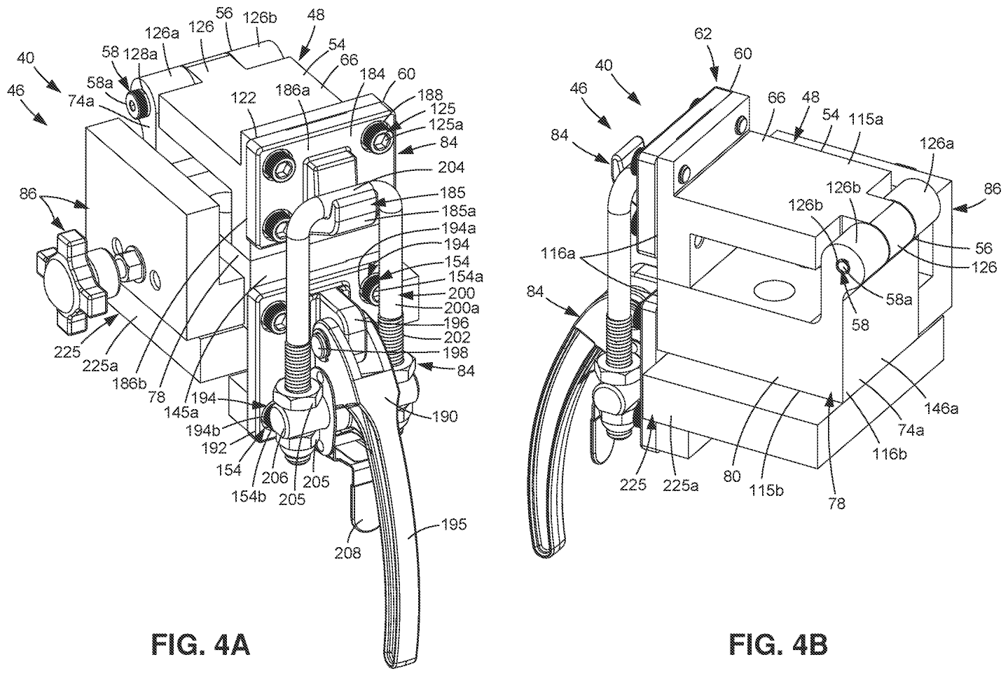

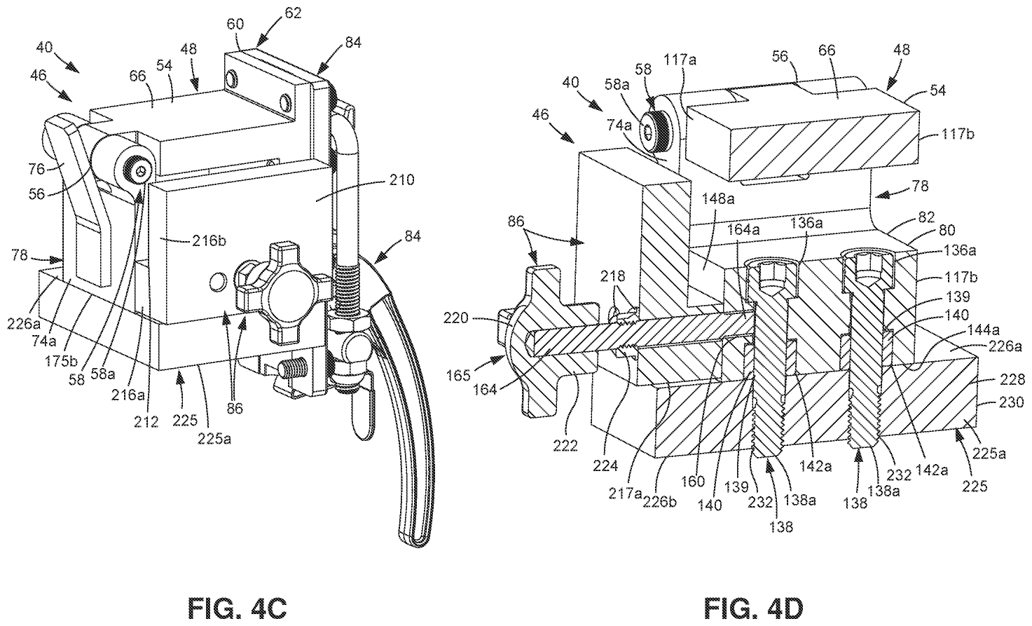

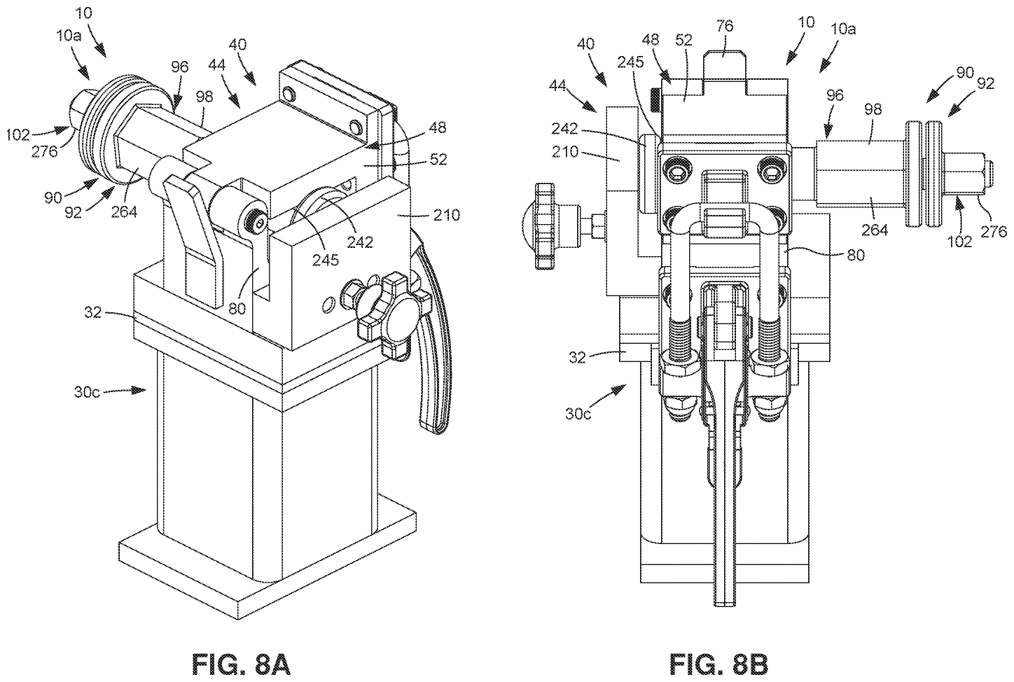

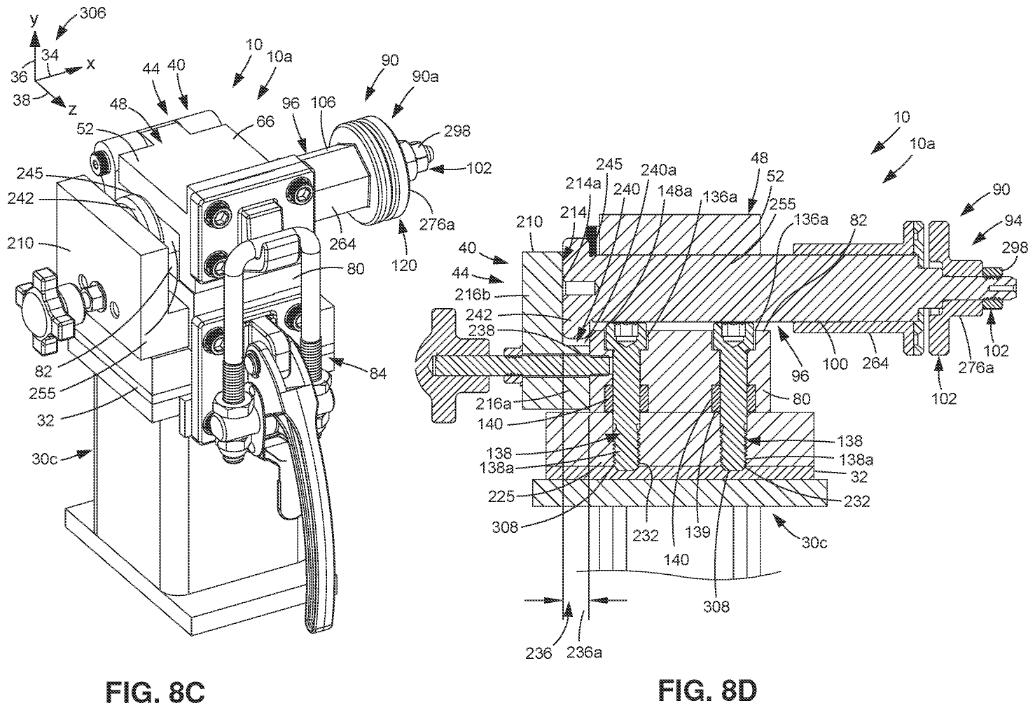

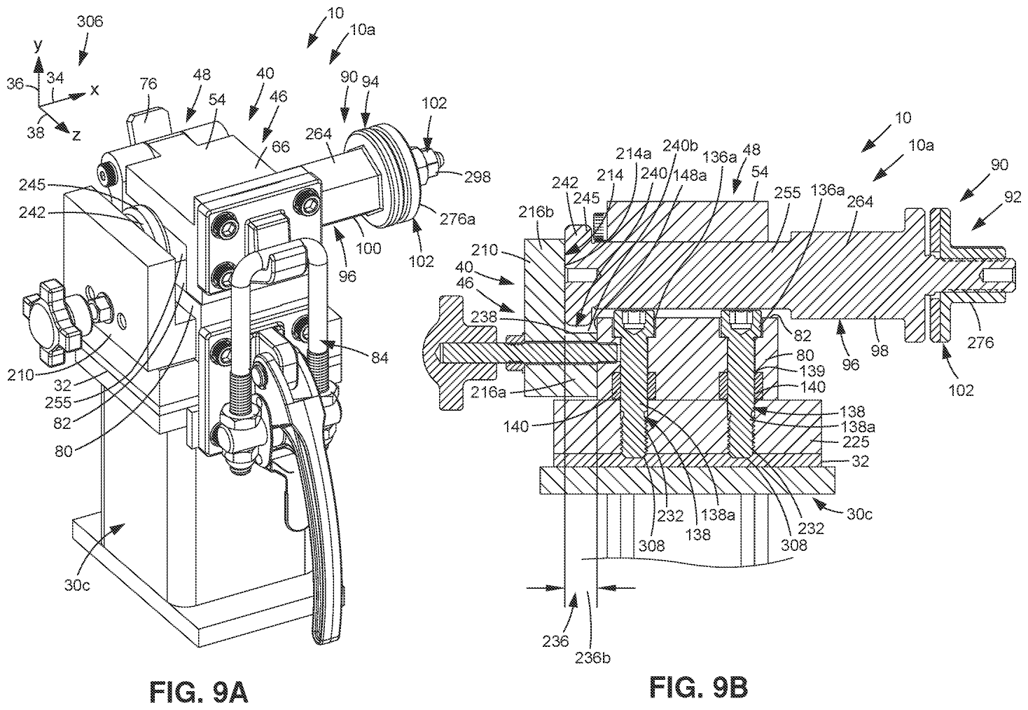

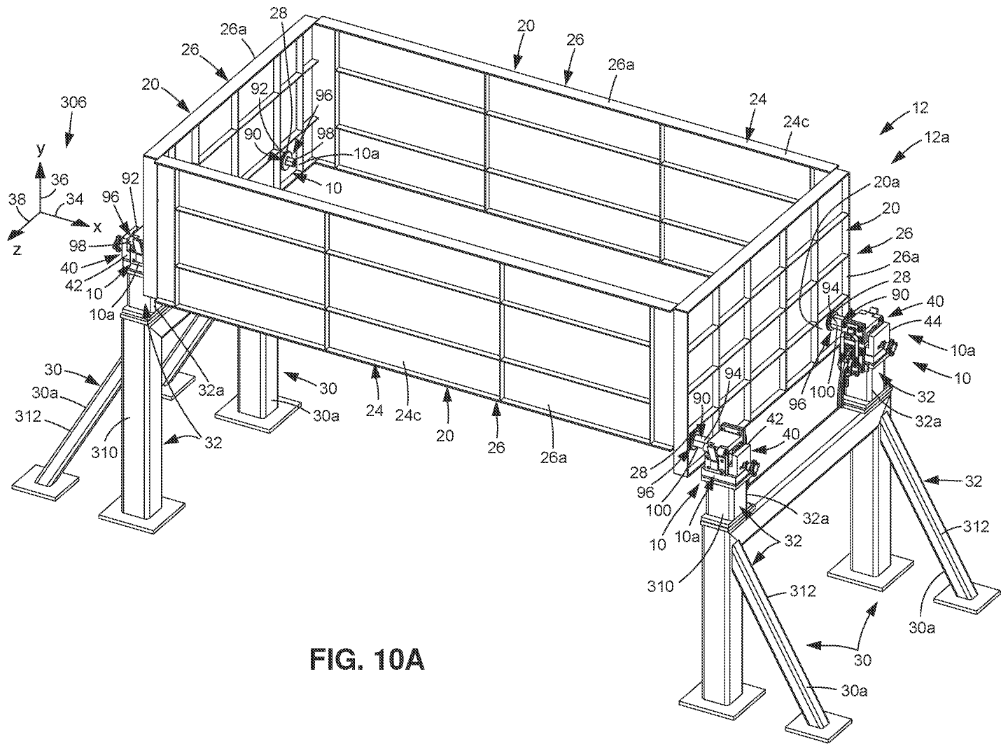

As shown in FIG. 1, the secondary hinged clamshell structure 52 and the tertiary hinged clamshell structure 54 each comprises the upper clamshell portion 66 hingedly or pivotally connected, via the hinge pin 58, to a lower clamshell portion 78 (see FIG. 1). As shown in FIG. 1, the lower clamshell assembly 68 comprises a block 80 with a top flat portion 82, and comprises an integral hinge plate 74a integral with the block 80. In one version, as shown in FIG. 3I, the integral hinge plate 74a optionally has the stop tab 76 attached to the integral hinge plate 74a. The stop tab 76 is designed to stop the upper clamshell portion 66 from over-pivoting, when the upper clamshell portion 66 is pivoted upward from the closed position 62 of the hinged clamshell structure 48 to the open position 64 of the hinged clamshell structure 48. In another version, as shown in FIG. 3J, the integral hinge plate 74a does not have the stop tab 76. The secondary clamshell assembly 44 and the secondary hinged clamshell structure 52 are discussed in further detail below with respect to FIGS. 3A-3J, 8A-8D. The tertiary clamshell assembly 46 and the tertiary hinged clamshell structure 54 are discussed in further detail below with respect to FIGS. 4A-4B, 9A-9B.

As shown in FIG. 1, the clamshell assembly 40 of the tooling assembly 10, such as the clamshell tooling assembly 10a, further comprises a latch assembly 84. The latch assembly 84 is attached to the non-hinged end 60 of the hinged clamshell structure 48, to latch the hinged clamshell structure 48 in the closed position 62. The latch assembly 84 is discussed in further detail below with respect to FIGS. 2A-2H, 3A-3H.

As shown in FIG. 1, the clamshell assembly 40 of the tooling assembly 10, such as the clamshell tooling assembly 10a, further comprises a clamp assembly 86. The clamp assembly 86 is attached to the hinged clamshell structure 48. The clamp assembly 86 is discussed in further detail below with respect to FIGS. 2A-2H, 3A-3H.

As shown in FIG. 1, the clamshell assembly 40 of the tooling assembly 10, such as the clamshell tooling assembly 10a, further comprises a base plate 225, such as in the form of a pour plate 225a. The base plate 225 is attached to the hinged clamshell structure 48. The base plate 225 is discussed in further detail below with respect to FIGS. 2A-2H, 3A-3H.

As shown in FIG. 1, the tooling assembly 10, such as the clamshell tooling assembly 10a, further comprises a pin assembly 90, such as a support pin assembly 90a. As shown in FIG. 1, the pin assembly 90, such as the support pin assembly 90a, may comprise a datum side pin assembly 92 or a non-datum side pin assembly 94. As used herein, “datum side” means an indexing structure or surface that is located or positioned on a same side as a clamshell assembly when coupled to an aircraft structure or other type of structure. As used herein, “non-datum side” means an indexing structure or surface that is located or positioned on an opposite side of a clamshell assembly when coupled to an aircraft structure or other type of structure.

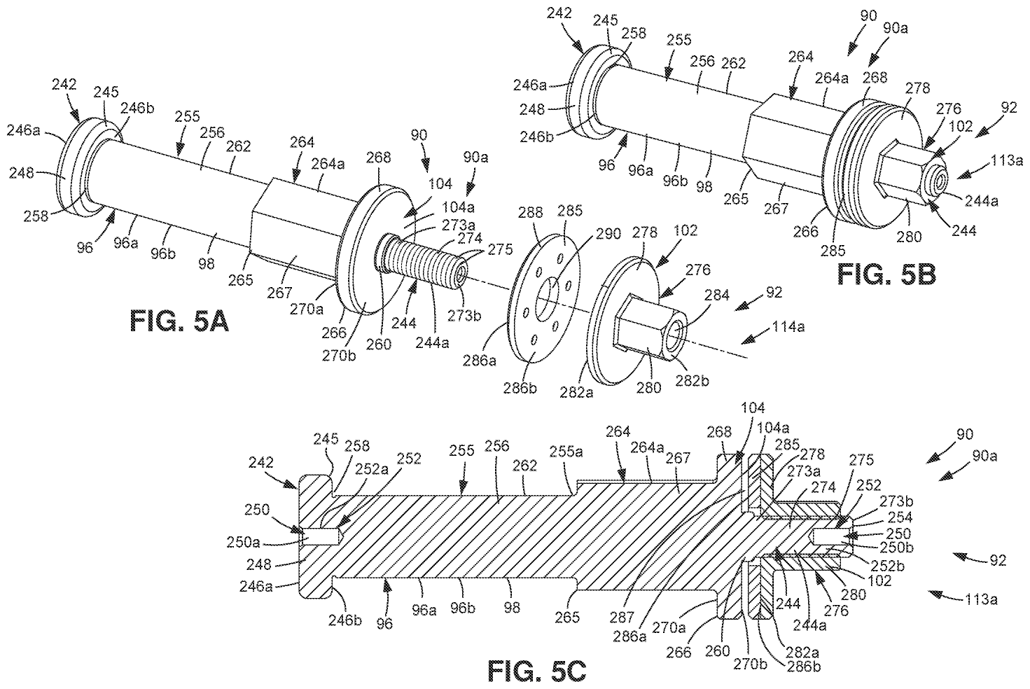

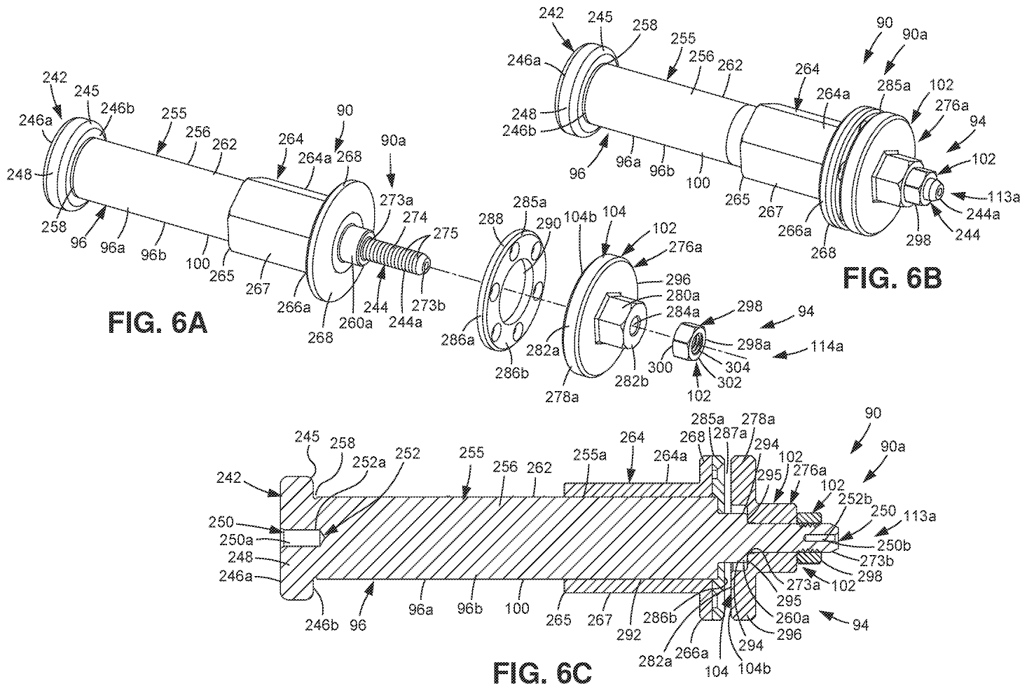

As shown in FIG. 1, the pin assembly 90, such as the support pin assembly 90a, comprises a pin 96, such as a support pin 96a, for example a floating pin 96b. In one version, when the pin assembly 90 comprises the datum side pin assembly 92, the pin 96 comprises a datum side pin 98 (see FIG. 1). The datum side pin 98 is discussed in more detail below with respect to FIGS. 5A-5C. In another version, when the pin assembly 90 comprises the non-datum side pin assembly 94, the pin 96 comprises a non-datum side pin 100. The non-datum side pin 100 is discussed in more detail below with respect to FIGS. 6A-6C.

As shown in FIG. 1, the pin assembly 90, such as a support pin assembly 90a, further comprises one or more nut elements 102 coupled to the pin 96. The one or more nut elements 102 are discussed in more detail below with respect to FIGS. 5A-6C.

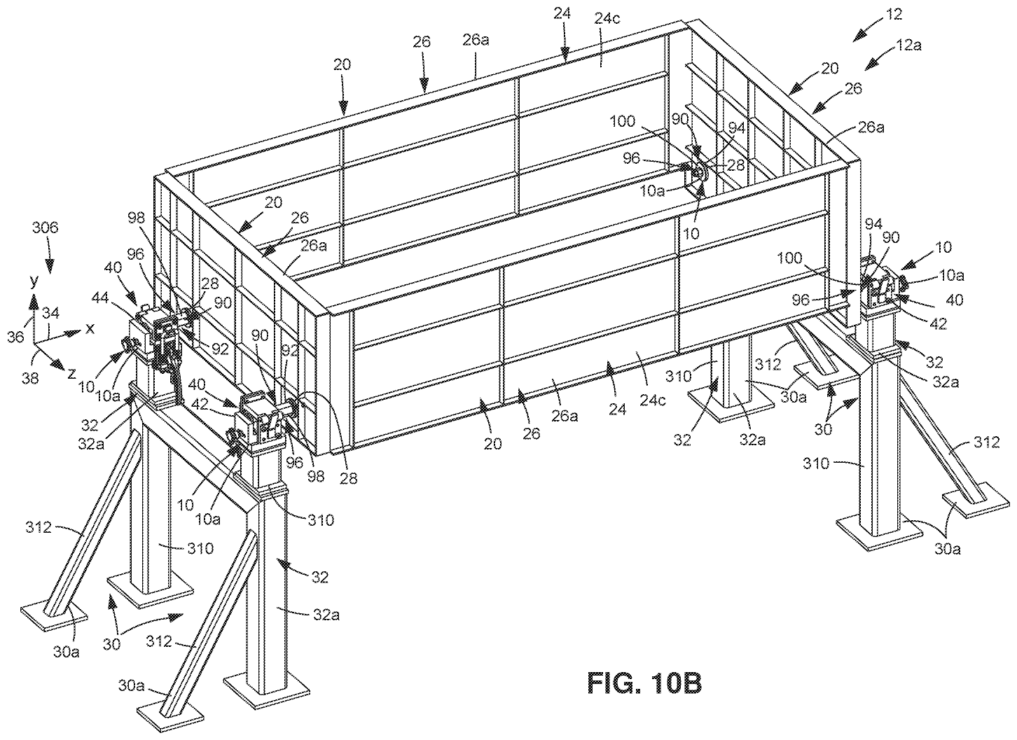

As shown in FIG. 1, the pin assembly 90, such as the support pin assembly 90a, further comprises an interfacing surface 104 formed on one of, the pin 96, or the one or more nut elements 102. The interfacing surface 104 is configured to interface, and interfaces, with a portion 20a (see FIG. 10A) of the aircraft structure 20. The clamshell assembly 40 controls the distance from an aircraft structure's “A” datum to a shoulder 245 (see FIGS. 5C, 6C) of a pin 96 that is removable in support of the full size determinant assembly (FSDA) build process 16 (see FIG. 1). The “A” datum is the aircraft structure's 20 primary datum.

The clamshell assembly 40 of the tooling assembly 10 allows the pin 96 to releasably engage within the assembly jig 30, and allows the pin 96 and the aircraft structure 20, the structure 19, to float together, while preventing over-constraint of the full size determinant assembly 14. Thus, the tooling assembly 10, such as the clamshell tooling assembly 10a, allows for a pin releasable engagement 106 (see FIG. 1) within the assembly jig 30, and allows for a pin float 108 (see FIG. 1) or a nominal adjustment 109 (see FIG. 1) of the pin 96 in the event of a binding condition 110 (see FIG. 1) of the pin 96. Each of the tooling assemblies 10 allows for a lateral movement of the pin 96 and the part 24 of the aircraft structure 20, or the structure 19, to enable the full size determinant assembly 14, and to avoid the binding condition 110 of the pin 96. As used herein, a “binding condition” means an immovable condition where a pin is not able to move and cannot be removed from an assembly jig. As used herein, “float” means a lateral movement or a nominal adjustment of a pin, an aircraft structure or another type of structure, or a pin and an aircraft structure or another type of structure together, to allow the aircraft structure's holes or structure's holes, such as full size holes, to align to one another.

Further, the tooling assembly 10, such as the clamshell tooling assembly 10a, allows for the build up of the frame section 26 (see FIG. 1), including the fuselage frame section 26a (see FIG. 1) and the wing frame section 26b (see FIG. 1), without jig lock of the assembly jig 30 (see FIG. 1) or pin binding issues with the pin 96 (see FIG. 1). The pin float 108 or nominal adjustment 109 allows the pin 96 to slide in and out to allow for adjustment movement of the frame section 26 that is being supported during full size determinant assembly 14. The tooling assembly 10, such as the clamshell tooling assembly 10a, provides an over-constraint prevention 112 of the full size determinant assembly 14. In addition, the tooling assembly 10, such as the clamshell tooling assembly 10a, is a custom tooling design that can be used in a variety of full size determinant assembly build ups 18 (see FIG. 1) and that accurately positions and supports the frame section 26, such as the fuselage frame section 26a or the wing frame section 26b, for full size determinant assembly 14 (see FIG. 1). As used herein, “over-constraint” or “over-constraining” means a situation when an assembly jig holds an aircraft structure or another type of structure in such a manner that holes, such as full size holes, that are predrilled in aircraft components or parts or other structure's components or parts are unable to locate to one another.

Now referring to FIGS. 2A-2H, FIGS. 2A-2H show versions of the clamshell assembly 40, such as the primary clamshell assembly 42, that may be used in versions of the tooling assembly 10 (see FIG. 1) and the tooling system 12 (see FIG. 1) of the disclosure. FIG. 2A is an illustration of a front perspective view of an exemplary version of the clamshell assembly 40, such as the primary clamshell assembly 42, of the tooling assembly 10 (see FIG. 1) and the tooling system 12 (see FIG. 1) of the disclosure, in an assembled configuration 113, and having the stop tab 76. FIG. 2B is an illustration of a left side view of the clamshell assembly 40, such as the primary clamshell assembly 42, of FIG. 2A. FIG. 2C is an illustration of a back right side perspective view of the clamshell assembly 40, such as the primary clamshell assembly 42, of FIG. 2A. FIG. 2D is an illustration of a front cross-sectional view of the clamshell assembly 40, such as the primary clamshell assembly 42, of FIG. 2A. FIG. 2E is an illustration of a right side perspective view of the clamshell assembly 40, such as the primary clamshell assembly 42, of FIG. 2A, in an unassembled configuration 114.

FIG. 2F is an illustration of a back right side perspective view of the clamshell assembly 40, such as the primary clamshell assembly 42, of FIG. 2C, but with no stop tab 76 (see FIG. 2C), and in the assembled configuration 113. FIG. 2G is an illustration of a left side perspective view of the clamshell assembly 40, such as the primary clamshell assembly 42, of FIG. 2F. FIG. 2H is an illustration of a back right side perspective view of the clamshell assembly 40, such as the primary clamshell assembly 42, of FIG. 2F, in the unassembled configuration 114.

FIGS. 2I-2J show exemplary versions of hinge plates 74. FIG. 2I is an illustration of a back perspective enlarged view of an exemplary version of the hinge plate 74 with the stop tab 76 of the clamshell assembly 40, such as the primary clamshell assembly 42, of FIG. 2C. FIG. 2J is an illustration of a back perspective enlarged view of another exemplary version of the hinge plate 74 with no stop tab 76 (see FIG. 2I) of the clamshell assembly 40, such as the primary clamshell assembly 42, of FIG. 2F.

FIGS. 2K-2L show an exemplary version of the V-block 70. FIG. 2K is an illustration of a back right side perspective enlarged view of the V-block 70 of the clamshell assembly 40, such as the primary clamshell assembly 42, of FIG. 2E. FIG. 2L is an illustration of a bottom perspective enlarged view of the V-block 70 of FIG. 2K.

As shown in FIGS. 2A-2H, the clamshell assembly 40, such as the primary clamshell assembly 42, comprises the hinged clamshell structure 48 (see FIGS. 2A-2D, 2F, 2G), such as the primary hinged clamshell structure 50 (see FIGS. 2A-2D, 2F, 2G), having the hinged end 56 (see FIGS. 2A-2B, 2F-2G) with the hinge pin 58 (see FIGS. 2A-2B, 2F-2G) inserted through the hinged end 56. The hinged clamshell structure 48 further has the non-hinged end 60 (see FIGS. 2A-2B, 2F-2G). The hinged clamshell structure 48 is configured to move or pivot, and moves or pivots, back and forth between the closed position 62 (see FIG. 2B) and the open position 64 (see FIG. 2E). As shown in FIGS. 2B, 2G, the hinged clamshell structure 48 has a top 115a, a bottom 115b, a front 116a, and a back 116b. As shown in FIG. 2D, the hinged clamshell structure 48 has a first side 117a and a second side 117b.

The hinged clamshell structure 48, such as the primary hinged clamshell structure 50, comprises the upper clamshell portion 66 (see FIGS. 2A-2H) hingedly or pivotally connected, via the hinge pin 58, to the lower clamshell assembly 68 (see FIGS. 2A-2H). As shown in FIGS. 2E, 2H, the upper clamshell portion 66 has a first end 118a, a second end 118b, and a body 120, such as a T-shaped body 120a, disposed between the first end 118a and the second end 118b. As shown in FIGS. 2E, 2H, the upper clamshell portion 66 has a front plate side 122 at the first end 118a. As further shown in FIGS. 2E, 2H, the front plate side 122 has holes 124 formed through the front plate side 122, where the holes 124 are configured to receive, and do receive, latch plate fasteners 125 (see also FIG. 2A), such as latch plate bolts 125a. FIGS. 2E, 2H show four (4) holes 124 formed through the front plate side 122 configured to receive four (4) latch plate fasteners 125. However, the front plate side 122 may have one (1), two (2), three (3), or more than four (4) holes 124 configured to receive one (1), two (2), three (3), or more than four (4) latch plate fasteners 125. As further shown in FIGS. 2E, 2H, the upper clamshell portion 66 has a hinge knuckle 126 at the second end 118b with a hinge pin opening 128 through which the hinge pin 58 is inserted.

As shown in FIGS. 2A-2H, the lower clamshell assembly 68 comprises the V-block 70, the extender block 72 (see FIGS. 2A-2B, 2E, 2G, 2H) attached to the V-block 70, and the hinge plate 74 attached to the V-block 70. As shown in FIGS. 2E, 2H, 2K, 2L, the V-block 70 of the lower clamshell assembly 68 comprises a V-shaped interior recess 130 that is configured to hold, and holds, the pin 96 (see FIG. 7B). As further shown in FIGS. 2E, 2K, 2L, the V-shaped interior recess 130 includes downwardly sloped surfaces 132 sloping downwardly from a top end 133 of the V-block 70 and terminating in a center channel 134. The V-shaped interior recess 130 further includes two or more V-block through holes 136 (see FIGS. 2D, 2E, 2H, 2K, 2L) formed through portions of the center channel 134 and formed through the width of the V-block 70.

Each V-block through hole 136 is configured to receive, and receives, a bolt 138 (see FIGS. 2D, 2E, 2H), such as a precision shoulder bolt 138a (see FIGS. 2D, 2E, 2H), inserted through the length of the V-block through hole 136. As shown in FIGS. 2E, 2H, in one version, the V-block 70 has two (2) V-block through holes 136 formed through the V-block 70. However, in another version, the V-block 70 may have one (1) V-block through hole 136, or more than two (2) V-block through holes 136. As shown in FIG. 2D, in one version, there are two (2) V-block through holes 136 with two (2) bolts 138, such as two (2) precision shoulder bolts 138a, inserted through the length of the V-block through holes 136, and inserted through two (2) bushings 140. As further shown in FIGS. 2D, 2E, 2H, 2K, recessed portions 141 are formed around the top of the V-block through holes 136.

As shown in FIG. 2D, each bolt 138 is also inserted through a bushing hole 139 (see also FIGS. 2E, 2H) in a bushing 140 (see also FIGS. 2E, 2H) that is inserted into a bushing opening 142 (see also FIG. 2L) formed in the bottom end 144 (see also FIG. 2L) of the V-block 70. As shown in FIGS. 2D, 2L, in one version, the V-block 70 has two (2) bushing openings 142 formed in the V-block 70 and configured to receive, and receiving, two (2) bushings 140. However, in another version, the V-block 70 may have one (1) bushing opening 142, formed in the V-block 70 and configured to receive, and receiving, one (1) bushing 140, or more than two (2) bushing openings 142 formed in the V-block 70 and configured to receive, and receiving, more than two (2) bushings 140. As shown in FIGS. 2D, 2L, the V-block through holes 136 are coaxial with the bushing openings 142, and the V-block through holes 136 extend through interior portions of the V-block 70 between the center channel 134 and the bottom end 144.

As shown in FIGS. 2E, 2K, 2L, the V-block 70 has a front side 145 opposite a back side 146 and has a first side 148 opposite a second side 150. The center channel 134 (see FIGS. 2E, 2K) extends laterally across the V-block 70 between the first side 148 and the second side 150. As shown in FIG. 2E, the front side 145 has front side openings 152 that are configured to receive, and do receive, the ends of mounting plate fasteners 154 (see also FIGS. 2A, 2E, 2H). FIG. 2E shows two (2) front side openings 152 formed in the front side 145 and configured to receive the ends of two (2) mounting plate fasteners 154. However, the front side 145 may have one (1), or more than two (2), front side opening(s) 152 configured to receive one (1), or more than two (2), mounting plate fastener(s) 154. When the clamshell assembly 40, such as the primary clamshell assembly 42, is attached to an assembly jig 30 (see FIGS. 1, 10A), four (4) mounting plate fasteners 154 may be used, including two (2) mounting plate fasteners 154 attached to the extender block 72 and two (2) mounting plate fasteners 154 attached to the assembly jig 30.

As shown in FIGS. 2H, 2K, 2L, the back side 146 has back side openings 156 that are configured to receive, and receive, the ends of hinge plate fasteners 158 (see FIGS. 2E, 2F, 2H). FIGS. 2H, 2K, 2L, show four (4) back side openings 156 formed in the back side 146 and configured to receive the ends of four (4) hinge plate fasteners 158 (see FIG. 2H). However, the back side 146 may have one (1), two (2), three (3), or more than four (4) back side openings 156 configured to receive one (1), two (2), three (3), or more than four (4) hinge plate fasteners 158. As shown in FIGS. 2E, 2F, 2H, the hinge plate fasteners 158 comprise two (2) screws 158a and two (2) dowels 158b. As shown in FIG. 2E, the top row of hinge plate fasteners 158 comprise one (1) screw 158a and one (1) dowel 158b, and the bottom row of hinge plate fasteners 158 comprise one (1) dowel 158b under the screw 158a in the top row and comprise one (1) screw 158a under the dowel 158b. However, the hinge plate fasteners 158 may comprise another amount and/or another combination of screws 158a and dowels 158b, or may comprise other suitable fasteners.

As shown in FIGS. 2E, 2H, 2K, 2L, the first side 148 of the V-block 70 has a plurality of first side openings 160 that are configured to receive, and do receive, the ends of clamp plate fasteners 162 (see FIGS. 2E, 2H) and a threaded screw end 164a of a threaded screw 164 of a threaded hand knob 165. FIGS. 2E, 2H, 2K, 2L, show two (2) first side openings 160, such as two (2) first side dowel openings 160a, formed in the first side 148 of the V-block 70, and that are configured to receive, and do receive, the ends of two (2) clamp plate fasteners 162 (see FIGS. 2E, 2H), such as dowels 162a (see FIGS. 2E, 2H), or other suitable fasteners. However, the first side 148 may have one (1), or more than two (2), first side dowel openings 160a configured to receive one (1), or more than two (2), clamp plate fasteners 162, such as dowels 162a, or other suitable fasteners. FIGS. 2D, 2E, 2H, 2K, 2L, show one (1) first side threaded screw end opening 160b that is configured to receive, and does receive, the threaded screw end 164a (see FIG. 2E) of the threaded screw 164 (see FIG. 2E) of the threaded hand knob 165 (see FIG. 2E). As shown in FIG. 2E, the first side threaded screw end opening 160b is aligned with, and positioned between, the first side dowel openings 160a. However, the first side threaded screw end opening 160b and the first side dowel openings 160a may be formed and positioned in another suitable arrangement.

As shown in FIGS. 2E, 2H, 2K, 2L, the first side 148 of the V-block 70 further optionally has threaded openings 166 formed in the first side 148 of the V-block 70. FIGS. 2E, 2H, 2K, 2L show two (2) threaded openings 166 formed in the first side 148 and positioned above the first side openings 160. However, the first side 148 may have zero (0), one (1), or more than two (2) threaded openings 166, and the threaded openings 166 may be located in another suitable position on the first side 148 of the V-block 70. As shown in FIG. 2G, the second side 150 does not have any openings or holes formed in the second side 150.

As shown in FIGS. 2B, 2E, 2H, the extender block 72 of the lower clamshell assembly 68 the hinged clamshell structure 48, such as the primary hinged clamshell structure 50, has an extender block front side 167a and an extender block back side 167b. As shown in FIG. 2B, the extender block back side 167b is configured to be attached, and is attached, to the front side 145 of the V-block 70, via the mounting plate fasteners 154 (see also FIG. 2E). As shown in FIGS. 2E, 2H, the extender block 72 has extender block through openings 168 that align with the front side openings 152 in the front side 145 of the V-block 70, and the extender block through openings 168 are configured to receive, and do receive, the mounting plate fasteners 154. The mounting plate fasteners 154 are inserted through the extender block through openings 168 and through the front side openings 152. As shown in FIGS. 2E, 2G, 2H, the extender block 72 has an extender block top end 169a and an extender block bottom end 169b.

As shown in FIGS. 2C, 2E, 2H, the hinge plate 74 of the lower clamshell assembly 68 of the hinged clamshell structure 48, such as the primary hinged clamshell structure 50, is configured to be attached, and is attached, to the back side 146 of the V-block 70, via the hinge plate fasteners 158. As shown in FIGS. 2E, 2H, 2I, 2J, the hinge plate 74 has hinge plate through openings 170 formed through a plate body 172 of the hinge plate 74 through which the hinge plate fasteners 158 (see FIGS. 2E, 2F, 2H) are inserted through, such as the screws 158a and the dowels 158b. FIGS. 2E, 2H show four (4) hinge plate through openings 170 formed through the hinge plate 74 and that are configured to receive, and do receive, the hinge plate fasteners 158. However, the hinge plate 74 may have one (1), two (2), three (3), or more than four (4) hinge plate through openings 170 that are configured to receive, and do receive, one (1), two (2), three (3), or more than four (4) hinge plate fasteners 158.

As shown in FIGS. 2E, 2I, 2J, the hinge plate 74 has an inner side 174a and an outer side 174b. As further shown in FIGS. 2I, 2J, the hinge plate 74 has an upper end 175a and a lower end 175b.

As further shown in FIGS. 2E, 2F, 2H, 2I, 2J, the hinge plate 74 has at the upper end 175a a first hinge knuckle 126a having a first hinge pin opening 128a and a second hinge knuckle 126b having a second hinge pin opening 128b. As shown in FIG. 2I, 2J, the first hinge knuckle 126a is aligned with the second hinge knuckle 126b, and the first hinge pin opening 128a is coaxial with the second hinge pin opening 128b along axis 176. As further shown in FIGS. 2I, 2J, the hinge plate 74 has an open portion 177, or notched portion, between the first hinge knuckle 126a and the second hinge knuckle 126b. The open portion 177, or notched portion, is sized to fit and accommodate the hinge knuckle 126 (see FIGS. 2E, 2H) of the upper clamshell portion 66 (see FIGS. 2E, 2H), when the upper clamshell portion 66 is hingedly coupled together with the lower clamshell assembly 68 (see FIGS. 2E, 2H), via the hinge pin 58 (see FIGS. 2E, 2F, 2H) to form the hinged end 56 (see FIG. 2F).

As shown in FIGS. 2C, 2F, the hinge pin 58, including the tail end 59b (see FIGS. 2E, 2H), such as a threaded screw end, is configured for insertion, and is inserted, through the first hinge pin opening 128a of the first hinge knuckle 126a of the hinge plate 74, through the hinge pin opening 128 (see FIG. 2E) of the hinge knuckle 126 of the upper clamshell portion 66, and through the second hinge pin opening 128b (see FIG. 2E) of the second hinge knuckle 126b of the hinge plate 74, to hingedly connect together the upper clamshell portion 66 and the lower clamshell assembly 68 at the hinged end 56. As shown in FIG. 2A, when the hinge pin 58, such as the shoulder bolt 58a, is inserted at the hinge end 56, the head end 59a of the hinge pin 58 is at an exterior of the first hinge pin opening 128a (see FIG. 2C).

In one version, as shown in FIGS. 2A-2E, 2I, the hinge plate 74 has the stop tab 76, configured to stop the upper clamshell portion 66 from over-pivoting, when the upper clamshell portion 66 is pivoted upward from the closed position 62 (see FIG. 2B) of the hinged clamshell structure 48 to the open position 64 (see FIG. 2E) of the hinged clamshell structure 48. In one version, as shown in FIGS. 2A-2E, 2I, the hinge plate 74 has the stop tab 76 attached to, or integral with, the hinge plate 74. As shown in FIG. 2I, the stop tab 76 has an attachment portion 178 and a stop portion 180. The stop portion 180 is integral with the attachment portion 178, and angled away from, and outwardly, with respect to the attachment portion 178. The attachment portion 178 has an inner side 182a (see FIG. 2I) and an outer side 182b (see FIG. 2I). As shown in FIG. 2I, the inner side 182a of the attachment portion 178 of the stop tab 76 is attached to, or integral with, a portion of the outer side 174b of the hinge plate 74. As further shown in FIG. 2I, the stop portion 180 is positioned between the first hinge knuckle 126a and the second hinge knuckle 126b and aligned with the open portion 177, or notched portion. The stop portion 180 has a width that is slightly wider than a width of the open portion 177, or notched portion. The stop portion 180 has a height that extends higher than the tops of the first hinge knuckle 126a and the second hinge knuckle 126b, and that extends higher than the top of the hinge knuckle 126 (see FIG. 2C), when the clamshell assembly 40 is in the assembled configuration 113. The stop portion 180 has a height that is greater than a height of the first hinge knuckle 126a, that is greater than a height of the second hinge knuckle 126b, and that is greater than a height of the hinge knuckle 126.

In another version, as shown in FIGS. 2F-2G, 2J, the hinge plate 74 does not have the stop tab 76 (see FIG. 2I). The stop tab 76 is an optional feature.

As shown in FIGS. 2A-2C, 2E-2H, the clamshell assembly 40, such as the primary clamshell assembly 42, further comprises the latch assembly 84. As shown in FIG. 2B, the latch assembly 84 is attached to the non-hinged end 60 of the hinged clamshell structure 48, to latch the hinged clamshell structure 48 in the closed position 62 (see FIG. 2A). As shown in FIGS. 2A, 2E, 2H, the latch assembly 84 comprises a latch plate 184 having a hook 185, such as a J-hook 185a, attached to, or integral with, a portion of a front side 186a of the latch plate 184. The latch plate 184 further has a back side 186b (see FIG. 2H) that is configured to attach, and is attached, to the front plate side 122 (see FIG. 2E) of the upper clamshell portion 66 (see FIG. 2E) of the hinged clamshell structure 48. As further shown in FIGS. 2E, 2H, the latch plate 184 has latch plate openings 188 formed through the latch plate 184 through which the latch plate fasteners 125 (see FIGS. 2A, 2E, 2H) are inserted through. FIGS. 2E, 2H show four (4) latch plate openings 188 formed through the latch plate 184 and that are configured to receive, and do receive, the latch plate fasteners 125. However, the latch plate 184 may have one (1), two (2), three (3), or more than four (4) latch plate openings 188 that are configured to receive, and do receive, one (1), two (2), three (3), or more than four (4) latch plate fasteners 125. As shown in FIG. 2A, the latch plate 184 is attached, via the plurality of latch plate fasteners 125, to the front plate side 122 (see FIG. 2E) of the upper clamshell portion 66 of the hinged clamshell structure 48, such as the primary hinged clamshell structure 50.

As shown in FIGS. 2A-2C, 2E-2H, the latch assembly 84 further comprises a latch clamp mechanism 190. As shown in FIGS. 2A, 2E, 2H, the latch clamp mechanism 190 comprises a mounting plate 192 with mounting plate holes 194 (see FIGS. 2E, 2H) through which the mounting plate fasteners 154, such as top mounting bolts 154a, are inserted through. FIGS. 2E, 2H show four (4) mounting plate holes 194 formed through the mounting plate 192 and that are configured to receive, and do receive, the mounting plate fasteners 154. However, the mounting plate 192 may have one (1), two (2), three (3), or more than four (4) mounting plate holes 194 that are configured to receive, and do receive, one (1), two (2), three (3), or more than four (4) mounting plate fasteners 154.

As shown in FIGS. 2A-2B, the mounting plate 192 is attached, via two (2) mounting plate fasteners 154 through the extender block through openings 168 (see FIGS. 2E, 2H) formed through the extender block 72, and into the front side openings 152 (see FIGS. 2E, 2H) of the V-block 70. As shown in FIG. 2E, the two (2) mounting plate fasteners 154 are configured to be inserted through two (2) mounting plate holes 194 formed through the mounting plate 192, are configured to be inserted through two (2) extender block through openings 168 formed through the extender block 72, and are configured to be inserted into two (2) front side openings 152 formed in the front side 145 of the V-block 70.

As shown in FIGS. 2B, 2H, the mounting plate 192 has a top row of mounting plate holes 194, such as two (2) top mounting plate holes 194a, configured to receive, and receiving, the mounting plate fasteners 154, such as the top mounting bolts 154a, to attach the top portion of the mounting plate 192 to the extender block 72. As further shown in FIGS. 2B, 2H, the mounting plate 192 has a bottom row of mounting plate holes 194, such as two (2) bottom mounting plate holes 194b, configured to receive, and receiving, the mounting plate fasteners 154, such as bottom mounting bolts 154b (see FIGS. 2B, 2C), to attach the bottom portion of the mounting plate 192 to an assembly jig 30 (see FIGS. 7A, 10A).

As shown in FIGS. 2E, 2H, the latch clamp mechanism 190 further comprises a latch clamp handle 195 coupled, or attached, to the mounting plate 192. As shown in FIGS. 2A, 2E, the latch clamp handle 195 is attached to the mounting plate 192, via a pivot mount 196 and a pivot pin 198 inserted through the latch clamp handle 195 and the pivot mount 196. The latch clamp mechanism 190 further comprises a latch clamp 200 (see FIGS. 2A, 2E, 2H), such as a U-shaped latch clamp 200a (see FIGS. 2A, 2E, 2H), having threaded ends 202 (see FIGS. 2A, 2E, 2H) and a latch clamp bar 204 (see FIGS. 2A, 2E, 2H). The threaded ends 202 are coupled, or attached, to the mounting plate 192, via nuts 205 (see FIGS. 2A, 2E) and a cross pin 206 (see FIGS. 2A, 2E), or another suitable coupling or attachment means. As shown in FIG. 2A, the latch clamp bar 204 of the U-shaped latch clamp 200a is latched over the hook 185, such as the J-hook 185a, on the latch plate 184, to close and lock the latch assembly 84, so that the latch assembly 84 is in a closed position 62a, and to close and lock the hinged clamshell structure 48, so that the hinged clamshell structure 48 is in the closed position 62.

As shown in FIGS. 2A-2B, 2E, the latch clamp mechanism 190 further comprises a safety lock release lever 208 coupled to the mounting plate 192. The safety lock release lever 208 is also coupled to an internal integral safety lock (not shown) and is configured to release the internal integral safety lock, to unlock the latch clamp 200 and the latch assembly 84. The internal integral safety lock automatically engages when the latch clamp 200 is closed, then remains locked until manually disengaged by pressing the safety lock release lever 208 before opening. This prevents the latch clamp 200 and the latch assembly 84 from being accidentally opened by bumping the latch clamp handle 195.

Once the internal integral safety lock is released to open the latch clamp 200, the latch clamp handle 195 (see FIG. 2A) can be manually moved and pivoted upwardly to unlatch the latch clamp bar 204 (see FIG. 2A) from over the J-hook 185a (see FIG. 2A), to open the latch assembly 84 (see FIG. 2A). To close the latch assembly 84, the latch clamp bar 204 is latched over the J-hook 185a and the latch clamp handle 195 is manually moved and pivoted downwardly to latch the latch assembly 84 in the closed position 62a (see FIG. 2A) and lock the latch clamp 200 and the latch assembly 84 with the internal integral safety lock, thus latching and locking the hinged clamshell structure 48, so that the hinged clamshell structure 48 is in the closed position 62 (see FIG. 2A).

As shown in FIGS. 2A, 2C-2F, 2H, the clamshell assembly 40, such as the primary clamshell assembly 42, further comprises the clamp assembly 86. The clamp assembly 86 comprises a clamp plate 210 (see FIGS. 2A, 2D, 2E, 2H) having an L-shaped block configuration 212 (see FIGS. 2E, 2H) with an inner side 214 (see FIGS. 2D, 2E, 2H), an outer side 215 (see FIGS. 2D, 2E, 2H), a first portion 216a (see FIGS. 2D, 2E, 2F), such as a first base portion, and a second portion 216b (see FIGS. 2D, 2E, 2H), such as a second vertical portion. As shown in FIG. 2D, the clamp plate 210 has a bottom end 217a and a top end 217b.

As shown in FIGS. 2E, 2H, the clamp plate 210 has clamp plate through holes 218, including a plurality of first clamp plate through holes 218a, formed through the clamp plate 210, such as the first portion 216a of the clamp plate 210. As further shown in FIGS. 2E, 2H, the clamp plate 210 has a clamp plate through hole 218, such as a second clamp plate through hole 218b, formed through the clamp plate 210, such as the first portion 216a of the clamp plate 210, and positioned between the first clamp plate through holes 218a.

As shown in FIGS. 2E, 2H, the clamp assembly 86 further comprises a plurality of clamp plate fasteners 162, such as dowels 162a (see also FIG. 2A), or other suitable fasteners. The plurality of clamp plate fasteners 162 (see FIGS. 2E, 2H), for example, two (2) clamp plate fasteners 162, are inserted through the plurality of first clamp plate through holes 218a (see FIGS. 2E, 2H), for example, two (2) first clamp plate through holes 218a, to attach an inner side portion 214a (see FIG. 2D) of the inner side 214 (see FIG. 2D) of the clamp plate 210 (see FIG. 2D) to a portion of the first side 117a (see FIG. 2D) of the hinged clamshell structure 48 (see FIG. 2D), such as to the first side 148 (see FIG. 2D) of the V-block 70 (see FIG. 2D) of the hinged clamshell structure 48.

As shown in FIGS. 2D, 2E, 2H, the clamp assembly 86 further comprises the threaded hand knob 165. The threaded hand knob 165 comprises the threaded screw 164 with the threaded screw end 164a that is inserted through the clamp plate through hole 218, such as the second clamp plate through hole 218b, to attach the threaded hand knob 165 to a portion of the first side 117a (see FIG. 2D) of the hinged clamshell structure 48 (see FIG. 2D), such as to the first side 148 (see FIG. 2D) of the V-block 70 (see FIG. 2D) of the hinged clamshell structure 48. As further shown in FIGS. 2D, 2E, 2H, the threaded hand knob 165, which is used to tighten and loosen the clamp plate 210 to the V-block 70, has a hand knob 220, a collar 222, and a nut 224. As shown in FIG. 2D, the threaded screw 164 is inserted in the interior of the hand knob 220, is inserted through the collar 222, is inserted through the nut 224, and is inserted through the clamp plate 210, and the threaded screw end 164a of the threaded screw 164 is inserted in the V-block 70. Two or more of the hand knob 220, the collar 222, and the threaded screw 164 may be integrally formed as a uniform part, or may comprise separate parts coupled together.

In one version, FIGS. 2E, 2H, show two (2) first clamp plate through holes 218a formed through the first portion 216a of the clamp plate 210 and that are configured to receive, and do receive, the clamp plate fasteners 162, such as dowels 162a, or other suitable fasteners. In other versions, the first portion 216a of the clamp plate 210 may have one (1), or more than two (2), first clamp plate through holes 218a configured to receive one (1), or more than two (2), clamp plate fasteners 162, such as dowels 162a. In one version, FIGS. 2E, 2H further show one (1) second clamp plate through hole 218b formed through the first portion 216a of the clamp plate 210 and that is configured to receive, and does receive, the threaded screw end 164a and the threaded screw 164 of the threaded hand knob 165. In other versions, the first portion 216a of the clamp plate 210 may have more than one second clamp plate through hole 218b. As shown in FIG. 2D, the inner side portion 214a of the clamp plate 210 is coupled, or attached, to the first side 148 of the V-block 70 of the hinged clamshell structure 48, via the threaded screw end 164a of the threaded screw 164 of the threaded hand knob 165, and via the clamp plate fasteners 162 (see FIGS. 2E, 2H), such as the dowels 162a (see FIGS. 2E, 2H).

As shown in FIGS. 2E, 2H, the clamp plate through holes 218, such as first clamp plate through holes 218a, are aligned with, and coaxial with, the first side dowel openings 160a in the V-block 70, and the clamp plate through hole 218, such as the second clamp plate through hole 218b, is aligned with, and coaxial with, the first side threaded screw end opening 160b in the V-block 70. As shown in FIGS. 2E, 2H, the dowels 162a are configured to be inserted through the first clamp plate through holes 218a through the clamp plate 210 and into the first side dowel openings 160a in the V-block 70, to attach the clamp plate 210 to the V-block 70. As shown in FIG. 2D, the threaded screw end 164a of the threaded screw 164 of the threaded hand knob 165 is inserted through the second clamp plate through hole 218b through the clamp plate 210 and into the first side threaded screw end opening 160b in the V-block 70, to attach the threaded hand knob 165 to the clamp plate 210 and to the V-block 70.

As shown in FIGS. 2A-2H, the clamshell assembly 40, such as the primary clamshell assembly 42, further comprises the base plate 225, such as the pour plate 225a, attached to the bottom 115b (see FIG. 2B) of the hinged clamshell structure 48, such as the primary hinged clamshell structure 50. As shown in FIGS. 2D, 2E, 2H, the base plate 225 has a top side 226a, a bottom side 226b, and a body 228 having a rectangle-shaped configuration 230 disposed between the top side 226a and the bottom side 226b. As shown in FIGS. 2D, 2E, 2H, the base plate 225 has base plate through holes 232, such as two (2) base plate through holes 232, formed through the body 228 of the base plate 225. As shown in FIG. 2D, the base plate 225 is attached to the V-block 70 with the bolts 138, such as the precision shoulder bolts 138a, extending through the V-block through holes 136 of the V-block 70 and through the base plate through holes 232 of the body 228 of the base plate 225. As shown in FIG. 2D, a portion of the top side 226a of the base plate 225 is adjacent and attached to the bottom end 144 of the V-block 70 and another portion of the top side 226a of the base plate 225 is adjacent the bottom end 217a of the clamp plate 210. As shown in FIG. 2C, another portion of the top side 226a of the base plate 225 is adjacent a portion of the lower end 175b of the hinge plate 74. As shown in FIG. 2G, another portion of the top side 226a of the base plate 225 is adjacent a portion of the extender block bottom end 169b of the extender block 72.

The base plate 225, such as the pour plate 225a, is designed to support the hinged clamshell structure 48, such as the primary hinged clamshell structure 50, and the clamp plate 210. The base plate 225 is directly adjacent the lower clamshell assembly 68, including the V-block 70, the extender block 72, and the hinge plate 74. In addition, the base plate 225 is directly adjacent the clamp plate 210.

Preferably, in one version, the upper clamshell portion 66, the lower clamshell assembly 68 including the V-block 70, the extender block 72, the hinge plate 74 and the optional stop tab 76, as well as the latch plate 184, the clamp plate 210, and the base plate 225 of the clamshell assembly 40, such as the primary clamshell assembly 42, are each one-piece, unitary, monolithic configurations. In other versions, one or more of the upper clamshell portion 66, the lower clamshell assembly 68 including the V-block 70, the extender block 72, the hinge plate 74 and the optional stop tab 76, as well as the latch plate 184, the clamp plate 210, and the base plate 225 may be made of two or more pieces or parts coupled, or attached, together with a suitable attachment means.

The sizes of the upper clamshell portion 66, the lower clamshell assembly 68 including the V-block 70, the extender block 72, the hinge plate 74 and the optional stop tab 76, as well as the latch assembly 84 including the latch plate 184, the clamp assembly 86 including the clamp plate 210, and the base plate 225 may be scaled up or down depending on the usage and size of the assembly jig 30. For example, for an assembly jig 30 that is small, these parts may each be sized down to a several inches, and for an assembly jig 30 that is large, these parts may each be sized up to several feet or more. In one version, one or more of the upper clamshell portion 66, the lower clamshell assembly 68 including the V-block 70, the extender block 72, the hinge plate 74 and the optional stop tab 76, as well as the latch assembly 84 including the latch plate 184, the clamp assembly 86 including the clamp plate 210, and the base plate 225 are made of a metal material including steel, stainless steel, aluminum, aluminum alloy, or another suitable metal material. In other versions, one or more of the upper clamshell portion 66, the lower clamshell assembly 68 including the V-block 70, the extender block 72, the hinge plate 74 and the optional stop tab 76, as well as the latch assembly 84 including the latch plate 184, the clamp assembly 86 including the clamp plate 210, and the base plate 225 are made of nylon, polyoxymethylene (POM) a high-performance acetal homopolymer resin that is durable, stiff, and stable, wood, or another suitable material.

Now referring to FIGS. 3A-3H, FIGS. 3A-3H show versions of a clamshell assembly 40, such as a secondary clamshell assembly 44, that may be used in versions of the tooling assembly 10 (see FIG. 1) and the tooling system 12 (see FIG. 1) of the disclosure. In one version, the clamshell assembly 40, such as the secondary clamshell assembly 44, locates the aircraft structure 20, or another type of structure 19, in the y-axis direction 36 (see FIG. 1) and in the z-axis direction 38 (see FIG. 1), and allows floating of the pin 96 (see FIGS. 1, 5A, 6A) in the x-axis direction 34 (see FIG. 1).

FIG. 3A is an illustration of a front perspective view of an exemplary version of the clamshell assembly 40, such as the secondary clamshell assembly 44, of the tooling assembly 10 (see FIG. 1) and the tooling system 12 (see FIG. 1) of the disclosure, and in the assembled configuration 113 and having the stop tab 76. FIG. 3B is an illustration of a left side view of the clamshell assembly 40, such as the secondary clamshell assembly 44 of FIG. 3A. FIG. 3C is an illustration of a back right side view of the clamshell assembly 40, such as the secondary clamshell assembly 44, of FIG. 3A. FIG. 3D is an illustration of a front cross-sectional view of the clamshell assembly 40, such as the secondary clamshell assembly 44, of FIG. 3A. FIG. 3E is an illustration of a right side perspective view of the clamshell assembly 40, such as the secondary clamshell assembly 44, of FIG. 3A in the unassembled configuration 114.

FIG. 3F is an illustration of back right side perspective view of the clamshell assembly 40, such as the secondary clamshell assembly 44, of FIG. 3C, in the assembled configuration 113, and with no stop tab 76 (see FIG. 3A). FIG. 3G is an illustration of a left side perspective view of the clamshell assembly 40, such as the secondary clamshell assembly 44, of FIG. 3F. FIG. 3H is an illustration of a back perspective view of the clamshell assembly 40, such as the secondary clamshell assembly 44, of FIG. 3F, in the unassembled configuration 114.

Now referring to FIGS. 3I-3J, FIG. 3I is an illustration of a back right side perspective enlarged view of an exemplary version of a lower clamshell portion 78 of the clamshell assembly 40, such as the secondary clamshell assembly 44, of FIG. 3E, having an integral hinge plate 74a with the stop tab 76. FIG. 3J is an illustration of a bottom right side perspective enlarged view of an exemplary version of the lower clamshell portion 78 of the clamshell assembly 40, such as the secondary clamshell assembly 44, of FIG. 3H, having the integral hinge plate 74a with no stop tab 76 (see FIG. 3I).

As shown in FIGS. 3A-3H, the clamshell assembly 40, such as the secondary clamshell assembly 44, comprises the hinged clamshell structure 48 (see FIGS. 3A-3D, 3F, 3G), such as the secondary hinged clamshell structure 52 (see FIGS. 3A-3D, 3F, 3G), having the hinged end 56 (see FIGS. 3A-3B, 3F-3G) with the hinge pin 58 (see FIGS. 3A-3B, 3F-3G) inserted through the hinged end 56. The hinged clamshell structure 48 further has the non-hinged end 60 (see FIGS. 3A-3B, 3F-3G). The hinged clamshell structure 48 is configured to move or pivot, and moves or pivots, back and forth between the closed position 62 (see FIG. 3B) and the open position 64 (see FIG. 3E). As shown in FIGS. 3B, 3G, the hinged clamshell structure 48 has a top 115a, a bottom 115b, a front 116a, and a back 116b. As shown in FIG. 3D, the hinged clamshell structure 48 has a first side 117a and a second side 117b (see also FIG. 3B).

The hinged clamshell structure 48, such as the secondary hinged clamshell structure 52, comprises the upper clamshell portion 66 (see FIGS. 3A-3H) hingedly or pivotally connected, via the hinge pin 58, to the lower clamshell portion 78 (see FIGS. 3A-3J). The upper clamshell portion 66 of the secondary hinged clamshell structure 52, shown in FIGS. 3A-3H, is similar to the upper clamshell portion 66 of the primary hinged clamshell structure 50, shown in FIGS. 2A-2H.

As shown in FIGS. 3E, 3H, the upper clamshell portion 66 has the first end 118a, the second end 118b, the body 120, such as the T-shaped body 120a, disposed between the first end 118a and the second end 118b, the front plate side 122 at the first end 118a, and holes 124 formed through the front plate side 122, where the holes 124 are configured to receive, and receive, the latch plate fasteners 125, such as the latch plate bolts 125a. FIGS. 3E, 3H show four (4) holes 124 (see also FIG. 3E) formed through the front plate side 122 configured to receive four (4) latch plate fasteners 125. However, the front plate side 122 may have one (1), two (2), three (3), or more than four (4) holes 124 configured to receive one (1), two (2), three (3), or more than four (4) latch plate fasteners 125. As further shown in FIGS. 3E, 3H, the upper clamshell portion 66 has the hinge knuckle 126 at the second end 118b with the hinge pin opening 128 through which the hinge pin 58 is inserted.

As shown in FIGS. 3A-3J, the hinged clamshell structure 48, such as the secondary hinged clamshell structure 52, comprises the lower clamshell portion 78. The lower clamshell portion 78 is preferably a one-piece, unitary, monolithic configuration instead of a combination of multiple parts, such as the V-block 70 (see FIG. 2E), the extender block 72 (see FIG. 2E), and the hinge plate 74 (see FIG. 2E) of the primary hinged clamshell structure 50, shown in FIGS. 2A-2H.

As shown in FIGS. 3D, 3E, 3H, 3I, 3J, the lower clamshell portion 78 comprises the block 80 with the top flat portion 82 having two or more block through holes 136a formed through portions of the top flat portion 82 and through the of the block 80. Each block through hole 136a is configured to receive, and receives, a bolt 138 (see FIGS. 3D, 3E, 3H), such as a precision shoulder bolt 138a (see FIGS. 3D, 3E, 3H), inserted through the length of the block through hole 136a. As shown in FIGS. 3E, 3H, in one version, the block 80 has two (2) block through holes 136a formed through the block 80. However, in another version, the block 80 may have one (1) block through hole 136a, or more than two (2) block through holes 136a.

As shown in FIG. 3D, each bolt 138 is also inserted through a bushing hole 139 in a bushing 140 that is inserted into a block bushing opening 142a (see also FIGS. 3H, 3J) formed in the block bottom end 144a of the block 80. As shown in FIGS. 3D, 3H, 3J, in one version, the block 80 has two (2) block bushing openings 142a formed in the block 80 and configured to receive, and receiving, two (2) bushings 140. However, in another version, the block 80 may have one (1) block bushing opening 142a, formed in the block 80 and configured to receive, and receiving, one (1) bushing 140, or more than two (2) block bushing openings 142a formed in the block 80 and configured to receive, and receiving, more than two (2) bushings 140. As shown in FIGS. 3D, 3J, the block through holes 136a are coaxial with the block bushing openings 142a, and the block through holes 136a extend through interior portions of the block 80 between the top flat portion 82 and a block bottom end 144a.

As shown in FIGS. 3B, 3D, 3E, 3H, 3I, 3J, the block 80 has a block top end 133a, has the block bottom end 144a, has a block front side 145a (see FIGS. 3B, 3E, 3H, 3I, 3J) opposite a block back side 146a (see FIGS. 3B, 3E, 3H, 3I, 3J), and has a block first side 148a (see FIGS. 3D, 3E, 3H, 3I, 3J) opposite a block second side 150a.

The block front side 145a (see FIGS. 3B, 3E) has block front side openings 152a (see FIGS. 3B, 3E) that are configured to receive, and do receive, the ends of mounting plate fasteners 154 (see FIGS. 3B, 3E), such as top mounting bolts 154a (see FIGS. 3B, 3E). FIG. 3E shows two (2) block front side openings 152a formed in the block front side 145a and configured to receive the ends of two (2) mounting plate fasteners 154, such as two (2) top mounting bolts 154a. However, the block front side 145a may have one (1), or more than two (2), block front side opening(s) 152a configured to receive one (1), or more than two (2), mounting plate fastener(s) 154. When the clamshell assembly 40, such as the secondary clamshell assembly 44, is attached to the assembly jig 30 (see FIGS. 1, 10A), four (4) mounting plate fasteners 154 may be used, including two (2) mounting plate fasteners 154 attached to the block 80 and two (2) mounting plate fasteners 154 attached to the assembly jig 30.

As shown in FIGS. 3E, 3H, 3I, 3J, the block first side 148a has a plurality of first side openings 160 that are configured to receive, and do receive, the ends of clamp plate fasteners 162 (see FIGS. 3E, 3H) and the threaded screw end 164a of the threaded screw 164 of the threaded hand knob 165. FIGS. 3E, 3K, 3L, show two (2) first side dowel openings 160a formed in the block first side 148a of the block 80 that are configured to receive, and do receive, the ends of two (2) clamp plate fasteners 162 (see FIGS. 3E, 3H), such as dowels 162a (see FIGS. 3E, 3H), or other suitable fasteners. However, the block first side 148a may have one (1), or more than two (2), first side dowel openings 160a configured to receive one (1), or more than two (2), clamp plate fasteners 162, such as dowels 162a, or other suitable fasteners. FIGS. 3D, 3E, 3I, 3J, show one (1) first side threaded screw end opening 160b formed in the block first side 148a of the block 80 between the first side dowel openings 160a, and that is configured to receive, and does receive, the threaded screw end 164a (see FIG. 3E) of the threaded screw 164 (see FIG. 3E) of the threaded hand knob 165 (see FIG. 3E). As shown in FIG. 3E, the first side threaded screw end opening 160b is aligned with, and positioned between, the first side dowel openings 160a. However, the first side threaded screw end opening 160b and the first side dowel openings 160a may be formed and positioned in another suitable arrangement.

As shown in FIGS. 3A-3J, the secondary hinged clamshell structure 52 comprises the integral hinge plate 74a integral with the block back side 146a (see FIGS. 3I, 3J) of the block 80. As shown in FIGS. 3I, 3J, the integral hinge plate 74a has an inner side 234a and an outer side 234b. As further shown in FIGS. 3I, 3J, the integral hinge plate 74a has an upper end 235a and a lower end 235b. As further shown in FIGS. 3E, 3H, 3I, 3J, the integral hinge plate 74a has at the upper end 235a (see FIGS. 3I, 3J) the first hinge knuckle 126a having the first hinge pin opening 128a and the second hinge knuckle 126b having the second hinge pin opening 128b. As shown in FIG. 3I, 3J, the first hinge knuckle 126a is aligned with the second hinge knuckle 126b, and the first hinge pin opening 128a is coaxial with the second hinge pin opening 128b along axis 176. As further shown in FIGS. 3I, 3J, the integral hinge plate 74a has an open portion 177, or notched portion, between the first hinge knuckle 126a and the second hinge knuckle 126b. The open portion 177, or notched portion, is sized to fit and accommodate the hinge knuckle 126 (see FIGS. 3E, 3H) of the upper clamshell portion 66 (see FIGS. 3E, 3H), when the upper clamshell portion 66 is hingedly coupled together with the lower clamshell portion 78 (see FIGS. 3E, 3H), via the hinge pin 58 (see FIGS. 3E, 3F, 3H) to form the hinged end 56 (see FIG. 3F).

As shown in FIGS. 3C, 3F, the hinge pin 58, including the tail end 59b (see FIGS. 3E, 3H), such as a threaded screw end, is configured for insertion, and is inserted, through the first hinge pin opening 128a of the first hinge knuckle 126a of the integral hinge plate 74a, through the hinge pin opening 128 (see FIG. 3E) of the hinge knuckle 126 of the upper clamshell portion 66, and through the second hinge pin opening 128b (see FIG. 3E) of the second hinge knuckle 126b of the integral hinge plate 74a, to hingedly connect together the upper clamshell portion 66 and the lower clamshell assembly 68 at the hinged end 56. As shown in FIG. 3C, when the hinge pin 58, such as the shoulder bolt 58a, is inserted at the hinge end 56, the head end 59a of the hinge pin 58 is at an exterior of the first hinge pin opening 128a (see FIG. 3C).

In one version, as shown in FIGS. 3A-3E, 3I, the integral hinge plate 74a has the stop tab 76, configured to stop the upper clamshell portion 66 from over-pivoting, when the upper clamshell portion 66 is pivoted upward from the closed position 62 (see FIG. 3B) of the hinged clamshell structure 48 to the open position 64 (see FIG. 3E) of the hinged clamshell structure 48. In one version, as shown in FIGS. 3A-3E, 3I, the integral hinge plate 74a has the stop tab 76 attached to, or integral with, the integral hinge plate 74a. The stop tab 76 in FIGS. 3A-3E, 3I is similar to the stop tab 76 of FIGS. 2A-2E, 2I. As shown in FIG. 3I, and as discussed above, the stop tab 76 has the stop portion 180 that is integral with the attachment portion 178, and angled away from, and outwardly, with respect to the attachment portion 178. The attachment portion 178 has the inner side 182a (see FIG. 3I) and the outer side 182b (see FIG. 3I). As shown in FIG. 3I, the inner side 182a of the attachment portion 178 of the stop tab 76 is attached to, or integral with, a portion of the outer side 174b of the integral hinge plate 74a. As further shown in FIG. 3I, the stop portion 180 is positioned between the first hinge knuckle 126a and the second hinge knuckle 126b and aligned with the open portion 177, or notched portion. The stop portion 180 has a width that is slightly wider than a width of the open portion 177, or notched portion. The stop portion 180 has a height that extends higher than the tops of the first hinge knuckle 126a and the second hinge knuckle 126b, and that extends higher than the top of the hinge knuckle 126 (see FIG. 3C), when the clamshell assembly 40 is in the assembled configuration 113. The stop portion 180 has a height that is greater than a height of the first hinge knuckle 126a, that is greater than a height of the second hinge knuckle 126b, and that is greater than a height of the hinge knuckle 126.

In another version, as shown in FIGS. 3F-3G, 3J, the integral hinge plate 74a does not have the stop tab 76 (see FIG. 3I). The stop tab 76 is an optional feature.

As shown in FIGS. 3A-3C, 3E-3H, the clamshell assembly 40, such as the secondary clamshell assembly 44, further comprises the latch assembly 84. The latch assembly 84 shown in FIGS. 3A-3C, 3E-3H of the secondary clamshell assembly 44 is similar to the latch assembly 84 shown in FIGS. 2A-2C, 2E-2H of the primary clamshell assembly 42. As shown in FIG. 3B, the latch assembly 84 is attached to the non-hinged end 60 of the hinged clamshell structure 48, to latch the hinged clamshell structure 48 in the closed position 62 (see FIG. 3A). As shown in FIGS. 3A, 3E, the latch assembly 84 comprises the latch plate 184 having the hook 185, such as the J-hook 185a, attached to, or integral with a portion of the front side 186a of the latch plate 184. The latch plate 184 further has the back side 186b (see FIGS. 3E, 3H) that is configured to attach, and is attached, to the front plate side 122 (see FIG. 3E) of the upper clamshell portion 66 (see FIG. 3E) of the hinged clamshell structure 48. As further shown in FIGS. 3A, 3E, 3H, the latch plate 184 has latch plate openings 188 formed through the latch plate 184 through which the latch plate fasteners 125 (see FIGS. 3A, 3E, 3H) are inserted through. FIG. 3E shows four (4) latch plate openings 188 formed through the latch plate 184 that are configured to receive, and do receive, the latch plate fasteners 125. However, the latch plate 184 may have one (1), two (2), three (3), or more than four (4) latch plate openings 188 that are configured to receive, and do receive, one (1), two (2), three (3), or more than four (4) latch plate fasteners 125. As shown in FIG. 3A, the latch plate 184 is attached, via the plurality of latch plate fasteners 125, to the front plate side 122 (see FIG. 3E) of the upper clamshell portion 66 of the hinged clamshell structure 48, such as the secondary hinged clamshell structure 52.

As shown in FIGS. 3A, 3E, 3H, the latch assembly 84 further comprises the latch clamp mechanism 190. As shown in FIGS. 3A, 3E, 3H, the latch clamp mechanism 190 comprises the mounting plate 192 with mounting plate holes 194 through which the mounting plate fasteners 154, such as top mounting bolts 154a and bottom mounting bolts 154b, are inserted through. FIGS. 3E, 3H show four (4) mounting plate holes 194 formed through the mounting plate 192 and that are configured to receive, and do receive, the mounting plate fasteners 154. However, the mounting plate 192 may have one (1), two (2), three (3), or more than four (4) mounting plate holes 194 that are configured to receive, and do receive, one (1), two (2), three (3), or more than four (4) mounting plate fasteners 154.

As shown in FIGS. 3A-3B, the mounting plate 192 is attached, via two (2) mounting plate fasteners 154, such as two top mounting bolts 154a, through the block front side openings 152a (see also FIG. 3E) of the block 80. As shown in FIG. 3E, the two (2) mounting plate fasteners 154, such as the top mounting bolts 154a, are configured to be inserted through a top row of two (2) mounting plate holes 194, such as top mounting plate holes 194a, formed through the mounting plate 192, and are configured to be inserted into two (2) block front side openings 152a formed in the block front side 145a of the block 80.

As shown in FIGS. 3A, 3E, the mounting plate 192 has the top row of mounting plate holes 194, such as two (2) top mounting plate holes 194a, configured to receive, and receiving, two (2) mounting plate fasteners 154, such as the top mounting bolts 154a, to attach the top portion of the mounting plate 192 to the block 80. The mounting plate 192 has a bottom row of mounting plate holes 194 (see FIGS. 3A, 3B, 3E), such as two (2) bottom mounting plate holes 194b, configured to receive, and receiving, two (2) mounting plate fasteners 154, such as bottom mounting bolts 154b (see FIGS. 3A, 3B), to attach the bottom portion of the mounting plate 192 to an assembly jig 30 (see FIGS. 8A, 10A).

As shown in FIGS. 3A, 3E, 3H, the latch clamp mechanism 190 further comprises the latch clamp handle 195 coupled, or attached, to the mounting plate 192, via the pivot mount 196 (see FIG. 3A) and the pivot pin 198 (see FIG. 3A) inserted through the latch clamp handle 195 and the pivot mount 196. As shown in FIGS. 3A, 3E, the latch clamp mechanism 190 further comprises the latch clamp 200, such as the U-shaped latch clamp 200a, having threaded ends 202 and the latch clamp bar 204. The threaded ends 202 are coupled, or attached, to the mounting plate 192, via the nuts 205 (see FIGS. 3A, 3E) and the cross pin 206 (see FIGS. 3A, 3E), or another suitable coupling or attachment means. As shown in FIG. 3A, the latch clamp bar 204 is latched over the hook 185, such as the J-hook 185a, on the latch plate 184, to close and lock the latch assembly 84, so that the latch assembly 84 is in the closed position 62a, and to close and lock the hinged clamshell structure 48, so that the hinged clamshell structure 48 is in the closed position 62.

As shown in FIGS. 3A-3B, 3E, 3H, the latch clamp mechanism 190 further comprises the safety lock release lever 208 coupled to the mounting plate 192 and is configured to release the internal integral safety lock, to unlock the latch clamp 200 and the latch assembly 84. The internal integral safety lock automatically engages when the latch clamp 200 is closed, then remains locked until manually disengaged by pressing the safety lock release lever 208 before opening. This prevents the latch clamp 200 and the latch assembly 84 from being accidentally opened by bumping the latch clamp handle 195.

Once the internal integral safety lock is released, to open the latch clamp 200, the latch clamp handle 195 (see FIG. 3A) can be manually moved and pivoted upwardly to unlatch the latch clamp bar 204 (see FIG. 3A) from over the J-hook 185a (see FIG. 3A), to open the latch assembly 84 (see FIG. 3A). To close the latch assembly 84, the latch clamp bar 204 is latched over the J-hook 185a and the latch clamp handle 195 is manually moved and pivoted downwardly to latch the latch assembly 84 in the closed position 62a (see FIG. 3A) and lock the latch clamp 200 and the latch assembly 84 with the integral internal safety lock, thus latching and locking the hinged clamshell structure 48, so that the hinged clamshell structure 48 is in the closed position 62 (see FIG. 3A).

As shown in FIGS. 3A, 3C-3H, the clamshell assembly 40, such as the secondary clamshell assembly 44, further comprises the clamp assembly 86. The clamp assembly 86 shown in FIGS. 3A, 3C-3F, 3H of the secondary clamshell assembly 44 is similar to the clamp assembly 86 shown in FIGS. 2A, 2C-2F, 2H of the primary clamshell assembly 42. The clamp assembly 86 comprises the clamp plate 210 (see FIGS. 3A, 3C-3H) having the L-shaped block configuration 212 (see FIGS. 3E, 3H). As shown in FIGS. 3D, 3E, 3H, the clamp plate 210 has the inner side 214, the outer side 215, the first portion 216a, such as the first base portion, and the second portion 216b, such as the second vertical portion. As shown in FIG. 3D, the clamp plate 210 has the bottom end 217a and the top end 217b.

As shown in FIGS. 3E, 3H, the clamp plate 210 has clamp plate through holes 218, including the plurality of first clamp plate through holes 218a, formed through the clamp plate 210, such as the first portion 216a of the clamp plate 210. As further shown in FIGS. 3E, 3H, the clamp plate 210 has the clamp plate through hole 218, such as the second clamp plate through hole 218b, formed through the clamp plate 210, such as the first portion 216a of the clamp plate 210, and positioned between the first clamp plate through holes 218a.

As shown in FIGS. 3E, 3H, the clamp assembly 86 further comprises the plurality of clamp plate fasteners 162, such as dowels 162a (see also FIG. 3A), or other suitable fasteners. The plurality of clamp plate fasteners 162 (see FIGS. 3E, 3H), for example, two (2) clamp plate fasteners 162, are inserted through the plurality of first clamp plate through holes 218a (see FIGS. 3E, 3H), for example, two (2) first clamp plate through holes 218a, to attach the inner side portion 214a (see FIG. 3D) of the inner side 214 (see FIG. 3D) of the clamp plate 210 (see FIG. 3D) to a portion of the first side 117a (see FIG. 3D) of the hinged clamshell structure 48 (see FIG. 3D), such as to the block first side 148a (see FIG. 3D) of the block 80 (see FIG. 3D) of the hinged clamshell structure 48.

As shown in FIGS. 3D, 3E, 3H, the clamp assembly 86 further comprises the threaded hand knob 165. As shown in FIGS. 3E, 3H, the threaded hand knob 165 comprises the threaded screw 164 with the threaded screw end 164a that is inserted through the clamp plate through hole 218, such as the second clamp plate through hole 218b, to attach the threaded hand knob 165 to a portion of the first side 117a (see FIG. 3D) of the hinged clamshell structure 48 (see FIG. 3D), such as to the block first side 148a (see FIG. 3D) of the block 80 (see FIG. 3D) of the hinged clamshell structure 48. As further shown in FIGS. 3D, 3E, 3H, the threaded hand knob 165, which is used to tighten and loosen the clamp plate 210 to the block 80, has the hand knob 220, the collar 222, and the nut 224. As shown in FIG. 3D, the threaded screw 164 is inserted in the interior of the hand knob 220, is inserted through the collar 222, is inserted through the nut 224, and is inserted through the clamp plate 210, and the threaded screw end 164a of the threaded screw 164 is inserted in the block 80. Two or more of the hand knob 220, the collar 222, and the threaded screw 164 may be integrally formed as a uniform part or may comprise separate parts coupled together.

In one version, FIGS. 3E, 3H, show two (2) first clamp plate through holes 218a formed through the first portion 216a of the clamp plate 210 and that are configured to receive, and do receive, the clamp plate fasteners 162, such as dowels 162a, or other suitable fasteners. In other versions, the first portion 216a of the clamp plate 210 may have one (1), or more than two (2), first clamp plate through holes 218a configured to receive one (1), or more than two (2), clamp plate fasteners 162, such as dowels 162a. In one version, FIGS. 3E, 3H further show one (1) second clamp plate through hole 218b formed through the first portion 216a of the clamp plate 210 and that is configured to receive, and does receive, the threaded screw end 164a and the threaded screw 164 of the threaded hand knob 165. In other versions, the first portion 216a of the clamp plate 210 may have more than one second clamp plate through hole 218b. As shown in FIG. 3D, the inner side portion 214a of the clamp plate 210 is coupled, or attached, to the block first side 148a of the block 80 of the hinged clamshell structure 48, via the threaded screw end 164a of the threaded screw 164 of the threaded hand knob 165, and via the clamp plate fasteners 162 (see FIGS. 3E, 3H), such as the dowels 162a (see FIGS. 3E, 3H).

As shown in FIGS. 3E, 3H, the clamp plate through holes 218, such as the first clamp plate through holes 218a, are aligned with, and coaxial with, the first side dowel openings 160a in the block 80, and the clamp plate through hole 218, such as the second clamp plate through hole 218b, is aligned with, and coaxial with, the first side threaded screw end opening 160b in the block 80. As shown in FIGS. 3E, 3H, the dowels 162a are configured to be inserted through the first clamp plate through holes 218a through the clamp plate 210 and into the first side dowel openings 160a in the block 80, to attach the clamp plate 210 to the block 80. As shown in FIG. 3D, the threaded screw end 164a of the threaded screw 164 of the threaded hand knob 165 is inserted through the second clamp plate through hole 218b through the clamp plate 210 and into the first side threaded screw end opening 160b in the block 80, to attach the threaded hand knob 165 to the clamp plate 210 and to the block 80.

As shown in FIGS. 3A-3H, the clamshell assembly 40, such as the secondary clamshell assembly 44, further comprises the base plate 225, such as a pour plate 225a, attached to the bottom 115b (see FIG. 3B) of the hinged clamshell structure 48, such as the secondary hinged clamshell structure 52. As shown in FIGS. 3D, 3E, 3H, the base plate 225 has the top side 226a, the bottom side 226b, and the body 228 having the rectangle-shaped configuration 230 disposed between the top side 226a and the bottom side 226b.

As shown in FIGS. 3D, 3E, 3H, the base plate 225 has base plate through holes 232, such as two (2) base plate through holes 232, formed through the body 228 of the base plate 225. As shown in FIG. 3D, the base plate 225 is attached to the block 80 with the bolts 138, such as the precision shoulder bolts 138a, extending through the block through holes 136a of the block 80 and through the base plate through holes 232 of the body 228 of the base plate 225. As shown in FIG. 3D, a portion of the top side 226a of the base plate 225 is adjacent and attached to the block bottom end 144a of the block 80 and another portion of the top side 226a of the base plate 225 is adjacent the bottom end 217a of the clamp plate 210. As shown in FIG. 3C, another portion of the top side 226a of the base plate 225 is adjacent a portion of the lower end 175b of the integral hinge plate 74a.

The base plate 225, such as the pour plate 225a, is designed to support the hinged clamshell structure 48, such as the secondary hinged clamshell structure 52, and the clamp plate 210. The base plate 225 is directly adjacent the lower clamshell portion 78, including the block 80 and the integral hinge plate 74a. In addition, the base plate 225 is directly adjacent the clamp plate 210.

Preferably, in one version, the upper clamshell portion 66, the lower clamshell portion 78 including the block 80 and the integral hinge plate 74a and the optional stop tab 76, as well as the latch plate 184, the clamp plate 210, and the base plate 225 of the clamshell assembly 40, such as the secondary clamshell assembly 44, are each one-piece, unitary, monolithic configurations. In other versions, one or more of the upper clamshell portion 66, the lower clamshell portion 79 including the block 80 and the integral hinge plate 74a and the optional stop tab 76, as well as the latch plate 184, the clamp plate 210, and the base plate 225 may be made of two or more pieces or parts coupled, or attached, together with a suitable attachment means.

The sizes of the upper clamshell portion 66, the lower clamshell portion 78 including the block 80 and the integral hinge plate 74a and the optional stop tab 76, as well as the latch assembly 84 including the latch plate 184, the clamp assembly 86 including the clamp plate 210, and the base plate 225 may be scaled up or down depending on the usage and size of the assembly jig 30. For example, for an assembly jig 30 that is small, these parts may each be sized down to a several inches, and for an assembly jig 30 that is large, these parts may each be sized up to several feet or more. In one version, one or more of the upper clamshell portion 66, the lower clamshell portion 78 including the block 80 and the integral hinge plate 74a and the optional stop tab 76, as well as the latch assembly 85, the clamp assembly 86, and the base plate 225 are made of a metal material including steel, stainless steel, aluminum, aluminum alloy, or another suitable metal material. In other versions, one or more of the upper clamshell portion 66, the lower clamshell portion 78 including the block 80 and the integral hinge plate 74a and the optional stop tab 76, as well as the latch assembly 85, the clamp assembly 86, and the base plate 225 are made of nylon, polyoxymethylene (POM) a high-performance acetal homopolymer resin that is durable, stiff, and stable, wood, or another suitable material.

Now referring to FIGS. 4A-4D, FIGS. 4A-4D show versions of a clamshell assembly 40, such as a tertiary clamshell assembly 46, that may be used in versions of the tooling assembly 10 (see FIG. 1) and the tooling system 12 (see FIG. 1) of the disclosure. In one version, the clamshell assembly 40, such as the tertiary clamshell assembly 46, locates or positions the aircraft structure 20, or another type of structure 19, in the z-axis direction 38 (see FIG. 1), and allows floating of the pin 96 (see FIGS. 1, 5A, 6A) in the x-axis direction 34 (see FIG. 1) and in the y-axis direction 36 (see FIG. 1).

FIG. 4A is an illustration of a front perspective view of an exemplary version of the clamshell assembly 40, such as the tertiary clamshell assembly 46, of the tooling assembly 10 (see FIG. 1) and the tooling system 12 (see FIG. 1) of the disclosure, and in the assembled configuration 113 and having no stop tab 76 (see FIG. 4C). FIG. 4B is an illustration of a left side perspective view of the clamshell assembly 40, such as the tertiary clamshell assembly 46, of FIG. 4A. FIG. 4C is an illustration of a right side perspective view of the clamshell assembly 40, such as the tertiary clamshell assembly 46, of FIG. 4A and having the stop tab 76 added. FIG. 4D is an illustration of a front cross-sectional view of the clamshell assembly 40, such as the tertiary clamshell assembly 46, of FIG. 4A.

The clamshell assembly 40, such as the tertiary clamshell assembly 46, with the hinged clamshell structure 48, such as the tertiary hinged clamshell structure 54, shown in FIGS. 4A-4D has substantially the same structure and parts as the clamshell assembly 40, such as the secondary clamshell assembly 44, with the hinged clamshell structure 48, such as the secondary hinged clamshell structure 52, shown in FIGS. 3A-3H. The only difference between the tertiary clamshell assembly 46 with the tertiary hinged clamshell structure 54 and the secondary clamshell assembly 44 with the secondary hinged clamshell structure 52, is a width 236 (see FIGS. 8D, 9B) of a flat portion 238 (see FIGS. 8D, 9B) of the first portion 216a (see FIGS. 8D, 9B) of the clamp plate 210 (see FIGS. 8D, 9B). As shown in FIG. 8D, the flat portion 238 of the first portion 216a of the clamp plate 210 of the secondary hinged clamshell structure 52 has the width 236, such as a secondary clamp plate width 236a. As shown in FIG. 9B, the flat portion 238 of the first portion 216a of the clamp plate 210 of the tertiary hinged clamshell structure 52 has the width 236, such as a tertiary clamp plate width 236b. The tertiary clamp plate width 236b (see FIG. 9B) is greater than the secondary clamp plate width 236a (see FIG. 8D), and the secondary clamp plate width 236a is smaller than the tertiary clamp plate width 236b. For example, in one version, the tertiary clamp plate width 236b is 1/16 inch (0.0625 inch) greater in width than the secondary clamp plate width 236a.

FIGS. 8D, 9B further show a gap 240 formed between an inner side portion 214b of the inner side 214 of the second portion 216b of the clamp plate 210 and the block first side 148a of the block 80 of the lower clamshell portion 78. As shown in FIG. 8D, the gap 240 comprises a secondary clamp plate gap 240a. As shown in FIG. 9B, the gap 240 comprises a tertiary clamp plate gap 240b. The tertiary clamp plate gap 240b is greater than the secondary clamp plate gap 240a, and the secondary clamp plate gap 240a is smaller than the tertiary clamp plate gap 240b.

As shown in FIGS. 4A-4D, the clamshell assembly 40, such as the tertiary clamshell assembly 46, comprises the hinged clamshell structure 48, such as the tertiary hinged clamshell structure 54. As shown in FIGS. 4A-4C, the hinged clamshell structure 48, such as the tertiary hinged clamshell structure 54 has the hinged end 56 with the hinge pin 58, such as the shoulder bolt 58a, inserted through the hinged end 56 and further has the non-hinged end 60. Like the secondary hinged clamshell structure 52, the tertiary hinged clamshell structure 54 is configured to move or pivot, and moves or pivots, back and forth between the closed position 62 (see FIG. 4B) and the open position 64 (see FIG. 3E). As shown in FIGS. 4B, the hinged clamshell structure 48 has the top 115a, the bottom 115b, the front 116a, and the back 116b. As shown in FIG. 4D, the hinged clamshell structure 48 has the first side 117a and the second side 117b.

Like the secondary hinged clamshell structure 52, the tertiary hinged clamshell structure 54 comprises the upper clamshell portion 66 (see FIGS. 4A-4D) hingedly or pivotally connected, via the hinge pin 58, to the lower clamshell portion 78 (see FIGS. 4A-4D). As shown in FIG. 4B, the upper clamshell portion 66 has the hinge knuckle 126 with the hinge pin opening 128 (see FIG. 3E) holding the hinge pin 58. The upper clamshell portion 66 of the tertiary hinged clamshell structure 54 shown in FIGS. 4A-4D is similar to the upper clamshell portion 66 of the primary hinged clamshell structure 50, shown in FIGS. 2A-2H and is similar to the upper clamshell portion 66 of the secondary hinged clamshell structure 52, shown in FIGS. 3A-3H. The parts of the upper clamshell portion 66 of the tertiary hinged clamshell structure 54 are the same parts as the upper clamshell portion 66 of the secondary hinged clamshell structure 52, as discussed above with respect to FIGS. 3E, 3H, including the first end 118a, the second end 118b, the body 120, such as the T-shaped body 120a, the front plate side 122, and the holes 124 formed through the front plate side 122, configured to receive, and receiving, the latch plate fasteners 125, such as the latch plate bolts 125a.

As shown in FIGS. 4A-4D, like the secondary hinged clamshell structure 52, the tertiary hinged clamshell structure 54 comprises the lower clamshell portion 78. As shown in FIGS. 4B, 4D, the lower clamshell portion 78 comprises the block 80 with the top flat portion 82 having two or more block through holes 136a configured to receive, and receiving, the bolts 138 (see FIG. 4D), such as the precision shoulder bolts 138a (see FIG. 4D). As shown in FIG. 4D, in one version, the block 80 has two (2) block through holes 136a formed through the block 80. However, in another version, the block 80 may have one (1) block through hole 136a, or more than two (2) block through holes 136a.

Like the secondary hinged clamshell structure 52, the block 80 of the tertiary hinged clamshell structure 54 has a plurality of first side openings 160 (see FIGS. 3E, 4D) on the block first side 148a (see FIG. 4D). The lower clamshell portion 78 is preferably a one-piece, unitary, monolithic configuration instead of a combination of multiple parts, such as the V-block 70 (see FIG. 2E), the extender block 72 (see FIG. 2E), and the hinge plate 74 (see FIG. 2E) of the primary hinged clamshell structure 50, shown in FIGS. 2A-2H.

FIG. 4D further shows the bushings 140 with the bushing holes 139 inserted into the block bushing openings 142a formed in the block bottom end 144a of the block 80. As shown in FIG. 3D, 4D, in one version, the block 80 has two (2) block bushing openings 142a formed through the block 80 and configured to receive, and receiving, two (2) bushings 140. However, in another version, the block 80 may have one (1) block bushing opening 142a, formed through the block 80 and configured to receive, and receiving, one (1) bushing 140, or more than two (2) block bushing openings 142a formed through the block 80 and configured to receive, and receiving, more than two (2) bushings 140. As shown in FIG. 4D, the block through holes 136a are coaxial with the block bushing openings 142a, and the block through holes 136a extend through interior portions of the block 80 between the top flat portion 82 and a block bottom end 144a.

The parts of the block 80 of the lower clamshell portion 78 of the tertiary hinged clamshell structure 54 are the same parts as the block 80 of the lower clamshell portion 78 of the secondary hinged clamshell structure 52, as discussed above with respect to FIGS. 3E, 3H, including the block top end 133a, the block bottom end 144a, the block front side 145a opposite the block back side 146a, the block first side 148a opposite the block second side 150a, the block front side openings 152a that are configured to receive, and do receive, the ends of the mounting plate fasteners 154, such as the top mounting bolts 154a, and the plurality of first side openings 160 that are configured to receive, and do receive, the ends of clamp plate fasteners 162, such as dowels 162a, and the threaded screw end 164a of the threaded screw 164 of the threaded hand knob 165.

As shown in FIGS. 4A-4D, the tertiary hinged clamshell structure 54 comprises the integral hinge plate 74a integral with the block back side 146a (see FIG. 4B) of the block 80. As shown in FIG. 4B, the integral hinge plate 74a has the first hinge knuckle 126a having the first hinge pin opening 128a (see FIG. 4A) and the second hinge knuckle 126b having the second hinge pin opening 128b, where the first hinge knuckle 126a is aligned with the second hinge knuckle 126b, and the first hinge pin opening 128a is coaxial with the second hinge pin opening 128b along axis 176. As shown in FIG. 4A, the hinge pin 58 is inserted through the first hinge pin opening 128a of the first hinge knuckle 126a of the integral hinge plate 74a, through the hinge pin opening 128 (see FIG. 3E) of the hinge knuckle 126 of the upper clamshell portion 66, and through the second hinge pin opening 128b (see FIG. 4B) of the second hinge knuckle 126b of the integral hinge plate 74a, to hingedly connect together the upper clamshell portion 66 and the lower clamshell portion 78 at the hinged end 56. The parts of the integral hinge plate 74a of the lower clamshell portion 78 of the tertiary hinged clamshell structure 54 are the same parts as the integral hinge plate 74a of the lower clamshell portion 78 of the secondary hinged clamshell structure 52, as discussed above with respect to FIGS. 3I, 3J, including the inner side 234a, the outer side 234b, the upper end 235a, the lower end 235b, and the open portion 177, or notched portion, as shown in FIGS. 3I, 3J.

In one version, as shown in FIG. 4C, the integral hinge plate 74a has the stop tab 76, configured to stop the upper clamshell portion 66 from over-pivoting, when the upper clamshell portion 66 is pivoted upward from the closed position 62 of the hinged clamshell structure 48 to the open position 64 (see FIG. 3E) of the hinged clamshell structure 48. In one version, as shown in FIG. 4C, the integral hinge plate 74a has the stop tab 76 attached to, or integral with, the integral hinge plate 74a. The stop tab 76 in FIG. 4C is identical to the stop tab 76 of FIGS. 2A-2E, 2I and the stop tab 76 of FIGS. 3A-3E, 3I. The parts of the stop tab 76 of the lower clamshell portion 78 of the tertiary hinged clamshell structure 54 are the same parts as the stop tab 76 of the lower clamshell portion 78 of the secondary hinged clamshell structure 52, as discussed above with respect to FIG. 3I, including the attachment portion 178, the stop portion 180, the inner side 182a, and the outer side 182b shown in FIG. 3I. In another version, as shown in FIGS. 4A-4B, 4D, the integral hinge plate 74a does not have the stop tab 76 (see FIG. 4C). The stop tab 76 is an optional feature.

As shown in FIGS. 4A-4C, the tertiary clamshell assembly 46, further comprises the latch assembly 84. The latch assembly 84 shown in FIGS. 4A-4C of the tertiary clamshell assembly 46 is similar to the latch assembly 84 shown in FIGS. 2A-2C, 2E-2H of the primary clamshell assembly 42 and the latch assembly 84 shown in FIGS. 3A-3C, 3E-3H. As shown in FIG. 4B, the latch assembly 84 is attached to the non-hinged end 60 of the hinged clamshell structure 48, to latch the hinged clamshell structure 48 in the closed position 62. As shown in FIG. 4A, the latch assembly 84 comprises the latch plate 184 having the hook 185, such as the J-hook 185a, attached to, or integral with a portion of the front side 186a of the latch plate 184, and the latch plate 184 has the back side 186b that is configured to attach, and is attached, to the front plate side 122 of the upper clamshell portion 66 of the hinged clamshell structure 48.

As further shown in FIG. 4A, the latch plate 184 has the latch plate openings 188 formed through the latch plate 184 through which the latch plate fasteners 125, such as the latch plate bolts 125a, are inserted through. FIG. 4A shows four (4) latch plate openings 188 formed through the latch plate 184 that are configured to receive, and do receive, the latch plate fasteners 125. However, the latch plate 184 may have one (1), two (2), three (3), or more than four (4) latch plate openings 188 that are configured to receive, and do receive, one (1), two (2), three (3), or more than four (4) latch plate fasteners 125. As shown in FIG. 4A, the latch plate 184 is attached, via the plurality of latch plate fasteners 125, to the front plate side 122 of the upper clamshell portion 66 of the hinged clamshell structure 48, such as the tertiary hinged clamshell structure 54

As further shown in FIG. 4A, the latch assembly 84 comprises the latch clamp mechanism 190 with the mounting plate 192 having mounting plate holes 194 through which the mounting plate fasteners 154, such as top mounting bolts 154a and bottom mounting bolts 154b, are inserted through. FIG. 4A shows four (4) mounting plate holes 194 formed through the mounting plate 192 and that are configured to receive, and do receive, the mounting plate fasteners 154. However, the mounting plate 192 may have one (1), two (2), three (3), or more than four (4) mounting plate holes 194 that are configured to receive, and do receive, one (1), two (2), three (3), or more than four (4) mounting plate fasteners 154.

As shown in FIG. 4A, the mounting plate 192 is attached, via two (2) mounting plate fasteners 154, such as two top mounting bolts 154a, inserted into the block front side openings 152a (see FIG. 3E) of the block 80. As shown in FIG. 4A, the two (2) mounting plate fasteners 154, such as the top mounting bolts 154a, are configured to be inserted through a top row of two (2) mounting plate holes 194, such as top mounting plate holes 194a, formed through the mounting plate 192, and are configured to be inserted into two (2) block front side openings 152a (see FIG. 3E) formed in the block front side 145a of the block 80.

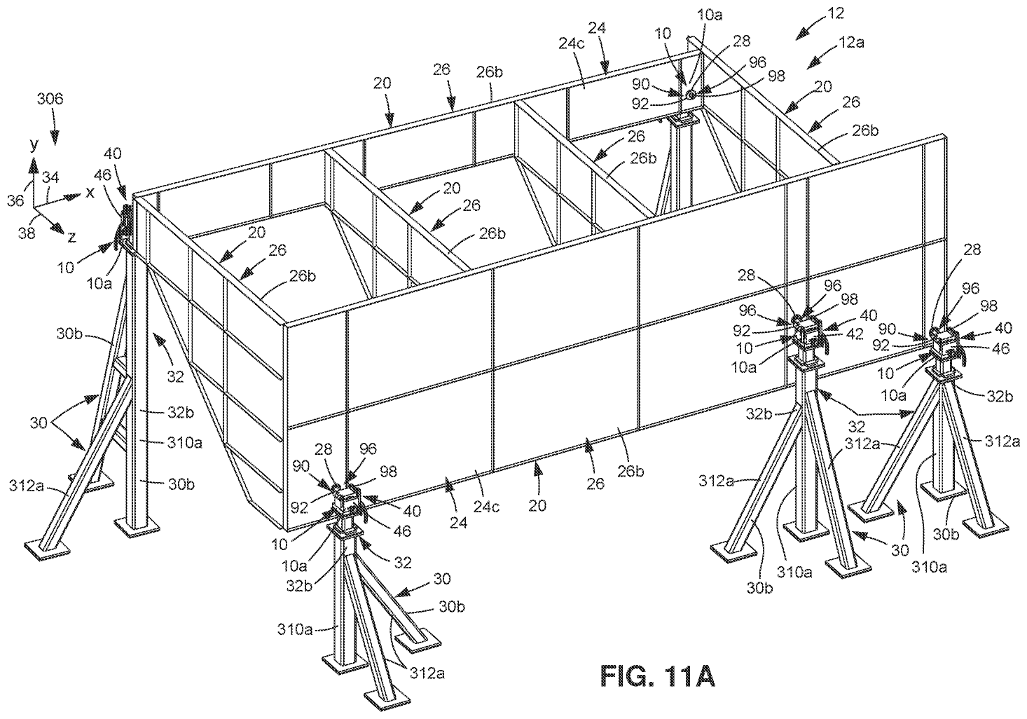

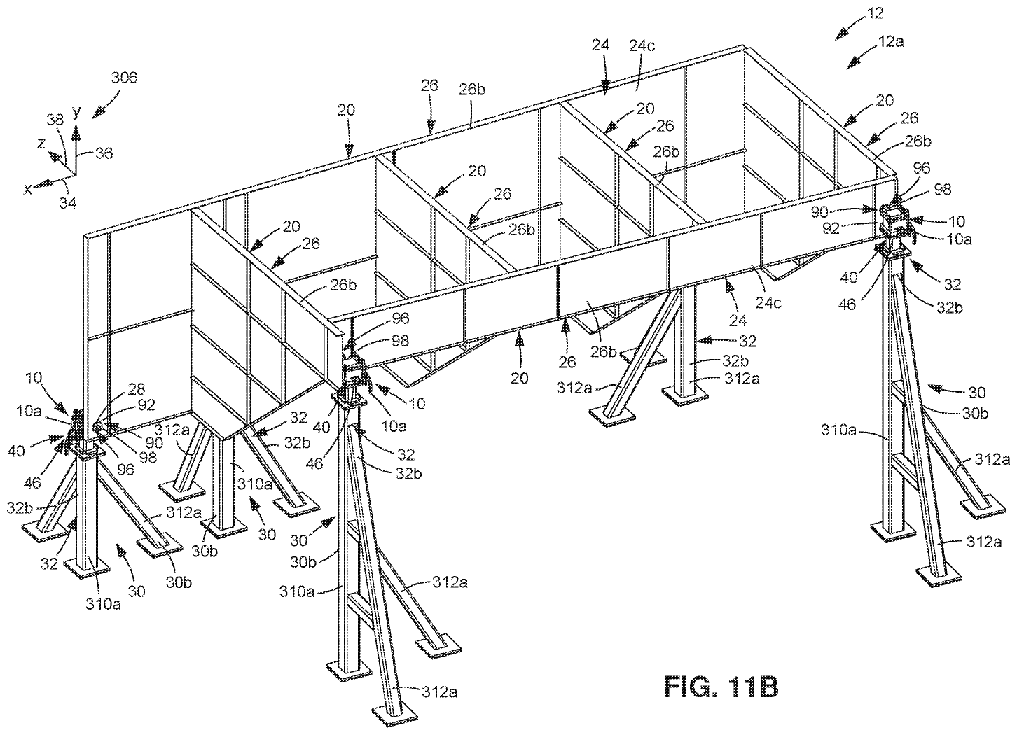

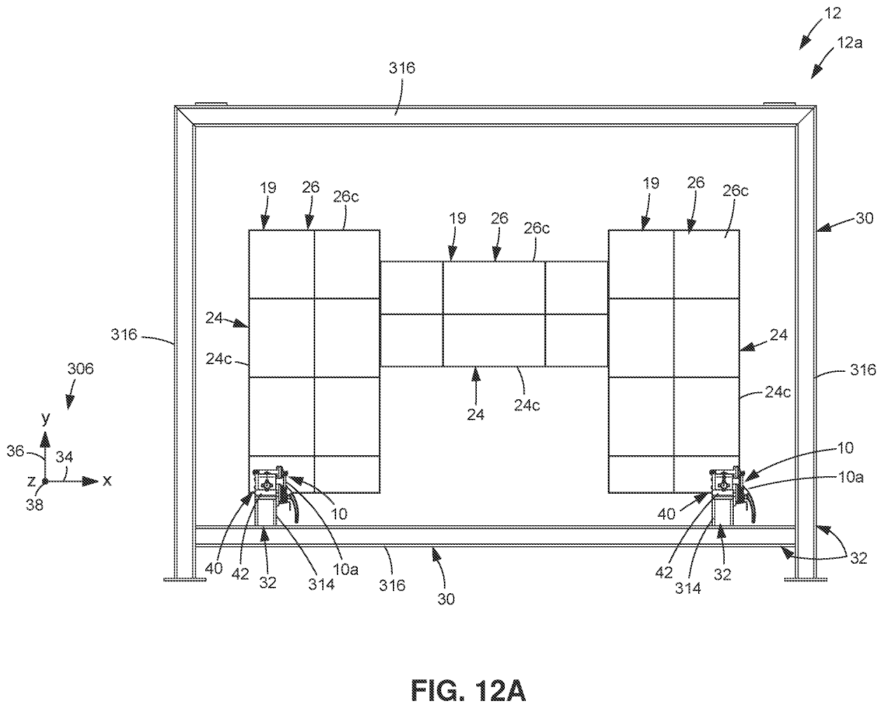

As shown in FIG. 4A, the mounting plate 192 has the top row of mounting plate holes 194, such as two (2) top mounting plate holes 194a, configured to receive, and receiving, two (2) mounting plate fasteners 154, such as the top mounting bolts 154a, to attach the top portion of the mounting plate 192 to the block 80. The mounting plate 192 has a bottom row of mounting plate holes 194 (see FIG. 4A), such as two (2) bottom mounting plate holes 194b (see FIG. 4A), configured to receive, and receiving, two (2) mounting plate fasteners 154, such as bottom mounting bolts 154b (see FIG. 4A), to attach the bottom portion of the mounting plate 192 to an assembly jig 30 (see FIGS. 9A, 11A).

As shown in FIG. 4A, the latch clamp mechanism 190 further comprises the latch clamp handle 195 coupled, or attached, to the mounting plate 192, via the pivot mount 196 and the pivot pin 198 inserted through the latch clamp handle 195 and the pivot mount 196. As shown in FIG. 4A, the latch clamp mechanism 190 further comprises the latch clamp 200, such as the U-shaped latch clamp 200a, having threaded ends 202 and the latch clamp bar 204. The threaded ends 202 are coupled, or attached, to the mounting plate 192, via the nuts 205 (see FIG. 4A) and the cross pin 206 (see FIG. 4A), or another suitable coupling or attachment means. As shown in FIG. 4A, the latch clamp bar 204 is latched over the hook 185, such as the J-hook 185a, on the latch plate 184, to close and lock the latch assembly 84, so that the latch assembly 84 is in the closed position 62a, and to close and lock the hinged clamshell structure 48, so that the hinged clamshell structure 48 is in the closed position 62.

As shown in FIG. 4A, the latch clamp mechanism 190 further comprises the safety lock release lever 208 coupled to the mounting plate 192 and configured to release the internal integral safety lock, to unlock the latch clamp 200 and the latch assembly 84. The internal integral safety lock automatically engages when the latch clamp 200 is closed, then remains locked until manually disengaged by pressing the safety lock release lever 208 before opening. This prevents the latch clamp 200 and the latch assembly 84 from being accidentally opened by bumping the latch clamp handle 195.

Once the internal integral safety lock is released, to open the latch clamp 200, the latch clamp handle 195 (see FIG. 4A) can be manually moved and pivoted upwardly to unlatch the latch clamp bar 204 (see FIG. 4A) from over the J-hook 185a (see FIG. 4A), to open the latch assembly 84 (see FIG. 4A). To close the latch assembly 84, the latch clamp bar 204 is latched over the J-hook 185a and the latch clamp handle 195 is manually moved and pivoted downwardly to latch the latch assembly 84 in the closed position 62a (see FIG. 4A) and lock the latch clamp 200 and the latch assembly 84 with the integral internal safety lock, thus latching and locking the hinged clamshell structure 48, so that the hinged clamshell structure 48 is in the closed position 62 (see FIG. 4A).

As shown in FIGS. 4A-4D, the clamshell assembly 40, such as the tertiary clamshell assembly 46, further comprises the clamp assembly 86. The clamp assembly 86 shown in FIGS. 4A-4D of the tertiary clamshell assembly 46 is identical to the clamp assembly 86 shown in FIGS. 3A-3C-3F, 3H of the secondary clamshell assembly 44, and is similar to the clamp assembly 86 shown in FIGS. 2A, 2C-2F, 2H of the primary clamshell assembly 42.

As shown in FIG. 4C, the clamp assembly 86 comprises the clamp plate 210 having the L-shaped block configuration 212 with the first portion 216a, such as the first base portion, and the second portion 216b, such as the second vertical portion. The parts of the clamp plate 210 of the clamp assembly 86 of the tertiary hinged clamshell structure 54 are the same parts as the clamp plate 210 of the clamp assembly 86 of the secondary hinged clamshell structure 52, as discussed above with respect to FIGS. 3E, 3H, including, as shown in FIGS. 3E, 3H, the inner side 214, the outer side 215, the bottom end 217a, the top end 217b, the clamp plate through holes 218, including the plurality of first clamp plate through holes 218a configured to receive, and receiving, the clamp plate fasteners 162, such as the dowels 162a, or other suitable fasteners, and the second clamp plate through hole 218b, configured to receive, and receiving, the threaded screw end 164a of the threaded screw 164 of the threaded hand knob 165. As shown in FIG. 4D, the threaded hand knob 165 comprises the threaded screw 164 inserted in the interior of the hand knob 220, inserted through the collar 222, inserted through the nut 224, and inserted through the clamp plate 210, and the threaded screw end 164a of the threaded screw 164 inserted in the block 80.

As shown in FIGS. 4A-4D the clamshell assembly 40, such as the tertiary clamshell assembly 46, further comprises the base plate 225, such as the pour plate 225a, attached to the bottom 115b (see FIG. 4B) of the hinged clamshell structure 48, such as the tertiary hinged clamshell structure 54. As shown in FIG. 4D, the base plate 225 has the top side 226a, the bottom side 226b, and the body 228 having the rectangle-shaped configuration 230 disposed between the top side 226a and the bottom side 226b. As shown in FIG. 4D, the base plate 225 has base plate through holes 232, such as two (2) base plate through holes 232, formed through the body 228 of the base plate 225. As further shown in FIG. 4D, the base plate 225 is attached to the block 80 with the bolts 138, such as the precision shoulder bolts 138a, extending through the block through holes 136a of the block 80 and through the base plate through holes 232 of the body 228 of the base plate 225. As shown in FIG. 4D, a portion of the top side 226a of the base plate 225 is adjacent and attached to the block bottom end 144a of the block 80 and another portion of the top side 226a of the base plate 225 is adjacent the bottom end 217a of the clamp plate 210. As shown in FIG. 4C, another portion of the top side 226a of the base plate 225 is adjacent a portion of the lower end 175b of the integral hinge plate 74a. The base plate 225, such as the pour plate 225a, is designed to support the hinged clamshell structure 48, such as the tertiary hinged clamshell structure 54, and the clamp plate 210. The base plate 225 is directly adjacent the lower clamshell portion 78, including the block 80 and the integral hinge plate 74a. In addition, the base plate 225 is directly adjacent the clamp plate 210.

Preferably, in one version, the upper clamshell portion 66, the lower clamshell portion 78 including the block 80 and the integral hinge plate 74a and the optional stop tab 76, as well as the latch plate 184, the clamp plate 210, and the base plate 225 of the clamshell assembly 40, such as the tertiary clamshell assembly 46, are each one-piece, unitary, monolithic configurations. In other versions, one or more of the upper clamshell portion 66, the lower clamshell portion 79 including the block 80 and the integral hinge plate 74a and the optional stop tab 76, as well as the latch plate 184, the clamp plate 210, and the base plate 225 may be made of two or more pieces or parts coupled, or attached, together with a suitable attachment means.

The sizes of the upper clamshell portion 66, the lower clamshell portion 78 including the block 80 and the integral hinge plate 74a and the optional stop tab 76, as well as the latch assembly 84 including the latch plate 184, the clamp assembly 86 including the clamp plate 210, and the base plate 225 may be scaled up or down depending on the usage and size of the assembly jig 30. For example, for an assembly jig 30 that is small, these parts may each be sized down to a several inches, and for an assembly jig 30 that is large, these parts may each be sized up to several feet or more. In one version, one or more of the upper clamshell portion 66, the lower clamshell portion 78 including the block 80 and the integral hinge plate 74a and the optional stop tab 76, as well as the latch assembly 85, the clamp assembly 86, and the base plate 225 are made of a metal material including steel, stainless steel, aluminum, aluminum alloy, or another suitable metal material. In other versions, one or more of the upper clamshell portion 66, the lower clamshell portion 78 including the block 80 and the integral hinge plate 74a and the optional stop tab 76, as well as the latch assembly 85, the clamp assembly 86, and the base plate 225 are made of nylon, polyoxymethylene (POM) a high-performance acetal homopolymer resin that is durable, stiff, and stable, wood, or another suitable material.

Now referring to FIGS. 5A-5C, FIG. 5A is an illustration of a side perspective view of an exemplary version of a pin assembly 90, such as a support pin assembly 90a, for example, a datum side pin assembly 92, of the disclosure, in an unassembled configuration 114a. FIG. 5B is an illustration of a side perspective view of the pin assembly 90, such as the support pin assembly 90a, for example, the datum side pin assembly 92, of FIG. 5A in an assembled configuration 113a. FIG. 5C is an illustration of a side cross-sectional view of the pin assembly 90, such as the support pin assembly 90a, for example, the datum side pin assembly 92, of FIG. 5A in the assembled configuration 113a.

As shown in FIGS. 5A-5C, the pin assembly 90, such as the support pin assembly 90a, for example, the datum side pin assembly 92, comprises the pin 96 that functions as a support pin 96a and a floating pin 96b, and in one example comprises a datum side pin 98. As shown in FIGS. 5A-5C, the pin 96, such as the datum side pin 98, comprises a head end 242, and a tail end 244, such as a threaded tail end 244a.

The head end 242 comprises a shoulder 245 (see FIGS. 5A-5C) that gets clamped by the clamshell assembly 40 (see FIGS. 7D, 8D, 9B), between the clamp assembly 86 (see FIGS. 7D, 8D, 9B) and the first side 117a (see FIGS. 7D, 8D, 9B) of the hinged clamshell structure 48 (see FIGS. 2A, 3A, 4A). In particular, the head end 242 comprising the shoulder 245 gets clamped between the clamp plate 210 (see FIGS. 7D, 8D, 9B), and the V-block 70 (see FIG. 7D) of the primary hinged clamshell structure 50 (see FIG. 7D), or the block 80 (see FIGS. 8D, 9B) of the secondary hinged clamshell structure 52 (see FIG. 8D) or the tertiary hinged clamshell structure 54 (see FIG. 9B). As shown in FIGS. 5A-5C, the head end 242 comprises an outer side 246a, an inner side 246b, and a disc-shaped body 248 formed between the outer side 246a and the inner side 246b.

As shown in FIG. 5C, the head end 242 of the pin 96 has a slip fit hole 250, such as a first slip fit hole 250a, formed in an interior portion 252a of an interior 252 of the pin 96 and through the head end 242 from the outer side 246a to the inner side 246b. As further shown in FIG. 5C, the tail end 244 has a slip fit hole 250, such as a second slip fit hole 250b, formed in an interior portion 252b of the interior 252 of the pin from an outer end 254 of the tail end 244. The slip fit holes 250 are optional.

The slip fit holes 250, such as the first slip fit hole 250a and the second slip fit hole 250b, are for insertion of a construction ball (not shown), also referred to as a tooling ball, for the assembly jig 30 on both ends of the pin 96. The tooling system 12, such as the clamshell tooling system 12a, with the two or more tooling assemblies 10, such as the two or more clamshell tooling assemblies 10a, coupled to the assembly jig 30, may be used with a laser metrology (LM) system (not shown) to perform a laser metrology (LM) process, to locate the hole 28 (see FIG. 10A) and to confirm an accurate positioning and an accurate alignment of the pin 96 with respect to the hole 28 in the part 24 of the aircraft structure 20, or another type of structure 19. The first slip fit hole 250a (see FIG. 5C) in the head end 242 (see FIG. 5C) of the pin 96, and/or the second slip fit hole 250b (see FIG. 5C) in the tail end 244 (see FIG. 5C) of the pin 96 may each be configured to receive the construction ball, also referred to as a tooling ball, that creates a visual reference point for the laser metrology system performing the laser metrology process, to locate the hole 28 and to confirm the accurate positioning and the accurate alignment of the pin 96 with respect to the hole 28 in the part 24 of the aircraft structure 20, or another type of structure 19. The construction ball typically comprises a smooth, round metal ball attached to a cylindrical shaft or stem, and the construction ball creates the visual reference point to refer to when performing the laser metrology process. As used herein, “laser metrology” means a system and process using optical laser technology scanning to measure, analyze, and optimize structures, such as aircraft structures, for inspection and quality control during manufacturing of structures, such as aircraft structures, and parts, where the laser metrology determines the location of holes in a part for a structure, such as an aircraft structure, and/or confirms that a pin is positioned and aligned accurately.

As shown in FIGS. 5A-5C, the pin 96 further comprises an indexing portion 255 extending from the head end 242 and substantially positioned within the hinged clamshell structure 48 (see FIGS. 7D, 8D, 9B). As shown in FIGS. 5A-5C, the indexing portion 255 comprises a shank 256 having a first end 258 adjacent to, or integral with, a portion of the inner side 246b of the head end 242. As shown in FIGS. 5A, 5C, the indexing portion 255 comprising the shank 256 has a second end 260 and a cylindrical shank body 262. The indexing portion 255, such as the shank 256, interfaces the V-shaped interior recess 130 (see FIG. 2E) of the V-block 70 (see FIG. 2E) when the hinged clamshell structure 48 (see FIG. 2E) comprises the primary hinged clamshell structure 50 (see FIG. 2E). The indexing portion 255, such as the shank 256, interfaces the top flat portion 82 (see FIGS. 3E, 4D) of the block 80 (see FIGS. 3E, 4D) when the hinged clamshell structure 48 (see FIGS. 3E, 4D) comprises the secondary hinged clamshell structure 52 (see FIG. 3E) or the tertiary hinged clamshell structure 54 (see FIG. 4D).

As shown in FIGS. 5A-5C, the pin 96 further comprises a rotation control portion 264 integral with, or coupled to, the indexing portion 255 and extending outwardly from an exterior portion 255a (see FIG. 5C) of the indexing portion 255. As shown in FIGS. 5A-5C, in one version, the rotation control portion 264 comprises a hexagon-shaped rotation control portion 264a having a hexagon-shaped portion 267 and having a ring portion 268. The ring portion 268 is integral with, or coupled to, the hexagon-shaped portion 267. As shown in FIG. 5C, the length of the outer diameter of the ring portion 268 is greater than the length of the outer diameter of the hexagon-shaped portion 267. In other versions, the rotation control portion 264 may comprise a square-shaped rotation control portion, machined surfaces, or flat surfaces that are configured to be held or gripped by a wrench or other suitable tool to retain the pin 96 and prevent the pin 96 from rotating. The rotation control portion 264 functions as a holding feature to tighten or to loosen the pin 96, when the nut element 102 is secured on the pin 96. As shown in FIGS. 5A-5C, the rotation control portion 264 has a first end 265 and a second end 266. As shown in FIG. 5C, the length of the outer diameter of hexagon-shaped portion 267 of the rotation control portion 264 is greater than the length of the outer diameter of the indexing portion 255.

As further shown in FIGS. 5A, 5C, the pin assembly 90, such as the datum side pin assembly 92, comprises the interfacing surface 104 on the pin 96. As shown in FIGS. 5A, 5C, in one version, the interfacing surface 104 comprises an interfacing indexing surface 104a located or positioned on the ring portion 268 of the rotation control portion 264 of the pin 96. As shown in FIGS. 5A, 5C, the ring portion 268 has a first side 270a, a second side 270b, and a ring body 272 formed between the first side 270a and the second side 270b. The second side 270b of the ring portion 268 has the interfacing surface 104, such as the interfacing indexing surface 104a. The interfacing surface 104, such as the interfacing indexing surface 104a, is a flat surface configured to interface with, and does interface with, a portion 20a (see FIG. 10A) of the aircraft structure 20 (see FIG. 10A), and is configured to index to the datum of the aircraft structure 20 being held. As shown in FIG. 5C, the length of the outer diameter of the ring portion 268 is greater than the length of the outer diameter of the indexing portion 255.

As further shown in FIGS. 5A, 5C, the pin 96 of the pin assembly 90, such as the datum side pin 98 of the datum side pin assembly 92, comprises the tail end 244 extending from the second end 260 of the indexing portion 255 comprising the shank 256. As shown in FIGS. 5A, 5C, the tail end 244 has a first end portion 273a, a second end portion 273b, and a threaded screw body 274 with threads 275 formed between the first end portion 273a and the second end portion 273b. The first end portion 273a is adjacent to, and integral with, or coupled to, the second end 260 of the indexing portion 255 comprising the shank 256.

As further shown in FIGS. 5A-5C, the pin assembly 90, such as the datum side pin assembly 92, comprises the nut element 102, such as a clamp nut element 276, configured to be coupled to, and coupled to, the tail end 244, such as the threaded tail end 244a, of the pin 96. The clamp nut element 276 is configured to attach the pin 96 to the structure 19, for example, the aircraft structure 20, and is configured to interface with the structure 19, for example, the aircraft structure 20. As shown in FIGS. 5A-5C, the clamp nut element 276 comprises a washer portion 278 integral with a hexagon-shaped portion 280. The hexagon-shaped portion 280 functions as a holding feature to tighten or to loosen the clamp nut element 276, when the clamp nut element 276 is secured on the tail end 244 of the pin 96. As further shown in FIG. 5A, the clamp nut element 276 has a first end 282a, a second end 282b, and a threaded through hole 284 formed through the interior of the clamp nut element 276, which is configured to be threadedly attached, and is threadedly attached, to the tail end 244, such as the threaded tail end 244a, of the pin 96, such as the datum side pin 98. As shown in FIG. 5C, in one version, the length of the outer diameter of the ring portion 268 is substantially equal to the length of the outer diameter of the washer portion 278 of the clamp nut element 276. In other versions, the washer portion 278 may have a greater or a smaller length of the outer diameter than the length of the outer diameter of the ring portion 268.

As shown in FIGS. 5A-5C, the pin assembly 90, such as the datum side pin assembly 92, may optionally comprise a pad element 285, such as a nylon pad, a thermoplastic pad, an acetal resin pad, or another suitable pad element, to provide padding to the washer portion 278 of the clamp nut element 276, to avoid marring or marking up the structure 19, such as the aircraft structure 20, that interfaces with the clamp nut element 276, when the tooling assembly 10 is attached to the structure 19, such as the aircraft structure 20. As shown in FIG. 5A, the pad element 285 has a first side 286a, a second side 286b, and a circular body 288 with a central hole 290. The second end 260 (see FIG. 5A) of the shank 256 (see FIG. 5A) and the tail end 244 (see FIG. 5A) are configured for insertion through the central hole 290 (see FIG. 5A) of the pad element 285 (see FIG. 5A). As shown in FIG. 5C, the second side 286b of the pad element 285 is adjacent to and coupled to, or integral with, the first end 282a of the clamp nut element 276. As further shown in FIG. 5C, there is a pin gap 287 between the first side 286a of the pad element 285 and the second side 270b of the ring body 272 of the rotation control portion 264. As further shown in FIG. 5C, the length of the outer diameter of the pad element 285 is substantially equal to the length of the outer diameter of the washer portion 278 of the clamp nut element 276.

The pin 96, such as the datum side pin 98, has the interfacing surface 104, such as the interfacing indexing surface 104a, on the pin 96, such as the datum side pin 98, that interfaces with the structure 19, such as the aircraft structure 20 (see FIG. 10A), and the datum side pin 98 indexes the aircraft structure 20 on the same side as the hinged clamshell structure 48. With the datum side pin 98, the datum side pin 98 is the locating feature or indexing feature since the pin 96 has the interfacing indexing surface 104a that indexes to the structure 19, such as the aircraft structure 20.

Now referring to FIGS. 6A-6C, FIG. 6A is an illustration of a side perspective view of an exemplary version of another pin assembly 90, such as a support pin assembly 90a, for example, a non-datum side pin assembly 94, of the disclosure, in the unassembled configuration 114a. FIG. 6B is an illustration of a side perspective view of the pin assembly 90, such as the support pin assembly 90a, for example, the non-datum side pin assembly 94, of FIG. 6A in the assembled configuration 113a. FIG. 6C is an illustration of a side cross-sectional view of the pin assembly 90, such as the support pin assembly 90a, for example, the non-datum side pin assembly 94, of FIG. 6A in the assembled configuration 113a.

As shown in FIGS. 6A-6C, the pin assembly 90, such as the support pin assembly 90a, for example, the non-datum side pin assembly 94, comprises the pin 96 that functions as a support pin 96a and a floating pin 96b, and in one example comprises a non-datum side pin 100. As shown in FIGS. 6A-6C, the pin 96, such as the non-datum side pin 100, comprises the head end 242 and the tail end 244, such as the threaded tail end 244a, similar to the datum side pin 98.

The head end 242 comprises the shoulder 245 (see FIGS. 6A-6C) that gets clamped by the clamshell assembly 40 (see FIGS. 7D, 8D, 9B), between the clamp assembly 86 (see FIGS. 7D, 8D, 9B) and the first side 117a (see FIGS. 7D, 8D, 9B) of the hinged clamshell structure 48 (see FIGS. 2A, 3A, 4A). In particular, the head end 242 comprising the shoulder 245 gets clamped between the clamp plate 210 (see FIGS. 7D, 8D, 9B), and the V-block 70 (see FIG. 7D) of the primary hinged clamshell structure 50 (see FIG. 7D), or the block 80 (see FIGS. 8D, 9B) of the secondary hinged clamshell structure 52 (see FIG. 8D) or the tertiary hinged clamshell structure 54 (see FIG. 9B). As shown in FIGS. 6A-6C, the head end 242 comprises the outer side 246a, the inner side 246b, and the disc-shaped body 248 formed between the outer side 246a and the inner side 246b.

As shown in FIG. 6C, the head end 242 of the pin 96 has the slip fit hole 250, such as the first slip fit hole 250a, formed in the interior portion 252a of the interior 252 of the pin 96 and through the head end 242 from the outer side 246a to the inner side 246b. As further shown in FIG. 6C, the tail end 244 has the slip fit hole 250, such as the second slip fit hole 250b, formed in the interior portion 252b of the interior 252 of the pin from the outer end 254 of the tail end 244. The slip fit holes 250 are optional.

As shown in FIGS. 6A-6C, the pin 96 further comprises the indexing portion 255 extending from the head end 242 and substantially positioned within the hinged clamshell structure 48 (see FIGS. 7D, 8D, 9B). As shown in FIGS. 6A-6C, the indexing portion 255 comprises the shank 256 having the first end 258 adjacent to, or integral with, a portion of the inner side 246b of the head end 242, a second end 260a (see FIG. 6C), and the cylindrical shank body 262. The indexing portion 255, such as the shank 256, interfaces the V-shaped interior recess 130 (see FIG. 2E) of the V-block 70 (see FIG. 2E) when the hinged clamshell structure 48 (see FIG. 2E) comprises the primary hinged clamshell structure 50 (see FIG. 2E). The indexing portion 255, such as the shank 256, interfaces the top flat portion 82 (see FIGS. 3E, 4D) of the block 80 (see FIGS. 3E, 4D) when the hinged clamshell structure 48 (see FIGS. 3E, 4D) comprises the secondary hinged clamshell structure 52 (see FIG. 3E) or the tertiary hinged clamshell structure 54 (see FIG. 4D).

As shown in FIGS. 6A-6C, the pin 96 further comprises the rotation control portion 264 coupled to an exterior portion 255a (see FIG. 6C) of the indexing portion 255 and extending outwardly from the exterior portion 255a and around the exterior portion 255a of the indexing portion 255. As shown in FIGS. 6A-6C, in one version, the rotation control portion 264 comprises the hexagon-shaped rotation control portion 264a having the hexagon-shaped portion 267 and having the ring portion 268. The ring portion 268 is integral with, or coupled to, the hexagon-shaped portion 267. As shown in FIG. 6C, the length of the outer diameter of the ring portion 268 is greater than the length of the outer diameter of the hexagon-shaped portion 267. In other versions, the rotation control portion 264 may comprise a square-shaped rotation control portion, machined surfaces, or flat surfaces that are configured to be held or gripped by a wrench or other suitable tool to retain the pin 96 and prevent the pin 96 from rotating. The rotation control portion 264 functions as a holding feature to tighten or to loosen the pin 96, when the nut elements 102 are secured on the pin 96. As shown in FIGS. 6A-6C, the rotation control portion 264 has the first end 265 and a second end 266a having a circular shape, and the length of the outer diameter of the second end 266a is greater than the length of the outer diameter of the first end 265. As further shown in FIG. 6C, the rotation control portion 264 has a through opening 292 in contact with the exterior portion 255a of the indexing portion 255. As shown in FIG. 6C, the length of the outer diameter of the hexagon-shaped portion 267 of the rotation control portion 264 is greater than the length of the outer diameter of the indexing portion 255.

As shown in FIG. 6C, the second end 260a of the indexing portion 255 comprising the shank 256 has end shoulder portions 294. FIG. 6C shows a nominal distance 295 from each end shoulder portion 294 to the nut element 102 comprising the clamp nut element 276a in the form of the indexing nut element 296. The nominal distance 295 is a known distance from each end shoulder portion 294 of the shank 256 to a predetermined portion of the nut element 102, such as the clamp nut element 276a comprising the indexing nut element 296, to locate to the indexing nut element 296, so that the distance from the datum of the aircraft structure 20 to the tooling assembly 10, such as the clamshell tooling assembly 10a, can be controlled.

As further shown in FIGS. 6A-6C, the pin 96 of the pin assembly 90, such as the non-datum side pin 100 of the non-datum side pin assembly 94, comprises the tail end 244, such as the threaded tail end 244a. As further shown in FIGS. 6A, 6C, the pin 96 of the pin assembly 90, such as the non-datum side pin 100 of the non-datum side pin assembly 94, comprises the tail end 244 extending from the second end 260a of the indexing portion 255 comprising the shank 256. As shown in FIGS. 6A, 6C, the tail end 244 has the first end portion 273a, the second end portion 273b, and the threaded screw body 274 (see FIG. 6A) with threads 275 (see FIG. 6A) formed between the first end portion 273a and the second end portion 273b. As shown in FIG. 6A, the first end portion 273a is adjacent to, and integral with, or coupled to, the second end 260 of the indexing portion 255 comprising the shank 256.

As shown in FIGS. 6A-6C, the pin assembly 90, such as the non-datum side pin assembly 94, may optionally comprise a pad element 285a, such as a nylon pad, a thermoplastic pad, an acetal resin pad, or another suitable pad element, to provide padding to the ring portion 268 of the rotation control portion 264, to avoid marring or marking up the structure 19, such as the aircraft structure 20, that interfaces with the ring portion 268, when the tooling assembly 10 is attached to the structure 19, such as the aircraft structure 20. As shown in FIG. 6A, the pad element 285a has the first side 286a, the second side 286b, and the circular body 288 with the central hole 290. The second end 260a (see FIG. 6A) of the shank 256 (see FIG. 6A) and the tail end 244 (see FIG. 6A) are configured for insertion through the central hole 290 (see FIG. 6A) of the pad element 285a (see FIG. 6A). As shown in FIG. 6C, the length of the outer diameter of the pad element 285 is substantially equal to the length of the outer diameter of the washer portion 278 of the clamp nut element 276.

As further shown in FIGS. 6A-6C, the pin assembly 90, such as the non-datum side pin assembly 94, comprises the nut element 102, such as a clamp nut element 276a, coupled to the tail end 244 of the pin 96, and configured to attach the pin 96 to the structure 19, such as the aircraft structure 20, and configured to interface with the structure 19, such as the aircraft structure 20. As shown in FIGS. 6A, the clamp nut element 276a comprises a washer portion 278a integral with a hexagon-shaped portion 280a. The hexagon-shaped portion 280a functions as a holding feature to tighten or to loosen the clamp nut element 276a, when the clamp nut element 276a is secured on the tail end 244 of the pin 96. As further shown in FIG. 6A, the clamp nut element 276a has the first end 282a, the second end 282b, and a threaded through hole 284a formed through the interior of the clamp nut element 276a, which is configured to be threadedly attached, and is threadedly attached, to the tail end 244, such as the threaded tail end 244a, of the pin 96, such as the non-datum side pin 100. As shown in FIG. 6C, in one version, the length of the outer diameter of the ring portion 268 is substantially equal to the length of the outer diameter of the washer portion 278a of the clamp nut element 276a. In other versions, the washer portion 278a may have a greater or a smaller length of the outer diameter than the length of the outer diameter of the ring portion 268.

As shown in FIG. 6A, the clamp nut element 276a comprises an indexing nut element 296 having the interfacing surface 104 comprising an interfacing indexing surface 104b. The interfacing surface 104 comprising the interfacing indexing surface 104b is located or positioned on the indexing nut element 296, and in particular, located or positioned on the first end 282a of the clamp nut element 276a comprising the indexing nut element 296. The interfacing surface 104, such as the interfacing indexing surface 104b, is a flat surface configured to interface with, and does interface with, a portion 20a (see FIG. 10A) of the aircraft structure 20 (see FIG. 10A), and to index to the datum of the aircraft structure 20 being held. As shown in FIG. 6C, there is a pin gap 287a between the first end 282a with the interfacing surface 104, such as the interfacing indexing surface 104b, and the second side 286b of the pad element 285a.

As shown in FIGS. 6A-6C, the pin assembly 90, such as the non-datum side pin assembly 94, comprises another nut element 102, such as a jam nut element 298 coupled to the tail end 244, such as the threaded tail end 244a, of the pin 96, such as the non-datum side pin 100. As shown in FIG. 6A, the jam nut element 298 comprises a hexagon-shaped jam nut element 298a having a first end 300, a second end 302, and a threaded through hole 304 formed through the interior of the jam nut element 298, which is configured to be threadedly attached, and is threadedly attached, to the tail end 244, such as the threaded tail end 244a, of the pin 96, such as the non-datum side pin 100. In one version, FIGS. 6A-6C show the jam nut element 298 in the form of a hexagon-shaped jam nut element 298a having a hexagon shape. In other versions, the jam nut element 298 may comprise another suitable securement or retaining element to secure and retain the clamp nut element 276a in place. The jam nut element 298 functions as a holding or securing feature or element to further hold and secure the clamp nut element 276a in place, so that it does not move off of or loosen from the known location of the end shoulder portions 294 (see FIG. 6C) of the shank 256, when the clamp nut element 276a is secured on the tail end 244 of the pin 96.

The pin 96, such as the non-datum side pin 100, has the interfacing surface 104, such as the interfacing indexing surface 104b, on the nut element 102, such as the clamp nut element 276a in the form of the indexing nut element 296, that interfaces with the structure 19, such as the aircraft structure 20 (see FIG. 10A), and the non-datum side pin 100 indexes the structure 19, such as the aircraft structure 20, on the opposite side of the hinged clamshell structure 48. With the non-datum side pin 100, the nut element 102, such as the clamp nut element 276a in the form of the indexing nut element 296 is the locating feature or indexing feature since the nut element 102, such as the clamp nut element 276a in the form of the indexing nut element 296 as the interfacing indexing surface 104b that indexes to the structure 19, such as the aircraft structure 20.

Now referring to FIGS. 7A-7E, FIGS. 7A-7E show versions of the tooling assembly 10, such as the clamshell tooling assembly 10a, of the disclosure having the clamshell assembly 40, such as the primary clamshell assembly 42, with the hinged clamshell structure 48, such as the primary hinged clamshell structure 50, and having the pin assembly 90, such as the datum side pin assembly 92 (see FIGS. 7A-7B) or having the non-datum side pin assembly 94 (see FIGS. 7C-7E).

FIG. 7A is an illustration of a front view of an exemplary version of the tooling assembly 10, such as the clamshell tooling assembly 10a, of the disclosure showing the clamshell assembly 40, such as the primary clamshell assembly 42, and the pin assembly 90, such as the datum side pin assembly 92. FIG. 7B is an illustration of a back perspective view of the tooling assembly 10, such as the clamshell tooling assembly 10a, of FIG. 7A. As shown in FIGS. 7A-7B, the pin assembly 90, such as the datum side pin assembly 92, comprises the pin 96, such as the datum side pin 98 with the nut element 102 comprising the clamp nut element 276.

FIG. 7C is an illustration of a back right side perspective view of the primary clamshell assembly 42 of FIG. 7A with the stop tab 76 and with the pin assembly 90, such as the non-datum side pin assembly 94. FIG. 7D is an illustration of a front perspective view of the tooling assembly 10, such as the clamshell tooling assembly 10a, of FIG. 7C. FIG. 7E is an illustration of a front cross-sectional view of the tooling assembly 10, such as the clamshell tooling assembly 10a, of FIG. 7D. As shown in FIGS. 7C-7E, the pin assembly 90, such as the non-datum side pin assembly 94, comprises the pin 96, such as the non-datum side pin 100, with the nut elements 102 comprising the clamp nut element 276a and the jam nut element 298. FIGS. 7C-7E further show the stop tab 76 on the primary clamshell assembly 42. FIG. 7D further shows an x-y-z coordinate system 306 with the x-axis direction 34, the y-axis direction 36, and the z-axis direction 38 with respect to the clamshell tooling assembly 10a. As shown in FIG. 7D, the upper clamshell portion 66 of the primary hinged clamshell structure 50 swings closed and locks the pin 96 in place using the latch assembly 84 holding a z location.

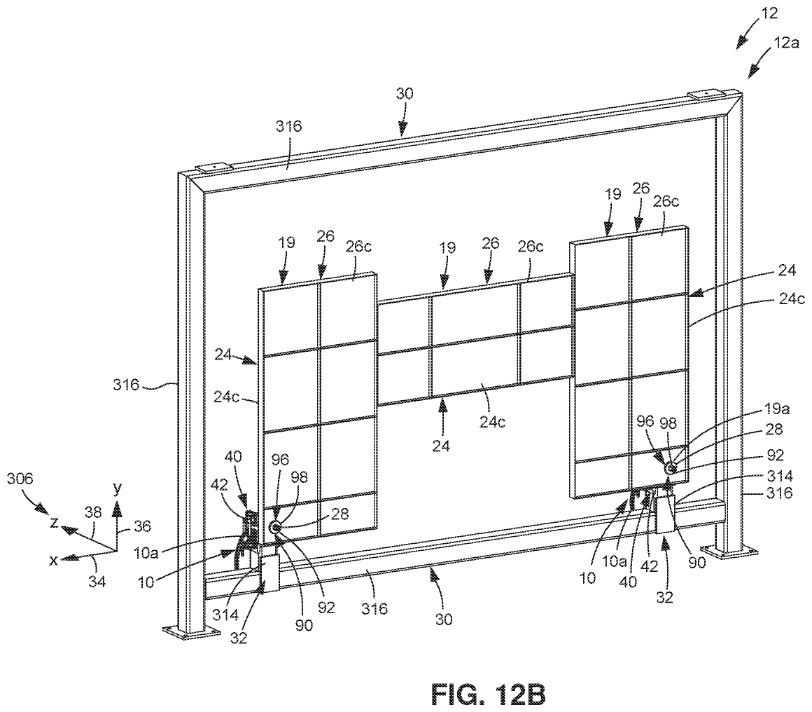

As shown in FIGS. 7A-7E, the indexing portion 255 (see FIGS. 7B, 7D-7E) of the pin 96 is positioned in the V-shaped interior recess 130 (see FIGS. 7C, 7E) of the V-block 70 of the primary hinged clamshell structure 50. As shown in FIGS. 7A, 7C-7D, the head end 242 with the shoulder 245 of the pin 96 is clamped between the first side 148 (see FIG. 7E) of the V-block 70 and the inner side portion 214a (see FIG. 7E) of the clamp plate 210. As shown in FIGS. 7D, 7E, the V-block 70 rests against the shoulder 245 of the head end 242 of the pin 96. As shown in FIGS. 7A-7B, 7D-7E, the rotation control portion 264 and the one or more nut elements 102 extend outside the V-block 70 and are configured to couple, or attach, to the structure 19 (see FIG. 12A), or to the aircraft structure 20 (see FIGS. 10A, 11A).

FIGS. 7A-7E further show the tooling assembly 10, such as the clamshell tooling assembly 10a, attached to an assembly jig portion 30c, and in particular, attached to a fixture 32 of the assembly jig portion 30c. As shown in FIG. 7E, the bolts 138, such as the precision shoulder bolts 138a, are inserted through the V-block through holes 136 in the V-block 70, are inserted through the bushing holes 139 in the bushings 140, are inserted through the base plate through holes 232 in the base plate 225, and are inserted into openings 308 of the assembly jig portion 30c, such as the fixture 32, to attach the clamshell tooling assembly 10a, to the assembly jig portion 30c such as the fixture 32.

Now referring to FIGS. 8A-8D, FIGS. 8A-8D show versions of the tooling assembly 10, such as the clamshell tooling assembly 10a, of the disclosure having the clamshell assembly 40, such as the secondary clamshell assembly 44, with the hinged clamshell structure 48, such as the secondary hinged clamshell structure 52, and having the pin assembly 90, such as the datum side pin assembly 92 (see FIGS. 8A-8B) or having the non-datum side pin assembly 94 (see FIGS. 8C-8D).

FIG. 8A is an illustration of a back right side perspective view of another exemplary version of the tooling assembly 10, such as the clamshell tooling assembly 10a, of the disclosure showing the clamshell assembly 40, such as the secondary clamshell assembly 44, and the pin assembly 90, such as the datum side pin assembly 92. FIG. 8B is an illustration of a front view of the tooling assembly 10, such as the clamshell tooling assembly 10a, of FIG. 8A but with a stop tab 76 on the secondary clamshell assembly 44. As shown in FIGS. 8A-8B, the pin assembly 90, such as the datum side pin assembly 92, comprises the pin 96, such as the datum side pin 98 with the nut element 102 comprising the clamp nut element 276.

FIG. 8C is an illustration of a front perspective view of the clamshell assembly 40, such as the secondary clamshell assembly 44, of FIG. 8A and with the pin assembly 90, such as the non-datum side pin assembly 94. FIG. 8D is an illustration of a front cross-sectional view of the tooling assembly 10, such as the clamshell tooling assembly 10a, of FIG. 8C. As shown in FIGS. 8C-8D, the pin assembly 90, such as the non-datum side pin assembly 94, comprises the pin 96, such as the non-datum side pin 100, with the nut elements 102 comprising the clamp nut element 276a and the jam nut element 298. FIG. 8C further shows an x-y-z coordinate system 306 with the x-axis direction 34, the y-axis direction 36, and the z-axis direction 38 with respect to the clamshell tooling assembly 10a. As shown in FIG. 8C, the upper clamshell portion 66 of the secondary hinged clamshell structure 52 swings closed and locks the pin 96 in place using the latch assembly 84 holding a z location.

As shown in FIGS. 8C-8D, the indexing portion 255 of the pin 96 is positioned on the top flat portion 82 of the block 80 of the secondary hinged clamshell structure 52. The secondary hinged clamshell structure 52 includes the top flat portion 82 or plate rather than a V-shaped interior recess 130 (see FIG. 7D) of the V-block 70 (see FIG. 7D), to secure the removable pin 96 in order to locate the structure 19, such as the aircraft structure 20, in the y-axis direction 36 (see FIG. 8D) and the z-axis direction 38 (see FIG. 8D), yet allow floating of the pin 96, and allow floating of the pin 96 and the structure 19, such as the aircraft structure 20, in the x-axis direction 34 (see FIG. 8C).

As shown in FIG. 8A-8D, the head end 242 with the shoulder 245 of the pin 96 is clamped between the block first side 148a (see FIG. 8D) of the block 80 and the inner side portion 214a (see FIG. 8D) of the inner side 214 (see FIG. 8D) of the clamp plate 210. As shown in FIG. 8D, the pin 96, such as the non-datum side pin 100, sits on the top flat portion 82 of the block 80 and is free to move along the top flat portion 82 to allow for full size determinant assembly 14 alignment of holes 28 (see FIG. 10A). As further shown in FIG. 8D, the shoulder 245 of the head end 242 is clamped between the block 80 and the clamp plate 210. As shown in FIGS. 8A-8D, the rotation control portion 264 and the one or more nut elements 102 extend outside the block 80 and are configured to couple, or attach, to the structure 19, such as the aircraft structure 20 (see FIG. 10A).

FIGS. 8A-8D further show the tooling assembly 10, such as the clamshell tooling assembly 10a, attached to the assembly jig portion 30c, and in particular, attached to the fixture 32 of the assembly jig portion 30c. As shown in FIG. 8D, the bolts 138, such as the precision shoulder bolts 138a, are inserted through the block through holes 136a in the block 80, are inserted through the bushing holes 139 in the bushings 140, are inserted through the base plate through holes 232 in the base plate 225, and are inserted into openings 308 of the assembly jig portion 30c, such as the fixture 32, to attach the clamshell tooling assembly 10a, to the assembly jig portion 30c such as the fixture 32.

FIG. 8D further shows the width 236, such as the secondary clamp plate width 236a, of the flat portion 238 of the first portion 216a of the clamp plate 210 of the secondary hinged clamshell structure 52. FIG. 8D further shows the gap 240 formed between the inner side portion 214a of the inner side 214 of the second portion 216b of the clamp plate 210 and the block first side 148a of the block 80 of the lower clamshell portion 78. As shown in FIG. 8D, the gap 240 comprises the secondary clamp plate gap 240a.

Now referring to FIGS. 9A-9B, FIGS. 9A-9B show versions of the tooling assembly 10, such as the clamshell tooling assembly 10a, of the disclosure having the clamshell assembly 40, such as the tertiary clamshell assembly 46, with the hinged clamshell structure 48, such as the tertiary hinged clamshell structure 54, and having the pin assembly 90, such as the datum side pin assembly 92 (see FIG. 9B) or having the non-datum side pin assembly 94 (see FIG. 9A).

FIG. 9A is an illustration of a front perspective view of another exemplary version of a tooling assembly 10, such as the clamshell tooling assembly 10a, of the disclosure showing the clamshell assembly 40, such as the tertiary clamshell assembly 46, and the pin assembly 90, such as the non-datum side pin assembly 94. As shown in FIG. 9A, the pin assembly 90, such as the non-datum side pin assembly 94, comprises the pin 96, such as the non-datum side pin 100, with the nut elements 102 comprising the clamp nut element 276a and the jam nut element 298.

FIG. 9A further shows an x-y-z coordinate system 306 with the x-axis direction 34, the y-axis direction 36, and the z-axis direction 38 with respect to the clamshell tooling assembly 10a. As shown in FIG. 9A, the upper clamshell portion 66 of the tertiary hinged clamshell structure 54 swings closed and locks the pin 96 in place using the latch assembly 84 holding a z location.

FIG. 9B is an illustration of a front cross-sectional view of the tooling assembly 10, such as the clamshell tooling assembly 10a, of FIG. 9A, but with no stop tab 76 (see FIG. 9A) on the tertiary clamshell assembly 46, and with the pin assembly 90, such as the datum side pin assembly 92. As shown in FIG. 9B, the pin assembly 90, such as the datum side pin assembly 92, comprises the pin 96, such as the datum side pin 98, with the nut element 102 comprising the clamp nut element 276.

As shown in FIGS. 9A-9B, the indexing portion 255 of the pin 96 is positioned on the top flat portion 82 of the block 80 of the tertiary hinged clamshell structure 54. The tertiary hinged clamshell structure 54 is like the secondary hinged clamshell structure 52 and includes the top flat portion 82 or plate, rather than the V-shaped interior recess 130 (see FIG. 7D) of the V-block 70 (see FIG. 7D), to secure the removable pin 96 in order to locate the structure 19, such as the aircraft structure 20, in the z-axis direction 38, and allow floating of the pin 96, and floating of the pin 96 and the structure 19, such as the aircraft structure 20, in the x-axis direction 34 and in the y-axis direction 36. The tertiary hinged clamshell structure 54 includes the top flat portion 82 of the block 80 and has the gap 240 (see FIG. 9B), such as the tertiary clamp plate gap 240b (see FIG. 9B) that is oversized and provides spacing between the shoulder 245 of the pin 96 and the clamp plate 210. This allows movement in two directions. As shown in FIG. 9B, the shoulder 245 of the head end 242 is free to float minimally between the block first side 148a of the block and the clamp plate 210. As shown in FIG. 9B, the pin 96 sits on the top flat portion 82 and is free to move along the top flat portion 82 or plate to allow for full size determinant assembly (FSDA) alignment of holes 28 (see FIGS. 1, 10A).

As shown in FIG. 9A-9B, the head end 242 with the shoulder 245 of the pin 96 is clamped between the block first side 148a (see FIG. 9B) of the block 80 and the inner side portion 214a (see FIG. 9B) of the inner side 214 (see FIG. 9B) of the clamp plate 210. As shown in FIGS. 9A-9B, the rotation control portion 264 and the one or more nut elements 102 extend outside the block 80 and are configured to couple, or attach, to the structure 19, such as the aircraft structure 20 (see FIG. 10A).

FIGS. 9A-9B further show the tooling assembly 10, such as the clamshell tooling assembly 10a, attached to the assembly jig portion 30c, and in particular, attached to the fixture 32 of the assembly jig portion 30c. As shown in FIG. 9B, the bolts 138, such as the precision shoulder bolts 138a, are inserted through the block through holes 136a in the block 80, are inserted through the bushing holes 139 in the bushings 140, are inserted through the base plate through holes 232 in the base plate 225, and are inserted into openings 308 of the assembly jig portion 30c, such as the fixture 32, to attach the clamshell tooling assembly 10a, to the assembly jig portion 30c such as the fixture 32.

FIG. 9B further shows the width 236, such as the tertiary clamp plate width 236b, of the flat portion 238 of the first portion 216a of the clamp plate 210 of the tertiary hinged clamshell structure 54. The tertiary clamp plate width 236b (see FIG. 9B) is greater than the secondary clamp plate width 236a (see FIG. 8D), and the secondary clamp plate width 236a is smaller than the tertiary clamp plate width 236b. For example, in one version, the tertiary clamp plate width 236b is 1/16 inch (0.0625 inch) greater in width than the secondary clamp plate width 236a.

FIG. 9B further shows the gap 240 formed between the inner side portion 214a of the inner side 214 of the second portion 216b of the clamp plate 210 and the block first side 148a of the block 80 of the lower clamshell portion 78. As shown in FIG. 9B, the gap 240 comprises the tertiary clamp plate gap 240b. The tertiary clamp plate gap 240b (see FIG. 9B) is greater than the secondary clamp plate gap 240a (see FIG. 9A), and the secondary clamp plate gap 240a is smaller than the tertiary clamp plate gap 240b.

As shown in FIGS. 1, 10A, 11A, 12A, there is provided the tooling system 12, such as the clamshell tooling system 12a, for full size determinant assembly 14 of the aircraft structure 20 (see FIGS. 10A, 11A) or the structure 19 (see FIG. 12A). The tooling system 12 comprises the assembly jig 30 (see FIGS. 10A, 11A, 12A), and the frame section 26 (see 10A, 11A, 12A) of the aircraft structure 20 (see FIGS. 10A, 11A) or the structure 19 (see FIG. 12A) for the full size determinant assembly 14. The frame section 26 is positioned on, and supported by, the assembly jig 30. The tooling system 12, such as the clamshell tooling system 12a, comprises two or more tooling assemblies 10 (see FIGS. 10A, 11A, 12A), such as two or more clamshell tooling assemblies 10a (see FIGS. 10A, 11A, 12A).

As discussed in detail above, each tooling assembly 10 comprises the clamshell assembly 40 (see FIG. 1) that locates the aircraft structure 20 (see FIGS. 10A, 11A) or the structure 19 (see FIG. 12A) in the assembly jig 30 in one or more of, the x-axis direction 34 (see FIGS. 1, 10A, 11A, 12A), the y-axis direction 36 (see FIGS. 1, 10A, 11A, 12A), and the z-axis direction 38 (see FIGS. 1, 10A, 11A, 12A). The clamshell assembly 40, as discussed in detail above, comprises the hinged clamshell structure 48 (see FIG. 1) having the hinged end 56 (see FIG. 1) with the hinge pin 58 (see FIG. 1) and the non-hinged end 60 (see FIG. 1).

As discussed in detail above, the clamshell assembly 40 further comprises the latch assembly 84 (see FIG. 1) attached to the non-hinged end 60 of the hinged clamshell structure 48, to latch the hinged clamshell structure 48 in the closed position 62 (see FIG. 1). As discussed in detail above, the clamshell assembly 40 further comprises the clamp assembly 86 (see FIG. 1) attached to a portion of a first side 117a (see FIGS. 2D, 3D, 4D) of the hinged clamshell structure 48, and further comprises the base plate 225 (see FIG. 1) attached to a bottom 115b (see FIGS. 2B, 3B, 4B) of the hinged clamshell structure 48.

As discussed in detail above, each tooling assembly 10 further comprises the pin assembly 90 (see FIG. 1). The pin assembly 90 comprises the pin 96 (see FIGS. 1, 4A, 5A). The pin assembly 90 comprises one of, the datum side pin assembly 92 (see FIGS. 5A-5C) having the datum side pin 98 (see FIGS. 5A-5C), or the non-datum side pin assembly 94 (see FIGS. 6A-6C) having the non-datum side pin 100 (see FIGS. 6A-6C).

As shown in FIGS. 7E. 8D, 9B, the pin 96 comprises the head end 242 clamped between the clamp assembly 86 and the first side 117a of the hinged clamshell structure 48, comprises the indexing portion 255 extending from the head end 242 and substantially positioned within the hinged clamshell structure 48, comprises the rotation control portion 264 coupled to the indexing portion 255, and comprises the tail end 244.

As shown in FIGS. 5C, 6C, the pin assembly 90 further comprises one or more nut elements 102 coupled to the pin 96, and further comprises the interfacing surface 104 located on one of, the pin 96, or the one or more nut elements 102. The interfacing surface 104 is configured to interface, and interfaces, with a portion 20a (see FIG. 10A) of the aircraft structure 20 (see FIG. 10A). The clamshell assembly 40 of each of the two or more tooling assemblies 10 allows the pin 96 to releasably engage within the assembly jig 30, and allows the pin 96 and the aircraft structure 20 to float, while preventing over-constraint of the full size determinant assembly 14.

The two or more tooling assemblies 10 may comprise at least one primary clamshell assembly 42 (see FIGS. 2A-2H) that locates the structure 19, such as the aircraft structure 20, in the x-axis direction 34 (see FIG. 1), in the y-axis direction 36 (see FIG. 1), and in the z-axis direction 38 (see FIG. 1), and the at least one primary clamshell assembly 42 comprises the primary hinged clamshell structure 50 (see FIGS. 2A-2H). The two or more tooling assemblies 10 may comprise at least one of, the secondary clamshell assembly 44 (see FIGS. 3A-3H) that locates the structure 19, such as the aircraft structure 20, in the y-axis direction 36 (see FIG. 1) and in the z-axis direction 38 (see FIG. 1), and allows floating of the pin 96 in the x-axis direction 34 (see FIG. 1), or the tertiary clamshell assembly 46 (see FIGS. 4A-4D) that locates the structure 19, such as the aircraft structure 20, in the z-axis direction 38 (see FIG. 1), and allows floating of the pin 96 in the x-axis direction 34 (see FIG. 1) and in the y-axis direction 36 (see FIG. 1). The secondary clamshell assembly 44 comprises the secondary hinged clamshell structure 52 (see FIGS. 3A-3H), and the tertiary clamshell assembly 46 comprises the tertiary hinged clamshell structure 54 (see FIGS. 4A-4D).

Now referring to FIGS. 10A-10B, FIG. 10A is an illustration of a front perspective view of an exemplary version of the tooling system 12, such as the clamshell tooling system 12a, of the disclosure, showing exemplary versions of the tooling assemblies 10, such as the clamshell tooling assemblies 10a, coupled to an exemplary version of an assembly jig 30, and coupled to exemplary versions of frame sections 26 of the aircraft structures 20. FIG. 10B is an illustration of a back perspective view of the tooling system 12, such as the clamshell tooling system 12a, of FIG. 10A. FIGS. 10A-10B further show the x-y-z coordinate system 306 with the x-axis direction 34, the y-axis direction 36, and the z-axis direction 38, with respect to the clamshell tooling assemblies 10a and the frame sections 26 of the aircraft structures 20.

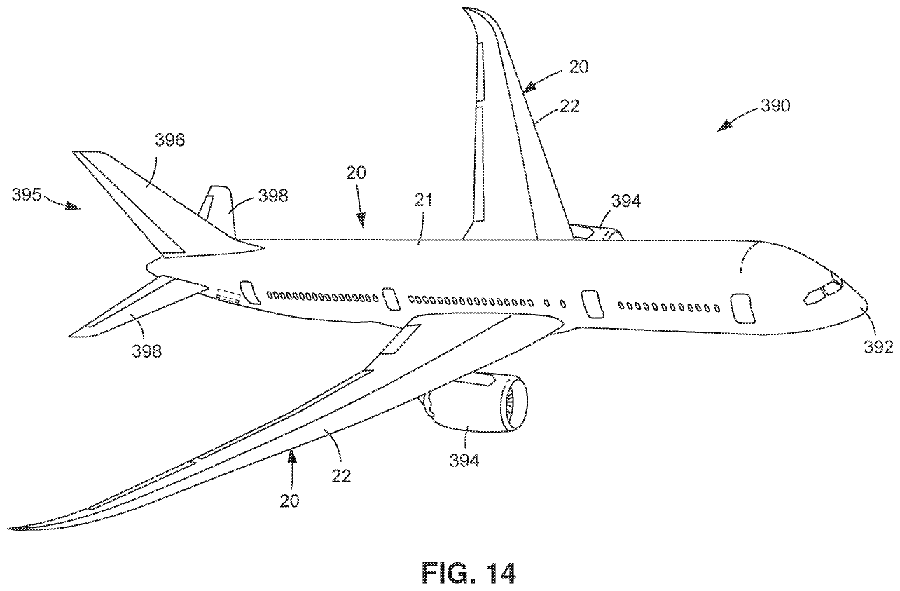

As shown in FIGS. 10A-10B, the frame sections 26 of the aircraft structures 20 comprise fuselage frame sections 26a of the fuselage 21 (see FIG. 14). The frame sections 26, such as the fuselage frame sections 26a (see FIGS. 10A-10B), may comprise bulkhead frame sections, keel frame sections, or other suitable fuselage frame sections. As shown in FIGS. 10A-10B, the frame sections 26, such as the fuselage frame sections 26a, comprise parts 24, such as production parts 24c. As shown in FIGS. 10A-10B, the aircraft structures 20, including the frame sections 26, such as the fuselage frame sections 26a, have holes 28 through which the pins 96 of each pin assembly 90 are inserted, to couple each tooling assembly 10, such as each clamshell tooling assembly 10a, to the aircraft structures 20, including the frame sections 26.

As shown in FIGS. 10A-10B, the tooling system 12, such as the clamshell tooling system 12a, further comprises the assembly jig 30, such as a fuselage assembly jig 30a. The fuselage assembly jig 30a may comprise a forward fuselage assembly jig, an aft fuselage assembly jig, or another suitable fuselage assembly jig. As shown in FIGS. 10A-10B, the tooling system 12, such as the clamshell tooling system 12a, further comprises fixtures 32, such as fuselage fixtures 32a, that are part of the assembly jig 30, such as the fuselage assembly jig 30a. The fuselage fixtures 32a may comprise forward fuselage fixtures, aft fuselage fixtures, or other suitable fuselage fixtures. As shown in FIGS. 10A-10B, the fixtures 32 of the assembly jig 30 include support structures 310 with support legs 312.

As shown in FIGS. 10A-10B, in one example, the tooling system 12, such as the clamshell tooling system 12a, has four (4) tooling assemblies 10, such as the four (4) clamshell tooling assemblies 10a, with four (4) clamshell assemblies 40 and four (4) pin assemblies 90. As shown in FIGS. 10A-10B, the four (4) clamshell assemblies 40 include two (2) primary clamshell assemblies 42, where one (1) primary clamshell assembly 42 has a datum side pin assembly 92 with a datum side pin 98, and one (1) primary clamshell assembly 42 has a non-datum side pin assembly 94 with a non-datum side pin 100. As further shown in FIGS. 10A-10B, the four (4) clamshell assemblies 40 include two (2) secondary clamshell assemblies 44, where one (1) secondary clamshell assembly 44 has a datum side pin assembly 92 with a datum side pin 98, and one (1) secondary clamshell assembly 44 has a non-datum side pin assembly 94 with a non-datum side pin 100. FIGS. 10A-10B show, in one version, an exemplary combination of the primary clamshell assemblies 42 and the secondary clamshell assemblies 44, and an exemplary combination of the datum side pin assemblies 92 and the non-datum side pin assemblies 94. In other versions, other combinations of the primary clamshell assemblies 42, the secondary clamshell assemblies 44, and/or tertiary clamshell assemblies 46 may be used, along with other combinations of the datum side pin assemblies 92 and the non-datum side pin assemblies 94.

As shown in FIGS. 10A-10B, each tooling assembly 10, such as each clamshell tooling assembly 10a, allows the pin 96 to releasably engage within the assembly jig 30, and allows the pin 96 and the aircraft structure 20 to float, while preventing over-constraint of the full size determinant assembly 14 (see FIG. 1).

Now referring to FIGS. 11A-11B, FIG. 11A is an illustration of a front perspective view of another exemplary version of the tooling system 12, such as the clamshell tooling system 12a, of the disclosure, showing exemplary versions of the tooling assemblies 10, such as the clamshell tooling assemblies 10a, coupled to an exemplary version of an assembly jig 30, and coupled to exemplary versions of frame sections 26 of the aircraft structures 20. FIG. 11B is an illustration of a back perspective view of the tooling system 12, such as the clamshell tooling system 12a, of FIG. 11A. FIGS. 11A-11B further show the x-y-z coordinate system 306 with the x-axis direction 34, the y-axis direction 36, and the z-axis direction 38, with respect to the clamshell tooling assemblies 10a and the frame sections 26 of the aircraft structures 20.

As shown in FIGS. 11A-11B, the frame sections 26 of the aircraft structures 20 comprise wing frame sections 26b of the wing 22 (see FIG. 14). The frame sections 26, such as the wing frame sections 26b (see FIGS. 11A-11B), may comprise rib frame sections, spar frame sections, or other suitable wing frame sections. As shown in FIGS. 11A-11B, the frame sections 26, such as the wing frame sections 26b, comprise parts 24, such as production parts 24c. As shown in FIGS. 11A-11B, the aircraft structures 20, including the frame sections 26, such as the wing frame sections 26b, have holes 28 through which the pins 96 of each pin assembly 90 are inserted, to couple each tooling assembly 10, such as each clamshell tooling assembly 10a, to the aircraft structures 20, including the frame sections 26.

As shown in FIGS. 11A-11B, the tooling system 12, such as the clamshell tooling system 12a, further comprises the assembly jig 30, such as a wing assembly jig 30b. The wing assembly jig 30b may comprise an inner wing assembly jig, an outer wing assembly jig, or another suitable wing assembly jig. As shown in FIGS. 11A-11B, the tooling system 12, such as the clamshell tooling system 12a, further comprises fixtures 32, such as wing fixtures 32b, that are part of the assembly jig 30, such as the wing assembly jig 30b. The wing fixtures 32b may comprise inner wing fixtures, outer wing fixtures, or other suitable wing fixtures. As shown in FIGS. 11A-10B, the fixtures 32 of the assembly jig 30 include support structures 310a with support legs 312a.

As shown in FIGS. 11A-11B, in one example, the tooling system 12, such as the clamshell tooling system 12a, has five (5) tooling assemblies 10, such as the five (5) clamshell tooling assemblies 10a, with five (5) clamshell assemblies 40 and five (5) pin assemblies 90. As shown in FIGS. 11A-11B, the five (5) clamshell assemblies 40 include one (1) primary clamshell assembly 42 having a datum side pin assembly 92 with a datum side pin 98, and include four (4) tertiary clamshell assemblies 46 each having a datum side pin assembly 92 with a datum side pin 98. FIGS. 11A-11B show, in one version, an exemplary combination of the primary clamshell assembly 42 and the tertiary clamshell assemblies 46, each with the datum side pin assemblies 92. In other versions, other combinations of the primary clamshell assemblies 42, the secondary clamshell assemblies 44, and/or tertiary clamshell assemblies 46 may be used, along with other combinations of the datum side pin assemblies 92 and the non-datum side pin assemblies 94.

As shown in FIGS. 11A-11B, each tooling assembly 10, such as each clamshell tooling assembly 10a, allows the pin 96 to releasably engage within the assembly jig 30, and allows the pin 96 and the aircraft structure 20 to float, while preventing over-constraint of the full size determinant assembly 14 (see FIG. 1).

Now referring to FIGS. 12A-12B, FIG. 12A is an illustration of a front view of an exemplary version of yet another tooling system 12, such as the clamshell tooling system 12a, of the disclosure, showing exemplary versions of the tooling assemblies 10, such as the clamshell tooling assemblies 10a, coupled to an exemplary version of an assembly jig 30, and coupled to exemplary versions of frame sections 26 of structures 19. FIG. 12B is an illustration of a back perspective view of the tooling system 12, such as a clamshell tooling system 12a, of FIG. 12A. FIGS. 12A-12B further show the x-y-z coordinate system 306 with the x-axis direction 34, the y-axis direction 36, and the z-axis direction 38, with respect to the clamshell tooling assemblies 10a and the frame sections 26 of the structures 19.

As shown in FIGS. 12A-12B, the frame sections 26 of the structures 19 comprise structure frame sections 26c of the structure 19. The structure 19 may comprise an aerospace structure, such as a spacecraft structure, a rotorcraft structure, a drone, or another suitable aerospace structure that can be assembled with full size determinant assembly (FSDA) 14 (see FIG. 1), or the structure 19 may comprise a watercraft structure, an automobile structure, a truck structure, or another suitable vehicle structure, that can be assembled with FSDA 14, or the structure 19 may comprise an architectural structure, such as a building structure, a bridge structure, or another suitable architectural structure, that can be assembled with FSDA 14, or the structure 19 may comprise another suitable structure that can be assembled with FSDA 14.

The frame sections 26, such as the structure frame sections 26c (see FIGS. 12A-12B), may comprise aerospace structure frame sections, vehicle structure frame sections, architectural structure frame sections, or other suitable structure frame sections. As shown in FIGS. 12A-12B, the frame sections 26, such as the structure frame sections 26c, comprise parts 24, such as production parts 24c, for example structure parts. As shown in FIGS. 12A-12B, the structures 19, including the frame sections 26, such as the structure frame sections 26c, have holes 28 through which the pins 96 of each pin assembly 90 are inserted, to couple each tooling assembly 10, such as each clamshell tooling assembly 10a, to the structures 19, including the frame sections 26.

As shown in FIGS. 12A-12B, the tooling system 12, such as the clamshell tooling system 12a, further comprises the assembly jig 30. As shown in FIGS. 12A-12B, the tooling system 12, such as the clamshell tooling system 12a, further comprises fixtures 32 that are part of the assembly jig 30. As shown in FIGS. 12A-12B, the fixtures 32 of the assembly jig 30 include support portions 314 and frame portions 316.

As shown in FIGS. 12A-12B, in one example, the tooling system 12, such as the clamshell tooling system 12a, has two (2) tooling assemblies 10, such as the two (2) clamshell tooling assemblies 10a, with two (2) clamshell assemblies 40 and two (2) pin assemblies 90 (see FIG. 12B). As shown in FIGS. 12A-12B, the two (2) clamshell assemblies 40 include two (2) primary clamshell assemblies 42 each having the datum side pin assembly 92 (see FIG. 12B) with the datum side pin 98 (see FIG. 12B) interfacing with a portion 19a (see FIG. 12B) of the structure 19 (see FIG. 12B). FIGS. 12A-12B show, in one version, an exemplary combination of the primary clamshell assemblies 42 and the datum side pin assemblies 92. In other versions, other combinations of the primary clamshell assemblies 42, the secondary clamshell assemblies 44, and/or tertiary clamshell assemblies 46 may be used, along with other combinations of the datum side pin assemblies 92 and the non-datum side pin assemblies 94.

As shown in FIGS. 12A-12B, each tooling assembly 10, such as each clamshell tooling assembly 10a, allows the pin 96 to releasably engage within the assembly jig 30, and allows the pin 96 and the structure 19 to float, while preventing over-constraint of the full size determinant assembly 14 (see FIG. 1).

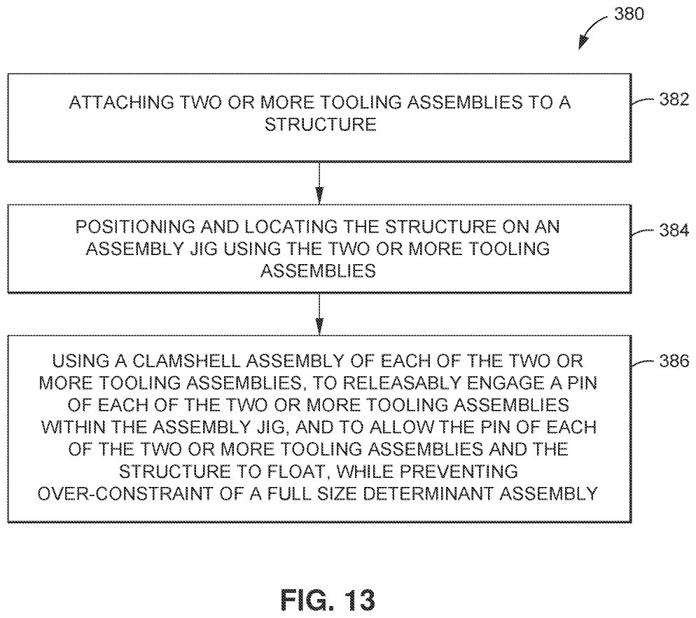

Now referring to FIG. 13, FIG. 13 is an illustration of a flow diagram of an exemplary version of a method 380 of the disclosure. In another version of the disclosure, there is provided the method 380 of supporting a structure 19 (see FIGS. 1, 12A), such as an aircraft structure 20 (see FIGS. 1, 14), or another suitable structure, for full size determinant assembly 14 (see FIG. 1).

The blocks in FIG. 13 represent operations and/or portions thereof, or elements, and lines connecting the various blocks do not imply any particular order or dependency of the operations or portions thereof, or elements. FIG. 13 and the disclosure of the steps of the method 380 set forth herein should not be interpreted as necessarily determining a sequence in which the steps are to be performed. Rather, although one illustrative order is indicated, it is to be understood that the sequence of the steps may be modified when appropriate. Accordingly, certain operations may be performed in a different order or simultaneously.

As shown in FIG. 13, the method 380 comprises the step of attaching 382 two or more tooling assemblies 10 (see FIGS. 1, 2A, 3A, 4A), as discussed in detail above, to the structure 19, such as the aircraft structure 20, or another suitable structure. Each tooling assembly 10 comprises the clamshell assembly 40 (see FIGS. 1, 2A, 3A, 4A) that locates the structure 19, such as the aircraft structure 20, in an assembly jig 30 in one or more of, an x-axis direction 34 (see FIG. 1), a y-axis direction 36 (see FIG. 1), and a z-axis direction 38 (see FIG. 1), the clamshell assembly (40). The clamshell assembly 40 comprises the hinged clamshell structure 48 (see FIGS. 1, 2A, 3A, 4A) having the hinged end 56 (see FIGS. 1, 2A, 3A, 4A) with the hinge pin 58 (see FIGS. 1, 2A, 3A, 4A) and the non-hinged end 60 (see FIGS. 1, 2A, 3A, 4A).

The hinged clamshell structure 48 further comprises the latch assembly 84 (see FIGS. 1, 2A, 3A, 4A) attached to the non-hinged end 60 of the hinged clamshell structure 48, to latch the hinged clamshell structure 48 in the closed position 62 (see FIGS. 1, 2A, 3A, 4A). The hinged clamshell structure 48 further comprises the clamp assembly 86 (see FIGS. 1, 2A, 3A, 4A) attached to the hinged clamshell structure 48. The hinged clamshell structure 48 further comprises the base plate 225 (see FIGS. 1, 2A, 3A, 4A), such as the pour plate 225a (see FIGS. 1, 2A, 3A, 4A), attached to the bottom 115b (see FIGS. 2B, 3B) of the hinged clamshell structure 48.

The clamshell assembly 40 further comprises the pin assembly 90 (see FIGS. 5A-6C). The pin 96 (see FIGS. 5A-5C) comprises the head end 242 (see FIGS. 5A, 6A), such as a shoulder 245 (see FIGS. 5A, 6A), clamped between the clamp assembly 86 and the hinged clamshell structure 48. The pin 96 further comprise the indexing portion 255 (see FIGS. 5A, 6A) extending from the head end 242 (see FIGS. 5A, 6A) and substantially positioned within the hinged clamshell structure 48. The pin 96 further comprises the rotation control portion 264 (see FIGS. 5A, 6A) coupled to the indexing portion 255. The pin 96 further comprises the tail end 244 (see FIGS. 5A, 6A), such as the threaded tail end 244a (see FIGS. 5A, 6A).

As shown in FIGS. 5A, 6A, the pin assembly 90 further comprises one or more nut elements 102 coupled to the pin 96. The pin assembly 90 further comprises the interfacing surface 104 (see FIGS. 5A, 6A) on one of, the pin 96, or the one or more nut elements 102. The interfacing surface 104, such as the interfacing indexing surface 104a (see FIG. 5A) or the interfacing indexing surface 104b (see FIG. 6A), is configured to interface with a portion 19a (see FIG. 12B) of the structure 19, such as with a portion 20a (see FIG. 10A) of the aircraft structure 20.

The step of attaching 382 the two or more tooling assemblies 10 to the structure 19, such as the aircraft structure 20, may further comprise, attaching the two or more tooling assemblies 10 with the pin assembly 90 (see FIGS. 5A, 6A) comprising one of, the datum side pin assembly 92 (see FIG. 5A) having the datum side pin 98 (see FIG. 5A), or the non-datum side pin assembly 94 (see FIG. 6A) having the non-datum side pin 100 (see FIG. 6A). The pin 96, such as the datum side pin 98, has the interfacing surface 104, such as the interfacing indexing surface 104a, on the pin 96, such as the datum side pin 98, that interfaces with the structure 19, such as the aircraft structure 20 (see FIG. 10A), and the datum side pin 98 indexes the structure 19, such as the aircraft structure 20, on the same side as the hinged clamshell structure 48. With the datum side pin 98, the datum side pin 98 is the locating feature or indexing feature since the pin 96 has the interfacing indexing surface 104a that indexes to the structure 19, such as the aircraft structure 20.

The pin 96, such as the non-datum side pin 100, has the interfacing surface 104, such as the interfacing indexing surface 104b, on the nut element 102, such as the clamp nut element 276a in the form of the indexing nut element 296, that interfaces with the structure 19, such as the aircraft structure 20 (see FIG. 10A), and the non-datum side pin 100 indexes the structure 19, such as the aircraft structure 20, on the opposite side of the hinged clamshell structure 48. With the non-datum side pin 100, the nut element 102, such as the clamp nut element 276a in the form of the indexing nut element 296 is the locating feature or indexing feature since the nut element 102, such as the clamp nut element 276a in the form of the indexing nut element 296 as the interfacing indexing surface 104b that indexes to the structure 19, such as the aircraft structure 20.

As shown in FIG. 13, the method 380 further comprises the step of positioning and locating 384 the structure 19, such as the aircraft structure 20, on the assembly jig 30 (see FIGS. 1, 10A, 11A, 12A) using the two or more tooling assemblies 10.

As shown in FIG. 13, the method 380 further comprises the step of using 386 the clamshell assembly 40 of each of the two or more tooling assemblies 10 to releasably engage the pin 96 of each of the two or more tooling assemblies 10 within the assembly jig 30, and to allow the pin 96 of each of the two or more tooling assemblies 10 and the structure 19, such as the aircraft structure 20, to float together, while preventing over-constraint of the full size determinant assembly 14.

The step of attaching 382 the two or more tooling assemblies 10 to the structure 19, such as the aircraft structure 20, may further comprise, attaching the two or more tooling assemblies 10 comprising at least one primary clamshell assembly 42 that locates the structure 19, such as the aircraft structure 20, in the x-axis direction 34 (see FIG. 1), in the y-axis direction 36 (see FIG. 1), and in the z-axis direction 38 (see FIG. 1). The at least one primary clamshell assembly 42 comprises the primary hinged clamshell structure 50 (see FIG. 1, 2A-2H). The primary hinged clamshell structure 50 comprises the upper clamshell portion 66 (see FIGS. 2A-2H) having the hinge knuckle 126 (see FIGS. 2E, 2H) with the hinge pin opening 128 (see FIGS. 2E, 2H).

The primary hinged clamshell structure 50 further comprises the lower clamshell assembly 68 (see FIG. 2E) comprising the V-block 70 (see FIG. 2E) with the V-shaped interior recess 130 (see FIG. 3E) to hold the indexing portion 255 (see FIGS. 5A, 6A) of the pin 96 (see FIGS. 5A, 5A). The V-shaped interior recess 130 has two or more V-block through holes 136 (see FIG. 2E). Each V-block through hole 136 receives a bolt 138 (see FIG. 2E). The V-block 70 further has a plurality of first side openings 160 (see FIG. 2E) in a first side 148 (see FIG. 2E).

The primary hinged clamshell structure 50 further comprises the extender block 72 (see FIG. 2E) attached to the front side 145 (see FIG. 2E) of the V-block 70. The primary hinged clamshell structure 50 further comprises the hinge plate 74 (see FIG. 2E) attached to the back side 146 (see FIG. 2E) of the V-block 70. The hinge plate 74 has the first hinge knuckle 126a (see FIG. 2E) with the first hinge pin opening 128a (see FIG. 2E) and the second hinge knuckle 126b (see FIG. 2E) with the second hinge pin opening 128b (see FIG. 2E). The hinge pin 58 is inserted through the first hinge pin opening 128a of the hinge plate 74, through the hinge pin opening 128 of the upper clamshell portion 66, and through the second hinge pin opening 128b of the hinge plate 74, to hingedly connect together the upper clamshell portion 66 and the lower clamshell assembly 68 at the hinged end 56.

The step of attaching 382 the two or more tooling assemblies 10 to the structure 19, such as the aircraft structure 20, may further comprise, attaching the two or more tooling assemblies 10 comprising at least one of, the secondary clamshell assembly 44 (see FIGS. 1, 3A-3H) or the tertiary clamshell assembly 46 (see FIGS. 1, 4A-4D). The secondary clamshell assembly 44 locates the structure 19, such as the aircraft structure 20, in the y-axis direction 36 (see FIG. 1) and in the z-axis direction 38 (see FIG. 1), and allows floating of the pin 96 (see FIG. 1) in the x-axis direction 34 (see FIG. 1). The tertiary clamshell assembly 46 locates the structure 19, such as the aircraft structure 20, in the z-axis direction 38 (see FIG. 1), and allows floating of the pin 96 (see FIG. 1) in the x-axis direction 34 (see FIG. 1) and in the y-axis direction 36 (see FIG. 1).

The secondary clamshell assembly 44 comprises the secondary hinged clamshell structure 52, and the tertiary clamshell assembly 46 comprises the tertiary hinged clamshell structure 54 (see FIG. 4A). The secondary hinged clamshell structure 52 and the tertiary hinged clamshell structure 54 each comprise the upper clamshell portion 66 having the hinge knuckle 126 with the hinge pin opening 128. The secondary hinged clamshell structure 52 and the tertiary hinged clamshell structure 54 each further comprises the lower clamshell portion 78 (see FIGS. 3B, 4B). The lower clamshell portion 78 comprises the block 80 (see FIGS. 3B, 3E, 4B) with the top flat portion 82 (see FIGS. 3B, 3E, 4B) having two or more block through holes 136a (see FIG. 3E). Each block through hole 136a receives a bolt 138 (see FIG. 3E), and the block 80 has a plurality of first side openings 160 (see FIG. 3E) on the block first side 148a (see FIG. 3E).

The lower clamshell portion 78 comprises the integral hinge plate 74a (see FIGS. 3B, 4B) integral with the block back side 146a (see FIGS. 3B, 4B) of the block 80. The integral hinge plate 74a has the first hinge knuckle 126a with the first hinge pin opening 128a and the second hinge knuckle 126b with the second hinge pin opening 128b.

The hinge pin 58 is inserted through the first hinge pin opening 128a of the integral hinge plate 74a, through the hinge pin opening 128 of the upper clamshell portion 66, and through the second hinge pin opening 128b of the integral hinge plate 74a, to hingedly connect together the upper clamshell portion 66 and the lower clamshell portion 78 at the hinged end 56.

Now referring to FIG. 14, FIG. 14 is an illustration of a perspective view of an exemplary aircraft 390 having aircraft structures 20, such as a fuselage 21 and wings 22, that may be manufactured using an exemplary version of a tooling system 12 (see FIG. 1) with two or more tooling assemblies 10 (see FIG. 1) of the disclosure for full size determinant assembly 14 (see FIG. 1), as discussed above. As shown in FIG. 14, the aircraft 390 includes the fuselage 21, the wings 22, a nose 392, engines 394, and an empennage 395. As shown in FIG. 14, the empennage 395 comprises a vertical stabilizer 396 and horizontal stabilizers 398.

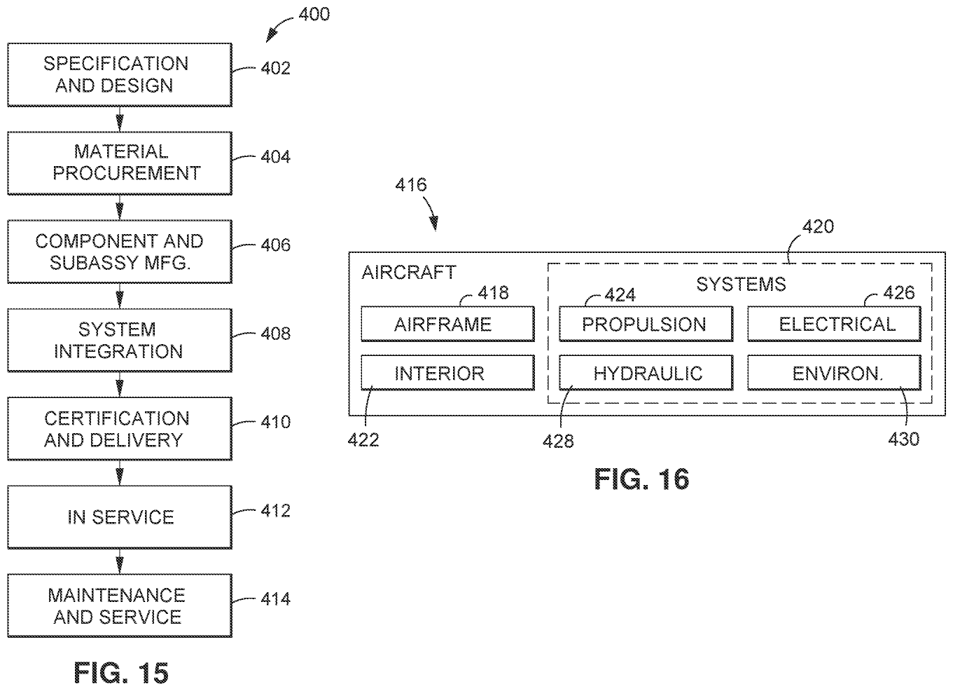

Now referring to FIGS. 15 and 16, FIG. 15 is an illustration of a flow diagram of an exemplary aircraft manufacturing and service method 400, and FIG. 16 is an illustration of an exemplary block diagram of an aircraft 416. Referring to FIGS. 15 and 16, versions of the disclosure may be described in the context of the aircraft manufacturing and service method 400 as shown in FIG. 15, and the aircraft 416 as shown in FIG. 16.

During pre-production, exemplary aircraft manufacturing and service method 400 may include specification and design 402 of the aircraft 416 and material procurement 404. During manufacturing, component and subassembly manufacturing 406 and system integration 408 of the aircraft 416 takes place. Thereafter, the aircraft 416 may go through certification and delivery 410 in order to be placed in service 412. While in service 412 by a customer, the aircraft 416 may be scheduled for routine maintenance and service 414 (which may also include modification, reconfiguration, refurbishment, and other suitable services).

Each of the processes of the aircraft manufacturing and service method 400 may be performed or carried out by a system integrator, a third party, and/or an operator (e.g., a customer). For the purposes of this description, a system integrator may include, without limitation, any number of aircraft manufacturers and major-system subcontractors. A third party may include, without limitation, any number of vendors, subcontractors, and suppliers. An operator may include an airline, leasing company, military entity, service organization, and other suitable operators.

As shown in FIG. 16, the aircraft 416 produced by the exemplary aircraft manufacturing and service method 400 may include an airframe 418 with a plurality of systems 420 and an interior 422. Examples of the plurality of systems 420 may include one or more of a propulsion system 424, an electrical system 426, a hydraulic system 428, and an environmental system 430. Any number of other systems may be included. Although an aerospace example is shown, the principles of the disclosure may be applied to other industries, such as the automotive industry, the construction industry, or another suitable industry.

Methods and systems embodied herein may be employed during any one or more of the stages of the aircraft manufacturing and service method 400. For example, components or subassemblies corresponding to component and subassembly manufacturing 406 may be fabricated or manufactured in a manner similar to components or subassemblies produced while the aircraft 416 is in service 412. Also, one or more apparatus embodiments, method embodiments, or a combination thereof, may be utilized during component and subassembly manufacturing 406 and system integration 408, for example, by substantially expediting assembly of or reducing the cost of the aircraft 416. Similarly, one or more of apparatus embodiments, method embodiments, or a combination thereof, may be utilized while the aircraft 416 is in service 412, for example and without limitation, to maintenance and service 414.

Disclosed versions of the tooling assembly 10 (see FIGS. 1, 2A, 3A, 4A), the tooling system 12 (see FIGS. 1, 10A, 11A, 12A) implementing the tooling assembly 10, and the method 380 (see FIG. 13) provide a custom clamshell tooling design and pin design for the tooling assembly 10 (see FIG. 1), such as the clamshell tooling assembly 10a (see FIG. 1), that can be used in a variety of full size determinant assembly build ups 18 (see FIG. 1) and that accurately positions and supports parts 24, such as production parts 24c (see FIG. 1), of structures 19 (see FIGS. 1, 12A), such as aircraft structures 20 (see FIGS. 1, 10A), for example, fuselage 21 (see FIGS. 1, 10A), wings 22 (see FIG. 1), or other suitable aircraft structures 20, for full size determinant assembly 14 (see FIG. 1). The novel tooling system 12 with the two or more tooling assemblies 10 allows for building the structure 19, such as the aircraft structure 20, for example, the fuselage 21, including, a full aircraft fuselage, or the wing 22, in a single assembly jig 30 (see FIGS. 1, 10A) with full size determinate assembly 14, rather than building in modules and splicing the modules together as in known systems and methods.

Disclosed versions of the tooling system 12 (see FIGS. 1, 10A, 11A, 12A) implementing the tooling assembly 10 and the method 380 (see FIG. 13) use two or more tooling assemblies 10, such as two or more clamshell tooling assemblies 10a, such as a minimum of two of one or more of the primary clamshell assembly 42 (see FIG. 2A), the secondary clamshell assembly 44 (see FIG. 3A), and/or the tertiary clamshell assembly 46 (see FIG. 4A), to locate the structure 19, such as the aircraft structure 20, in space. The tertiary clamshell assembly 46 is also used to provide added support while still preventing over-constraining of the full size determinant assembly 14. The tooling assembly 10, such as the clamshell tooling assembly 10a, includes the clamshell assembly 40 (see FIG. 1) with the hinged clamshell structure 48 (see FIG. 1) and the pin assembly 90 (see FIGS. 1, 5A, 6A). The clamshell assembly 40 has a releasably engaging detail or feature. The tooling system 12, such as the clamshell tooling system 12a, uses two or more clamshell tooling assemblies 10a, with coordinating pin assemblies 90 each having a pin 96. The pin 96 has an indexing portion 255 (see FIGS. 5A, 6A), such as a shank 256 (see FIGS. 5A, 6A), that interfaces the hinged clamshell structure 48, and has a head end 242 (see FIGS. 5A, 6A) comprising a shoulder 245 (see FIGS. 5A, 6A) that gets clamped between the hinged clamshell structure 48 and the clamp plate 210 (see FIGS. 2A, 3A, 4A) of the clamp assembly 86 (see FIG. 1). The pin assembly 90 further includes the interfacing surface 104 (see FIGS. 5A, 6A), such as the interfacing indexing surface 104a (see FIG. 5A), or the interfacing indexing surface 104b (see FIG. 6A), on one of, the pin 96 (see FIG. 5A), or the one or more nut elements 102 (see FIG. 6A), where the interfacing surface 104 interfaces with the structure 19, such as the aircraft structure 20.

In addition, the tooling system 12, such as the clamshell tooling system 12a (see FIG. 1), with the one or more tooling assemblies 10, such as the one or more clamshell tooling assemblies 10a (see FIG. 1), provides for over-constraint prevention 112 (see FIG. 1) and does not over-constrain the full size determinate assembly build up 18 (see FIG. 1), and allows the full size determinate assembly build up 18 to move or to float by providing a means for nominal adjustment 109 (see FIG. 1) of the pin 96 (see FIGS. 1, 5A, 6A) or pin float 108 (see FIG. 1) with the floating or movement of the pin 96, and the floating or movement of the pin 96 and the structure 19, such as the aircraft structure 20, together. The tooling assembly 10, the tooling system 12, and the method 380 (see FIG. 13) allow for the use of multiple tooling assemblies 10, such as multiple clamshell tooling assemblies 10a, to be used on an assembly jig 30 (see FIG. 10A), to support the structure 19, such as the aircraft structure 20 (see FIG. 10A), in space, while preventing over-constraining of the full size determinant assembly (FSDA) 14 (see FIG. 1). The tooling system 12, such as the clamshell tooling system 12a, with the two or more tooling assemblies 10, such as the two or more clamshell tooling assemblies 10a, allows for the full size determinate assembly build up 18 to float in one or more of, the x-axis direction 34 (see FIG. 1), the y-axis direction 36 (see FIG. 1), or the z-axis direction 38 (see FIG. 1), for the full size determinate assembly build process 16 (see FIG. 1). The tooling system 12, such as the clamshell tooling system 12a, with the two or more tooling assemblies 10, such as the two more clamshell tooling assemblies 10a, not only allows the pin 96 and the part 24, such as the structure 19, for example, the aircraft structure 20, to float together but also allows for locating the pin 96 at a nominal location for assembly jig 30 checks.

Moreover, disclosed versions of the tooling assembly 10 (see FIGS. 1, 2A, 3A, 4A), the tooling system 12 (see FIGS. 1, 10A, 11A, 12A) implementing the tooling assembly 10, and the method 380 (see FIG. 13) provide for pin releasable engagement 106 (see FIG. 1) and prevention of a binding condition 110 (see FIG. 1) of the pin 96. The tooling assembly 10, the tooling system 12, and the method 380 (see FIG. 13) for supporting the structure 19, such as the aircraft structure 20, for full size determinant assembly 14 disclosed herein allow the pins 96, such as datum side pins 98 (see FIG. 5A) and the non-datum side pins 100 (see FIG. 6A) to be releasably engaged, so that the pins 96 can be moved out of the assembly jig 30 (see FIG. 10A) with the structure 19, such as the aircraft structure 20 (see FIG. 10A), and allow for the pins 96 to float, to allow for full size determinant assembly 14. The pinning method allows the pins 96 to be releasably engaged within the assembly jig 30 to allow for full size determinate assembly 14. The tooling assembly 10, the tooling system 12, and the method 380 (see FIG. 13) prevent assembly jig lock and pin binding to accurately position and support structures 19, such as aircraft structures 20, such as frame sections 26 (see FIG. 1) of fuselage 21 (see FIGS. 1, 14) and wings 22 (see FIGS. 1, 14), to enable full size determinant assembly 14. Further, each clamshell assembly 40 (see FIG. 1) of the tooling assembly 10 allows the pin 96 (see FIG. 1) to releasably engage within the assembly jig 30 (see FIGS. 1, 10A), and allows the pin 96 and the structure 19, such as the aircraft structure 20, to float, while preventing over-constraint of the full size determinant assembly 14. When the pin 96 is fixed to the aircraft structure 20, the pin 96 and the structure 19, such as the aircraft structure 20, can move or float together. It is preferred to tool to the datum side of the production parts 24c (see FIG. 1) with the datum side pins 98 but when this is not achievable for accessibility reasons, the non-datum side pin 100 can be used to still be able to tool to a datum or indexing surface, such as an interfacing surface 104 (see FIGS. 5A, 6A).

In addition, disclosed versions of the tooling assembly 10 (see FIGS. 1, 2A, 3A, 4A), the tooling system 12 (see FIGS. 1, 10A, 11A, 12A) implementing the tooling assembly 10, and the method 380 (see FIG. 13) provide for the use of multiple clamshell tooling assemblies 10a to allow for more precise and secure alignment of the full size determinant assembly 14 (see FIG. 1). The tooling system 12 controls the distance from an aircraft structure's 20 “A” datum to the end shoulder portions 294 (see FIGS. 5C, 6C) of the removable pin 96 in support of the full size determinant assembly 14 process. The primary clamshell assembly 42 includes the V-block 70 (see FIG. 2A), which rests against the shoulder 245 (see FIGS. 5C, 6C) of the head end 242 (see FIGS. 5C, 6C) of the pin 96, in order to locate the structure 19, such as the aircraft structure 20, in the x-axis direction 34 (see FIG. 1), in the y-axis direction 36 (see FIG. 1), and in the z-axis direction 38 (see FIG. 1). The secondary clamshell assembly 44 (see FIG. 3A) includes the block 80 (see FIG. 3B) with the top flat portion 82 (see FIG. 3B) instead of the V-block 70 (see FIG. 2B), to secure the removable pin 96, in order to locate the structure 19, such as the aircraft structure 20, in the y-axis direction 36 and in the z-axis direction 38, yet to still allow floating of the pin 96, or the pin 96 and the structure 19, such as the aircraft structure 20, in the x-axis direction 34. The tertiary clamshell assembly 46 (see FIG. 4A) also includes the block 80 (see FIG. 4B) with the top flat portion 82 (see FIG. 4B) instead of the V-block 70 (see FIG. 2B), yet has the gap 240 (see FIG. 9B) that is an oversized slot that provides spacing between the shoulder 245 (see FIG. 9B) of the head end 242 (see FIG. 9B) of the pin 96 (see FIG. 9B) and the clamp plate 210 (see FIG. 9B). This allows movement in two directions.

Moreover, disclosed versions of the tooling assembly 10 (see FIGS. 1, 2A, 3A, 4A), the tooling system 12 (see FIGS. 1, 10A, 11A, 12A) implementing the tooling assembly 10, and the method 380 (see FIG. 13) provide improvements in the structural assembly process and tools for the full size determinant assembly 14 in order to provide more accurate and precise installation of parts 24 (see FIG. 1), such as the structures 19, for example, aircraft structures 20, with the assembly jig 30 (see FIG. 1) pinning methods and components. The tooling system 12 and method 380 improve the full size determinant assembly build process 16 (see FIG. 1) with removable pins 96 and latching hinged clamshell assemblies 40 (see FIG. A), to more accurately and efficiently position the parts 24, such as the structures 19, for example, the aircraft structures 20, prior to assembly on the assembly jig 30.

Further, disclosed versions of the tooling assembly 10 (see FIGS. 1, 2A, 3A, 4A), the tooling system 12 (see FIGS. 1, 10A, 11A, 12A) implementing the tooling assembly 10, and the method 380 (see FIG. 13) provide a means to avoid or prevent possible misalignments of the holes 28 (see FIGS. 1, 10A) within the part 24 coupled to the assembly jig 30. The tooling system 12, such as the clamshell tooling system 12a, and the two or more tooling assemblies 10, such as the two or more clamshell tooling assemblies 10a, of the tooling system 12 allow for hole misalignment prevention and allow for the build up of the fuselage assembly jig 30a (see FIG. 1) or the wing assembly jig 30b (see FIG. 1) without jig lock or pin binding issues. Thus, the tooling assembly 10, such as the clamshell tooling assembly 10a, provides for nominal adjustment 109 (see FIG. 1) and for pin float 108 (see FIG. 1), and for float of the pin 96 and the structure 19, such as the aircraft structure 20, together. In addition, the tooling assembly 10, such as the clamshell tooling assembly 10a, is a custom tooling and pin design that can be used in a variety of full size determinant assembly build ups 18 (see FIG. 1) and that accurately positions and supports the part 24, such as the fuselage part 24a (see FIG. 1) or the wing part 24b (see FIG. 1), for full size determinant assembly 14 (see FIG. 1). The novel tooling assembly 10 allows for the build up of the structure 19, such as the aircraft structure 20, without hole misalignment issues.

Many modifications and other versions of the disclosure will come to mind to one skilled in the art to which this disclosure pertains having the benefit of the teachings presented in the foregoing descriptions and the associated drawings. The versions described herein are meant to be illustrative and are not intended to be limiting or exhaustive. Although specific terms are employed herein, they are used in a generic and descriptive sense only and not for purposes of limitation. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled.

1. A tooling assembly for full size determinant assembly of a structure, the tooling assembly comprising:
a clamshell assembly that locates the structure in an assembly jig in one or more of, an x-axis direction, a y-axis direction, and a z-axis direction, the clamshell assembly comprising:
a hinged clamshell structure having a hinged end with a hinge pin and a non-hinged end;
a latch assembly attached to the non-hinged end of the hinged clamshell structure, to latch the hinged clamshell structure in a closed position;
a clamp assembly attached to the hinged clamshell structure; and
a base plate attached to a bottom of the hinged clamshell structure; and
a pin assembly comprising:
a pin comprising:
a head end clamped between the clamp assembly and the hinged clamshell structure;
an indexing portion extending from the head end and substantially positioned within the hinged clamshell structure;
a rotation control portion coupled to the indexing portion; and
a tail end;
one or more nut elements coupled to the pin; and
an interfacing surface on one of, the pin, or the one or more nut elements, the interfacing surface configured to interface with a portion of the structure,
wherein the clamshell assembly of the tooling assembly allows the pin to releasably engage within the assembly jig, and allows the pin and the structure to float, while preventing over-constraint of the full size determinant assembly.

2. The tooling assembly of claim 1, wherein the clamshell assembly comprises a primary clamshell assembly that locates the structure in the x-axis direction, in the y-axis direction, and in the z-axis direction.

3. The tooling assembly of claim 1, wherein the hinged clamshell structure comprises a primary hinged clamshell structure comprising:
an upper clamshell portion having a hinge knuckle with a hinge pin opening;
a lower clamshell assembly comprising:
a V-block with a V-shaped interior recess to hold the indexing portion of the pin, the V-shaped interior recess having two or more V-block through holes, each V-block through hole receiving a bolt, and the V-block having a plurality of first side openings in a first side;
an extender block attached to a front side of the V-block; and
a hinge plate attached to a back side of the V-block, the hinge plate having a first hinge knuckle with a first hinge pin opening and a second hinge knuckle with a second hinge pin opening,
wherein the hinge pin is inserted through the first hinge pin opening of the hinge plate, through the hinge pin opening of the upper clamshell portion, and through the second hinge pin opening of the hinge plate, to hingedly connect together the upper clamshell portion and the lower clamshell assembly at the hinged end.

4. The tooling assembly of claim 3, wherein the hinge plate has a stop tab, to stop the upper clamshell portion from over-pivoting, when the upper clamshell portion is pivoted upward from the closed position of the hinged clamshell structure to an open position of the hinged clamshell structure.

5. The tooling assembly of claim 1, wherein the clamshell assembly comprises a secondary clamshell assembly that locates the structure in the y-axis direction and in the z-axis direction, and allows floating of the pin in the x-axis direction.

6. The tooling assembly of claim 1, wherein the clamshell assembly comprises a tertiary clamshell assembly that locates the structure in the z-axis direction, and allows floating of the pin in the x-axis direction and in the y-axis direction.

7. The tooling assembly of claim 1, wherein the hinged clamshell structure comprises a secondary hinged clamshell structure or a tertiary hinged clamshell structure, the secondary hinged clamshell structure and the tertiary hinged clamshell structure each comprising:
an upper clamshell portion having a hinge knuckle with a hinge pin opening;
a lower clamshell portion comprising:
a block with a top flat portion having two or more block through holes, each block through hole receiving a bolt, and the block having a plurality of first side openings on a block first side; and
an integral hinge plate integral with a block back side of the block, the integral hinge plate having a first hinge knuckle with a first hinge pin opening and a second hinge knuckle with a second hinge pin opening,
wherein the hinge pin is inserted through the first hinge pin opening of the integral hinge plate, through the hinge pin opening of the upper clamshell portion, and through the second hinge pin opening of the integral hinge plate, to hingedly connect together the upper clamshell portion and the lower clamshell portion at the hinged end.

8. The tooling assembly of claim 7, wherein the hinge plate of each of the secondary hinged clamshell structure and the tertiary hinged clamshell structure has a stop tab, to stop the upper clamshell portion from over-pivoting, when the upper clamshell portion is pivoted upward from the closed position of the hinged clamshell structure to an open position of the hinged clamshell structure.

9. The tooling assembly of claim 1, wherein the latch assembly comprises:
a latch plate having a hook, the latch plate attached, via a plurality of latch plate fasteners, to a front plate side of the hinged clamshell structure; and
a latch clamp mechanism comprising:
a mounting plate attached, via a plurality of mounting plate fasteners, to the front plate side of the hinged clamshell structure;
a latch clamp handle coupled to the mounting plate; and
a latch clamp coupled to the mounting plate and configured to latch with the hook of the latch plate, to latch the hinged clamshell structure in the closed position.

10. The tooling assembly of claim 1, wherein the clamp assembly comprises:
a clamp plate having an L-shaped block configuration with an inner side and an outer side, the clamp plate having a plurality of first clamp plate through holes formed through the clamp plate and a second clamp plate through hole formed through the clamp plate;
a plurality of clamp plate fasteners inserted through the plurality of first clamp plate through holes, to attach an inner side portion of the inner side of the clamp plate to a first side of a V-block of the hinged clamshell structure; and
a threaded hand knob having a threaded screw end inserted through the second clamp plate through hole, to attach the threaded hand knob to the first side of the V-block of the hinged clamshell structure.

11. The tooling assembly of claim 1, wherein:
the pin assembly comprises a datum side pin assembly;
the pin comprises a datum side pin;
the rotation control portion comprises a hexagon-shaped rotation control portion with a hexagon-shaped portion and a ring portion;
the interfacing surface comprises an interfacing indexing surface located on the ring portion of the rotation control portion of the pin; and
the one or more nut elements comprise a clamp nut element coupled to the tail end of the pin, and configured to attach the pin to the structure.

12. The tooling assembly of claim 1, wherein:
the pin assembly comprises a non-datum side pin assembly;
the pin comprises a non-datum side pin;
the rotation control portion comprises a hexagon-shaped rotation control portion;
the one or more nut elements comprise:
a clamp nut element coupled to the tail end of the pin, and configured to attach the pin to the structure, the clamp nut element comprising an indexing nut element; and
a jam nut element coupled to the tail end of the pin; and
the interfacing surface comprises an interfacing indexing surface located on the indexing nut element.

13. A tooling system for full size determinant assembly of an aircraft structure, the tooling system comprising:
an assembly jig;
a frame section of the aircraft structure for the full size determinant assembly, the frame section positioned on, and supported by, the assembly jig; and
two or more tooling assemblies, each tooling assembly comprising:
a clamshell assembly that locates the aircraft structure in the assembly jig in one or more of an x-axis direction, a y-axis direction, and a z-axis direction, the clamshell assembly comprising:
a hinged clamshell structure having a hinged end with a hinge pin and a non-hinged end;
a latch assembly attached to the non-hinged end of the hinged clamshell structure, to latch the hinged clamshell structure in a closed position;
a clamp assembly attached to the hinged clamshell structure; and
a base plate attached to a bottom of the hinged clamshell structure; and
a pin assembly comprising:
a pin comprising:
a head end clamped between the clamp assembly and the hinged clamshell structure;
an indexing portion extending from the head end and substantially positioned within the hinged clamshell structure;
a rotation control portion coupled to the indexing portion; and
a tail end;
one or more nut elements coupled to the pin; and
an interfacing surface on one of, the pin, or the one or more nut elements, the interfacing surface configured to interface with a portion of the aircraft structure,
wherein the clamshell assembly of each of the two or more tooling assemblies allows the pin to releasably engage within the assembly jig, and allows the pin and the aircraft structure to float, while preventing over-constraint of the full size determinant assembly.

14. The tooling system of claim 13, wherein the two or more tooling assemblies comprise at least one primary clamshell assembly that locates the aircraft structure in the x-axis direction, in the y-axis direction, and in the z-axis direction, and the at least one primary clamshell assembly comprises a primary hinged clamshell structure comprising:
an upper clamshell portion having a hinge knuckle with a hinge pin opening;
a lower clamshell assembly comprising:
a V-block with a V-shaped interior recess to hold the indexing portion of the pin, the V-shaped interior recess having two or more V-block through holes, each V-block through hole receiving a bolt, and the V-block having a plurality of first side openings in a first side;
an extender block attached to a front side of the V-block; and
a hinge plate attached to a back side of the V-block, the hinge plate having a first hinge knuckle with a first hinge pin opening and a second hinge knuckle with a second hinge pin opening,
wherein the hinge pin is inserted through the first hinge pin opening of the hinge plate, through the hinge pin opening of the upper clamshell portion, and through the second hinge pin opening of the hinge plate, to hingedly connect together the upper clamshell portion and the lower clamshell assembly at the hinged end.

15. The tooling system of claim 13, wherein the two or more tooling assemblies comprise at least one of:
a secondary clamshell assembly that locates the aircraft structure in the y-axis direction and in the z-axis direction, and allows floating of the pin in the x-axis direction, or
a tertiary clamshell assembly that locates the aircraft structure in the z-axis direction, and allows floating of the pin in the x-axis direction and in the y-axis direction, and
further wherein the secondary clamshell assembly comprises a secondary hinged clamshell structure, and the tertiary clamshell assembly comprises a tertiary hinged clamshell structure, the secondary hinged clamshell structure and the tertiary hinged clamshell structure each comprising:
an upper clamshell portion having a hinge knuckle with a hinge pin opening;
a lower clamshell portion comprising:
a block with a top flat portion having two or more block through holes, each block through hole receiving a bolt, and the block having a plurality of first side openings on a block first side; and
an integral hinge plate integral with a block back side of the block, the integral hinge plate having a first hinge knuckle with a first hinge pin opening and a second hinge knuckle with a second hinge pin opening,
wherein the hinge pin is inserted through the first hinge pin opening of the integral hinge plate, through the hinge pin opening of the upper clamshell portion, and through the second hinge pin opening of the integral hinge plate, to hingedly connect together the upper clamshell portion and the lower clamshell portion at the hinged end.

16. The tooling system of claim 13, wherein the pin assembly comprises one of, a datum side pin assembly having a datum side pin, or a non-datum side pin assembly having a non-datum side pin.

17. A method of supporting a structure for full size determinant assembly, the method comprising the steps of:
attaching two or more tooling assemblies to the structure, each tooling assembly comprising:
a clamshell assembly that locates the structure in an assembly jig in one or more of, an x-axis direction, a y-axis direction, and a z-axis direction, the clamshell assembly comprising:
a hinged clamshell structure having a hinged end with a hinge pin and a non-hinged end;
a latch assembly attached to the non-hinged end of the hinged clamshell structure, to latch the hinged clamshell structure in a closed position;
a clamp assembly attached to the hinged clamshell structure; and
a base plate attached to a bottom of the hinged clamshell structure; and
a pin assembly comprising:
a pin comprising:
a head end clamped between the clamp assembly and the hinged clamshell structure;
an indexing portion extending from the head end and substantially positioned within the hinged clamshell structure;
a rotation control portion coupled to the indexing portion; and
a tail end;
one or more nut elements coupled to the pin; and
an interfacing surface on one of, the pin, or the one or more nut elements, the interfacing surface configured to interface with a portion of the structure;
positioning and locating the structure on the assembly jig using the two or more tooling assemblies; and
using the clamshell assembly of each of the two or more tooling assemblies to releasably engage the pin of each of the two or more tooling assemblies within the assembly jig, and to allow the pin of each of the two or more tooling assemblies and the structure to float, while preventing over-constraint of the full size determinant assembly.

18. The method of claim 17, wherein attaching the two or more tooling assemblies to the structure further comprises, attaching the two or more tooling assemblies comprising at least one primary clamshell assembly that locates the structure in the x-axis direction, in the y-axis direction, and in the z-axis direction, and the at least one primary clamshell assembly comprises a primary hinged clamshell structure comprising:
an upper clamshell portion having a hinge knuckle with a hinge pin opening;
a lower clamshell assembly comprising:
a V-block with a V-shaped interior recess to hold the indexing portion of the pin, the V-shaped interior recess having two or more V-block through holes, each V-block through hole receiving a bolt, and the V-block having a plurality of first side openings in a first side;
an extender block attached to a front side of the V-block; and
a hinge plate attached to a back side of the V-block, the hinge plate having a first hinge knuckle with a first hinge pin opening and a second hinge knuckle with a second hinge pin opening,
wherein the hinge pin is inserted through the first hinge pin opening of the hinge plate, through the hinge pin opening of the upper clamshell portion, and through the second hinge pin opening of the hinge plate, to hingedly connect together the upper clamshell portion and the lower clamshell assembly at the hinged end.

19. The method of claim 17, wherein attaching the two or more tooling assemblies to the structure further comprises, attaching the two or more tooling assemblies comprising at least one of:
a secondary clamshell assembly that locates the structure in the y-axis direction and in the z-axis direction, and allows floating of the pin in the x-axis direction, or
a tertiary clamshell assembly that locates the structure in the z-axis direction, and allows floating of the pin in the x-axis direction and in the y-axis direction, and
further wherein the secondary clamshell assembly comprises a secondary hinged clamshell structure, and the tertiary clamshell assembly comprises a tertiary hinged clamshell structure, the secondary hinged clamshell structure and the tertiary hinged clamshell structure each comprising:
an upper clamshell portion having a hinge knuckle with a hinge pin opening;
a lower clamshell portion comprising:
a block with a top flat portion having two or more block through holes, each block through hole receiving a bolt, and the block having a plurality of first side openings on a block first side; and
an integral hinge plate integral with a block back side of the block, the integral hinge plate having a first hinge knuckle with a first hinge pin opening and a second hinge knuckle with a second hinge pin opening,
wherein the hinge pin is inserted through the first hinge pin opening of the integral hinge plate, through the hinge pin opening of the upper clamshell portion, and through the second hinge pin opening of the integral hinge plate, to hingedly connect together the upper clamshell portion and the lower clamshell portion at the hinged end.

20. The method of claim 17, wherein attaching the two or more tooling assemblies to the structure further comprises, attaching the two or more tooling assemblies with the pin assembly comprising one of, a datum side pin assembly having a datum side pin, or a non-datum side pin assembly having a non-datum side pin.
